(19) United States
(12) Patent Application Publication
(10) Pub. No.: US 2012/0136911 A1
(43) Pub. Date: May 31, 2012

(54) INFORMATION PROCESSING APPARATUS, INFORMATION PROCESSING METHOD AND INFORMATION PROCESSING PROGRAM

(75) Inventor: Daisuke MOCHIZUKI, Chiba (JP)

(73) Assignee: Sony Corporation, Tokyo (JP)

(21) Appl. No.: 13/251,572

(22) Filed: Oct. 3, 2011

(30) Foreign Application Priority Data
Nov. 26, 2010 (JP) 2010-263820

(51) Int. Cl. G06F 17/15

(52) U.S. Cl. 708/422

(57) ABSTRACT

An information processing includes a base-N numerical-value generation section (N≧2) generating a combined base-N numerical value for each piece of data having positional information indicating a position prescribed in terms of D different coordinates of a D-dimensional coordinate system set for a feature space as the position of the piece of data in the feature space (D≧2) by alternately arranging digits representing the values of all the D different coordinates. A clustering section groups the pieces of data, each represented by one of the generated combined base-N numerical values each having k most significant digits common to the pieces of data (k≧1) in the same cluster.

### BACKGROUND

The present disclosure relates to an information processing apparatus, an information processing method and an information processing program.

There is known a technology for clustering data in a feature space on the basis of positional information of the data. Data grouped into the same cluster as a result of the clustering can be regarded as data existing at positions close to each other in the feature space. The data existing at close positions in the feature space is data whose features expressed by the feature space are similar to each other. A typical example of this clustering technology is a technology disclosed in Japanese Patent Laid-open No. 2010-140383. In accordance with this disclosed technology, positional information is added to image data and clustering based on the positional information is carried out in order to classify the image data into groups according to the positional information. In this case, the positional information added to image data is information on a location at which the image represented by the image data is taken.

### SUMMARY

Since the clustering processing computes distances among a plurality of pieces of data each having positional information, however, the processing load of the distance computation tends to increase. In addition, the clustering processing tends to require a memory having a large storage capacity. Therefore, there is raised a problem of how to increase the speed of the clustering processing.

It is thus an aim of the present disclosure, which addresses the problems described above, to provide a novel and improved information processing apparatus capable of carrying out clustering processing entailing only a reduced amount of processing at a high speed and provide an information processing method to be adopted by the information processing apparatus as well as an information processing program implementing the information processing method.

In order to solve the problems described above, in accordance with a mode of the present disclosure, there is provided an information processing apparatus employing:

a base-N numerical-value generation section (where N=2, 3 and so on) for generating a combined base-N numerical value for each piece of data having positional information indicating a position prescribed in terms of D different coordinates of a D-dimensional coordinate system set for a feature space as the position of the piece of data in the feature space (where D=2, 3 and so on) by alternately arranging digits representing the values of all the D different coordinates each represented by a component base-N numerical value having a predetermined digit count representing the number of aforementioned digits representing the coordinate sequentially on a digit-after-digit basis; and

a clustering section for grouping the pieces of data, which are each represented by one of the generated combined base-N numerical values each having k most significant digits common to the pieces of data (where k=1, 2 and so on), in the same cluster.

In addition, it is possible to provide a configuration in which, if the relation k=D×m (where m=1, 2 and so on) holds true, the clustering section groups the pieces of data, which are each represented by one of the generated base-N numerical values each having k most significant digits common to the pieces of data, in the same cluster on an mth layer of a (N^{D})-child tree structure of clusters.

In addition, it is possible to provide a configuration in which the clustering section has a clustering-oriented content-sorting block for sorting the pieces of data in the order of aforementioned base-N numerical values each generated by the base-N numerical-value generation section for one of the pieces of data. In this configuration, the clustering section identifies the pieces of data to be grouped in the same cluster from the result of the sorting carried out by the clustering-oriented content-sorting block.

In addition, it is possible to provide a configuration in which the clustering section generates cluster identifying information used for identifying a cluster for the result of the sorting by creating the cluster identifying information from the position of the first piece of data appearing in the cluster and the number of pieces of data grouped in the cluster.

In addition, it is possible to provide a configuration in which the information processing apparatus further employs:

a merging-oriented cluster-sorting block for sorting the clusters in a first direction in the feature space on the basis of the result of first ranking determination processing based on the D different coordinates of the D-dimensional coordinate system;

a cluster-adjacency determination block for determining whether or not the clusters sorted in the first direction are adjacent to each other in the first direction; and

a cluster merging section for merging clusters determined to be clusters adjacent to each other in the first direction.

In addition, it is possible to provide a configuration in which:

the merging-oriented cluster-sorting block sorts the clusters in a second direction in the feature space on the basis of the result of second ranking determination processing based on the D different coordinates of the D-dimensional coordinate system;

the cluster-adjacency determination block determines whether or not the clusters sorted in the second direction are adjacent to each other in the second direction; and

the cluster merging section further merges clusters determined to be clusters adjacent to each other in the second direction.

In addition, it is possible to provide a configuration in which:

the feature space is the surface of the earth;

the D different coordinates of the D-dimensional coordinate system are the latitude and longitude coordinates used as the two coordinates of a two-dimensional coordinate system;

the cluster is an area provided with information on the positions of the pieces of data which are included in a grid defined on the surface of the earth in terms of the two coordinates of the two-dimensional coordinate system; and

the first ranking determination processing is processing carried out to sort the grids in the first direction in order to set a sorting order of the grids and provide the sorting order of the grids to clusters each associated with one of the sorted grids as a ranking of the clusters.

In addition, it is possible to provide a configuration in which:

the feature space is a three-dimensional space;

the D different coordinates of the D-dimensional coordinate system are the three coordinates of a three-dimensional coordinate system used as an orthogonal-coordinate system; and

the cluster is an area provided with information on the positions of the pieces of data which are included in a block defined in the three-dimensional space in terms of the three coordinates of the three-dimensional coordinate system.

In order to solve the problems described above, in accordance with another mode of the present disclosure, there is provided an information processing method having:

generating a combined base-N numerical value (where N=2, 3 and so on) for each piece of data having positional information indicating a position prescribed in terms of D different coordinates of a D-dimensional coordinate system set for a feature space as the position of the piece of data in the feature space (where D=2, 3 and so on) by alternately arranging digits representing the values of all the D different coordinates each represented by a component base-N numerical value having a predetermined digit count representing the number of aforementioned digits representing the coordinate sequentially on a digit-after-digit basis; and

grouping the pieces of data, which are each represented by one of the generated combined base-N numerical values each having k most significant digits common to the pieces of data (where k=1, 2 and so on), in the same cluster.

In order to solve the problems described above, in accordance with another mode of the present disclosure, there is provided an information processing program to be executed by a computer to carry out:

processing to generate a combined base-N numerical value (where N=2, 3 and so on) for each piece of data having positional information indicating a position prescribed in terms of D different coordinates of a D-dimensional coordinate system set for a feature space as the position of the piece of data in the feature space (where D=2, 3 and so on) by alternately arranging digits representing the values of all the D different coordinates each represented by a component base-N numerical value having a predetermined digit count representing the number of aforementioned digits representing the coordinate sequentially on a digit-after-digit basis; and

processing to group the pieces of data, which are each represented by one of the generated combined base-N numerical values each having k most significant digits common to the pieces of data (where k=1, 2 and so on), in the same cluster.

It is possible to provide a configuration in which the information processing program is executed by the computer in order to further carry out:

processing to sort the clusters in a first direction in the feature space on the basis of the result of first ranking determination processing based on the D different coordinates of the D-dimensional coordinate system;

processing to determine whether or not the clusters sorted in the first direction are adjacent to each other in the first direction; and

processing to merge clusters determined to be clusters adjacent to each other in the first direction.

It is possible to provide a configuration in which the processing to merge clusters includes a process of computing a distance between any two of the clusters and a process of merging two clusters with each other if the computed distance between the two clusters is not longer than a threshold value determined in advance.

It is possible to provide a configuration in which the processing to merge clusters includes:

a process of computing a distance between any two of the clusters;

a process of storing two clusters in a memory as merging-candidate clusters if the computed distance between the two clusters is not longer than a threshold value determined in advance; and

a process of merging clusters, which are selected from the stored merging-candidate clusters, with each other in an order starting with the merging-candidate clusters having a small distance between the merging-candidate clusters.

As described above, it is possible to carry out clustering processing, the amount of which is reduced, at a high speed.

### BRIEF DESCRIPTION OF THE DRAWINGS

FIG. 1 is a diagram showing typical relations between contents, a cluster and a grid in a first embodiment of the present disclosure;

FIG. 2 is a diagram showing a typical hierarchical structure of grids in the first embodiment of the present disclosure;

FIG. 3 is a diagram showing a typical result of clustering carried out in accordance with the first embodiment of the present disclosure;

FIGS. 4A and 4B are explanatory diagrams to be referred to in description of typical comparison of grid-based positional clustering carried out in accordance with the first embodiment of the present disclosure with the ordinary distance-based positional clustering;

FIGS. 5A and 5B are other explanatory diagrams to be referred to in description of other typical comparison of the grid-based positional clustering carried out in accordance with the first embodiment of the present disclosure with the ordinary distance-based positional clustering;

FIG. 6 is a block diagram showing the configuration of an information processing apparatus according to the first embodiment of the present disclosure;

FIG. 7 is an explanatory diagram to be referred to in description of clustering carried out in accordance with the first embodiment of the present disclosure;

FIG. 8 is an explanatory diagram to be referred to in description of processing to merge clusters with each other in accordance with the first embodiment of the present disclosure;

FIG. 9 shows a flowchart representing clustering processing and merging processing which are carried out in accordance with the first embodiment of the present disclosure;

FIG. 10 is an explanatory diagram to be referred to in description of the clustering processing carried out in accordance with the first embodiment of the present disclosure;

FIG. 11 is an explanatory diagram to be referred to in description of cluster identifying information according to the first embodiment of the present disclosure;

FIG. 12 shows a flowchart representing merging-related processing carried out in accordance with the first embodiment of the present disclosure;

FIG. 13 is a table of typical merging setting information according to the first embodiment of the present disclosure;

FIG. 14 shows a flowchart representing merging setting information select processing carried out in accordance with the first embodiment of the present disclosure;

FIG. 15 shows a flowchart representing search-order merging processing carried out in accordance with the first embodiment of the present disclosure;

FIG. 16 shows a flowchart representing the full-match merging processing carried out in accordance with the first embodiment of the present disclosure;

FIG. 17A is a diagram showing a case in which a search of a grid list is carried out in the horizontal direction in accordance with the first embodiment of the present disclosure; FIG. 17B is a diagram showing a case in which a search of a grid list is carried out in the vertical direction in accordance with the first embodiment of the present disclosure; FIG. 17C is a diagram showing a case in which a search of a grid list is carried out in the oblique right downward direction in accordance with the first embodiment of the present disclosure; FIG. 17D is a diagram showing a case in which a search of a grid list is carried out in the oblique right upward direction in accordance with the first embodiment of the present disclosure;

FIG. 18A is a diagram showing a case in which a one-direction search is carried out in accordance with the first embodiment of the present disclosure; FIG. 18B is a diagram showing a case in which a two-direction search is carried out in accordance with the first embodiment of the present disclosure; FIG. 18C is a diagram showing a case in which a four-direction search is carried out in accordance with the first embodiment of the present disclosure;

FIG. 19 shows a flowchart representing neighborhood-search merging processing (without an upper-level search) carried out in accordance with the first embodiment of the present disclosure;

FIG. 20 shows a flowchart representing adjacency search processing (without an upper-level search) carried out in accordance with the first embodiment of the present disclosure;

FIG. 21 shows a flowchart representing neighborhood-search merging processing (with an upper-level search) carried out in accordance with the first embodiment of the present disclosure;

FIG. 22 is a diagram showing a typical an upper-level grid list according to the first embodiment of the present disclosure;

FIG. 23 is a diagram showing a typical an upper-level grid list according to the first embodiment of the present disclosure;

FIG. 24 is an explanatory diagram to be referred to in description of adjacency search processing (with an upper-level search) carried out in accordance with the first embodiment of the present disclosure;

FIG. 25 shows a flowchart representing adjacency search processing (with an upper-level search) carried out in accordance with the first embodiment of the present disclosure;

FIG. 26 is an explanatory diagram to be referred to in description of adjacency search processing (with an upper-level search) carried out in accordance with the first embodiment of the present disclosure;

FIG. 27 is a diagram showing typical grids each serving as a subject of neighborhood-search merging processing (with an upper-level search) carried out in accordance with the first embodiment of the present disclosure;

FIG. 28 is an explanatory diagram to be referred to in description of an outline of distance-order sorting carried out in accordance with the first embodiment of the present disclosure;

FIG. 29 shows a flowchart representing distance-order merging processing carried out in accordance with the first embodiment of the present disclosure;

FIG. 30A is a diagram showing typical relations between contents, clusters and blocks in a second embodiment of the present disclosure, FIG. 30B is a diagram showing a typical display of contents and a cluster in the second embodiment of the present disclosure;

FIG. 31 is an explanatory diagram to be referred to in description of an operation to divide the surface of the earth by making use of blocks in accordance with the second embodiment of the present disclosure;

FIG. 32 is an explanatory diagram to be referred to in description of an operation to divide the surface of the earth by making use of blocks in accordance with the second embodiment of the present disclosure;

FIG. 33 is an explanatory diagram to be referred to in description of an operation to divide the surface of the earth by making use of blocks in accordance with the second embodiment of the present disclosure;

FIG. 34 is an explanatory diagram referred to in the following description of clustering carried out in accordance with the second embodiment of the present disclosure; and

FIG. 35 is a block diagram showing the hardware configuration of the information processing apparatus according to the embodiments of the present disclosure.

### DETAILED DESCRIPTION OF THE PREFERRED EMBODIMENTS

Preferred embodiments of the present disclosure are explained below in detail by referring to the diagrams. It is to be noted that, in the specification of the present disclosure and the diagrams, configuration elements having virtually identical functional configurations are each denoted by the same reference numeral so that such configuration elements need to be explained only once. Thus, it is possible to avoid duplications of explanations.

It is also worth noting that the embodiments are explained in chapters arranged as follows.

### 1: First Embodiment

### 1-1: Outline of Grid-Based Positional Clustering

### 1-2: Configuration of the Information Processing Apparatus

### 1-3: Details of Clustering and Merging

### 2: Second Embodiment

### 2-1: Outline of the Block-Based Positional Clustering

### 3: Hardware Configuration of the Information Processing Apparatus According to the Embodiments of the Disclosure

### 4: Conclusions

### 1: First Embodiment

In the first embodiment of the present disclosure, the surface of the earth corresponds to the feature space cited before. In addition, in this embodiment, information on a position on the surface of the earth is represented in terms of two different coordinates which are the latitude and longitude coordinates of a two-dimensional coordinate system. On top of that, in this embodiment, a cluster associated with a grid is an area provided with information on the positions of contents included in the grid which is defined on the surface of the earth by making use of two different coordinates, that is, the latitude and longitude coordinates of a two-dimensional coordinate system, as will be described more in detail later.

1-1: Outline of Grid-Based Positional Clustering

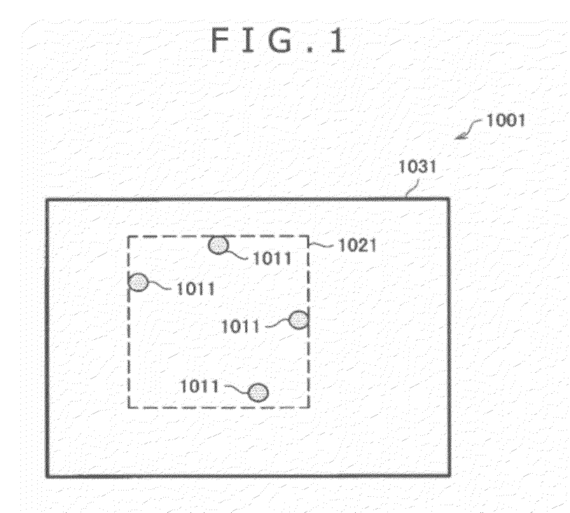

First of all, an outline of clustering carried out in accordance with the first embodiment of the present disclosure is explained by referring to FIGS. 1 to 5B. The clustering carried out in accordance with this embodiment is a process of grouping contents each having information on the position of the content into clusters by taking a grid as a reference. As described above, the grid is defined on the surface of the earth by making use of two different coordinates which are the latitude and longitude coordinates of a two-dimensional coordinate system as will be described more in detail later. In the following description, the clustering is also referred to as grid-based positional clustering.

### Grid

FIG. 1 is a diagram showing typical relations between contents 1011, a cluster 1021 and a grid 1031 in a first embodiment of the present disclosure. To put it concretely, FIG. 1 shows the earth surface 1001, the contents 1011, the cluster 1021 and the grid 1031.

The earth surface 1001 is an area of the entire surface of the earth or an area of a portion of the surface. In this embodiment, the earth surface 1001 is treated as a two-dimensional plane. Information on each position on the earth surface 1001 is expressed in terms of two different coordinates which are the latitude and longitude coordinates of a two-dimensional coordinate system. In the following description, information on a position is also referred to as positional information.

The content 1011 at a position on the earth surface 1001 is data having positional information used for identifying the position of the data. The content 1011 does not have to be the positional information itself. Thus, the content 1011 can be data having positional information added to the data as additional information for some other information. A typical example of the content 1011 is image data including positional information used for identifying a location at which an image represented by the image data has been taken.

The cluster 1021 is an area including contents 1011 located at positions close to each other on the earth surface 1001. In the figure, the cluster 1021 is shown to have a shape resembling a rectangle. However, the cluster 1021 can have another shape. As an alternative, the cluster 1021 can have a shape circumscribing contents 1011 included in the cluster 1021.

The grid 1031 is a grid set on the earth surface 1001. The grid 1031 can be the area of a rectangle defined by a range of latitudes and longitudes on the earth surface 1001. As will be described more later, the size of the grid 1031 is set properly in accordance with clustering conditions such as the number of contents 1011 and the size of an area serving as the object of clustering.

As shown in the figure, in this embodiment, contents 1011 included in the same grid 1031 are grouped in the same cluster 1021 associated with the grid 1031. Except for a case in which clusters 1021 are merged with each other, the area of a cluster 1021 including contents 1011 is included in the area of a grid 1031 including the same contents 1011. That is to say, in the grade-based positional clustering processing carried out in accordance with this embodiment, a decision as to whether or not contents 1011 are to be grouped in a cluster 1021 is made on the basis of a result of a determination as to whether or not the contents 1011 pertain to the same grid 1031 including the cluster 1021. That is to say, the result of such a determination is used as the basic criterion of the clustering.

The ordinary distance-based positional clustering includes processing to compute the distance between every two contents and compare the distance with a threshold value determined in advance or the distance between two other contents. In the distance computation processing, the number of distances to be computed is equal to the number of combinations each composed of two different contents. Thus, the amount of the distance computation processing is large. In addition, if the distance between two contents is to be compared with the distance between two other contents, the computed distances have to be stored in a memory temporarily. Thus, a memory having a large storage capacity is desired.

In the case of the grid-based positional clustering carried out in accordance with this embodiment, on the other hand, the positional information of a content 1011 by itself also represents a grid 1031 including the content 1011 as is obvious from the following description. The positional information of a content 1011 is expressed in terms of a latitude and a longitude which are each represented by a base-N numerical value composed of an array of digits. As will be described later, if the contents 1011 are sorted in the order of the base-N numerical values by carrying out sequential digit-to-digit comparison on the numerical values, a result of the sorting is obtained.

Contents 1011 included in the area of the same grid 1031 are adjacent to each other in the result of the sorting. It is possible to determine whether or not two contents 1011 adjacent to each other in the result of the sorting are included in the same grid 1031 by, for example, determining whether or not the k (where k=1, 2 and so on) most significant digits of the base-N numerical values each representing one of the two contents 1011 are identical with each other.

As described earlier, contents 1011 included in the same grid 1031 are grouped in the same cluster 1021 associated with the grid 1031. Therefore, the processing to sort numerical values generated from positional information of contents 101 is the main processing of the grid-based positional clustering carried out in accordance with this embodiment. The sort processing serves as a small load to be borne by a processor in comparison with the distance computation processing. In addition, the number of times the sort processing is to be carried out is smaller than the number of times the distance computation processing is to be carried out. Thus, the grid-based positional clustering carried out in accordance with this embodiment can be carried out at a higher speed and the storage capacity of a memory in the grid-based positional clustering can be reduced.

### Hierarchical Structure of Grids

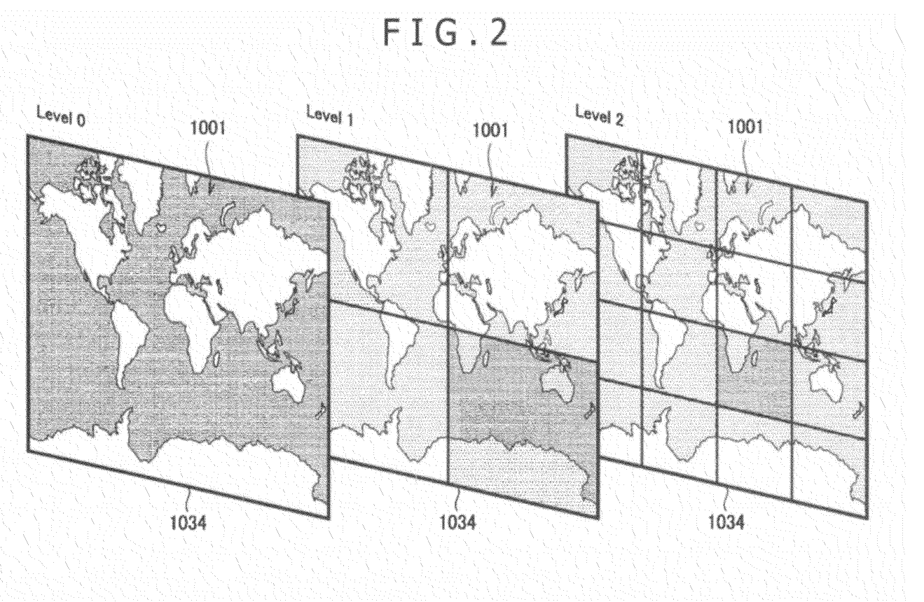

FIG. 2 is a diagram showing a typical hierarchical structure of grids in the first embodiment of the present disclosure. FIG. 2 shows a level-0 grid 1032, a level-1 grid 1033 and a level-2 grid 1034.

The level-0 grid 1032 is a grid of the highest level in the hierarchical structure. The range of the level-0 grid 1032 is the entire earth surface 1001. That is to say, at the highest level in the hierarchical structure, the entire earth surface 1001 is included in one grid which is the level-0 grid 1032.

A level-1 grid 1033 is any one of four grids obtained by dividing the level-0 grid 1032 into two grids in the latitude direction and two grids in the longitude direction. In other words, the entire earth surface 1001, which is the area of the level-0 grid 1032, is divided into the four level-1 grids 1033.

A level-2 grid 1034 is any one of 16 grids obtained by dividing each level-1 grid 1033 into two grids in the latitude direction and two grids in the longitude direction. In other words, the area of each level-1 grid 1033 is divided into the four level-two grids 1034. That is to say, the entire earth surface 1001, which is the area of the level-0 grid 1032, is divided into the 16 level-two grids 1034.

The hierarchical structure of the grids is extended to further lower levels in the same way. To put it concretely, the area of each level-2 grid 1034 is divided into four level-three grids, the area of each level-3 grid is divided into four level-four grids and so on. In this way, a grid having a finer area can be defined. By adjusting the level of grids used in the clustering processing, it is possible to establish a balance between the granularity of the clustering processing and the load of the processing.

As described above, in this embodiment, by dividing a grid of a specific level into two grids in the latitude direction and two grids in the longitude direction, four grids of a level immediately below the specific level can be obtained. In other words, the area of the grid of the specific level is divided into the four grids of the level immediately below the specific level. Thus, the hierarchical structure of the grids 1031 in this embodiment has a four-child tree structure with the level-0 grid 1032 serving as a root node which is divided into four grids of a level immediately below the highest level of the root node. In the four-child tree structure, each grid at every specific level below the highest level of the root node is divided into four grids of a level immediately below the specific level. The clusters 1021 each defined in one of the grids 1031 also have a four-child tree structure identical with that of the grids 1031.

In the ordinary distance-based positional clustering processing, if the tree structure of clusters is defined, a storage memory is required for holding information on the tree structure. In the case of the grid-based positional clustering processing carried out in accordance with this embodiment, on the other hand, the tree structure of the grids 1031 is uniquely determined as described above. Thus, by holding information indicating the grid level at which every grid 1031 is defined, the tree structure of the clusters 1021 can be known with ease on the basis of the four-child tree structure of the grids 1031.

### Clustering Result

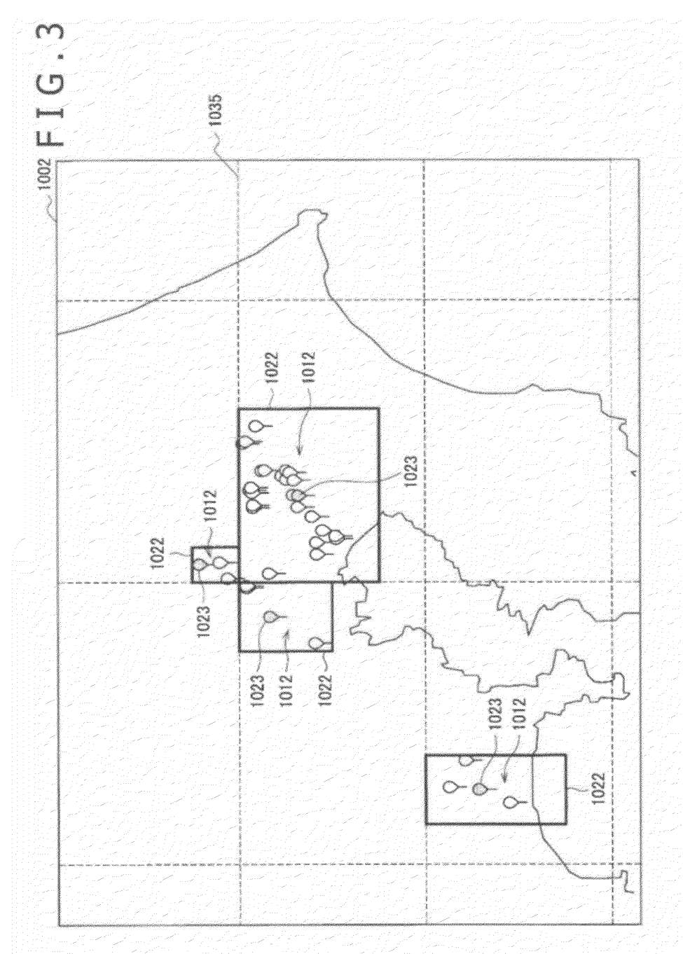

FIG. 3 is a diagram showing a typical result of clustering carried out in accordance with the first embodiment of the present disclosure. FIG. 3 shows a map 1002, a content icon 1012, a cluster area 1022, a cluster center 1023 and grid lines 1035.

The map 1002 is an image of a partial area of the earth surface 1001 or the entire area of the earth surface 1001. The map 1002 is shown in order to show the position of each content 1011 and the area of a cluster 1021 which is the result of clustering carried out on the contents 1011 to the user. The area of the earth surface 1001 represented by the map 1002 can be set in accordance with the range in which the contents 1011 exist on the earth surface 1001 or in accordance with an operation carried out by the user.

The content icon 1012 is displayed at a position existing on the map 1002 as a position corresponding to the area of the content 1011 on the earth surface 1001. The content icon 1012 is displayed as an icon having the shape of a pin. However, the displayed content icon 1012 does not have to have the shape of a pin. That is to say, the displayed content icon 1012 can have any one of a variety of shapes. In addition, the content icon 1012 may also display a portion of information such as characters or an image which are included in the content 1011 or all of the information.

The cluster area 1022 is displayed at a position existing on the map 1002 as a position corresponding to the area of the cluster 1021 on the earth surface 1001. The cluster area 1022 can be displayed as an area having the same shape as the cluster 1021 or, as an alternative, displayed as an area slightly made larger than the area of the cluster 1021 in order to typically prevent the display of the cluster area 1022 from overlapping the display of the content icon 1012 so as to make the content icon 1012 easy to look at.

The cluster center 1023 is displayed at a position existing on the map 1002 as a position corresponding to the position of the center of the cluster area 1022 or the position of the center of the cluster 1021 on the earth surface 1001. The cluster center 1023 is displayed in order to typically show recapitulative information extracted from the content 1011 included in the cluster 1021. If the content 1011 is image data, the recapitulative information is typically a representative image or a thumbnail image. However, it is not always necessary to display the cluster center 1023.

Grid lines 1035 are lines enclosing a grid 1031 used in clustering to group contents 1011 in a cluster 1021 associated with the grid 1031. The grid lines 1035 are not displayed on the map 1002 for displaying the result of clustering. For example, when the user changes the setting of the granularity of the clustering, however, the grid lines 1035 may be deliberately shown as reference information.

Comparison with the Distance-Based Positional Clustering: Merits of the Grid-Based Positional Clustering

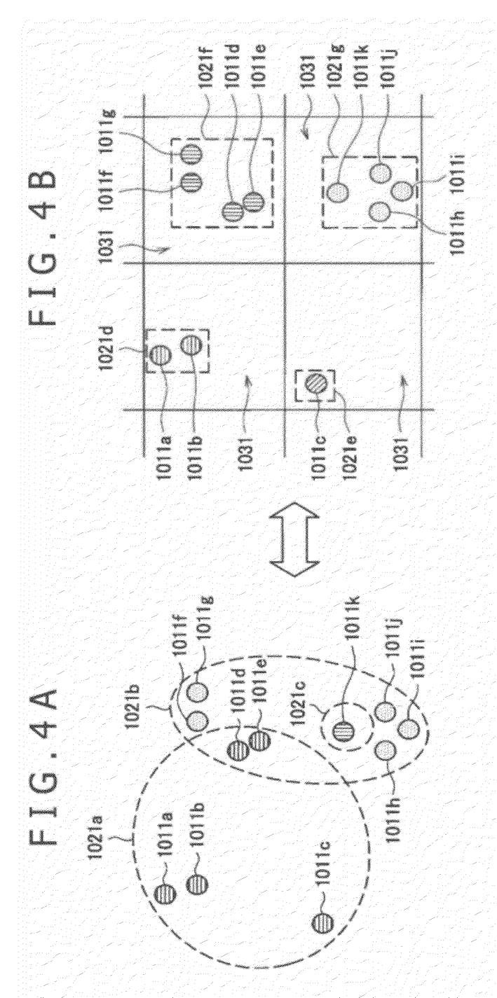

FIGS. 4A and 4B are explanatory diagrams referred to in the following description of typical comparison of the grid-based positional clustering carried out in accordance with the first embodiment of the present disclosure with the ordinary distance-based positional clustering. To be more specific, FIG. 4A is an explanatory diagram referred to in the following description of the ordinary distance-based positional clustering carried out on contents 1011a to 1011k. On the other hand, FIG. 4B is an explanatory diagram referred to in the following description of the grid-based positional clustering carried out on the same contents 1011a to 1011k in accordance with this embodiment.

As shown in FIG. 4A, as a result of the ordinary distance-based positional clustering carried out on the contents 1011a to 1011k, the contents 1011a to 1011e are grouped in a cluster 1021a, the contents 1011f to 1011j are grouped in a cluster 1021b whereas the content 1011k is put in a cluster 1021c. The shapes of the clusters 1021a to 1021c are each created to have an elliptical shape so that the clusters 1021a partially overlaps the cluster 1021b whereas the cluster 1021b includes the cluster 1021c as shown in the figure. In the case of distance-based positional clustering, the procedure for computing and comparing distances typically causes the areas of clusters to partially overlap each other and/or the area of a cluster to include the area of another cluster as described above in some cases.

As a result of the grid-based positional clustering carried out on the same contents 1011a to 1011k in accordance with this embodiment, on the other hand, as shown in FIG. 4B, the contents 1011a and 1011b are grouped in a cluster 1021d, the content 1011c is put in a cluster 1021e, the contents 1011d to 1011g are grouped in a cluster 1021f whereas the contents 1011h to 1011k are grouped in a cluster 1021g. As shown in the figure, the clusters 1021d to 1021g neither partially overlap each other nor include other clusters. That is to say, the clusters 1021d to 1021g are clearly separated from each other. As described above, in the case of the grid-based positional clustering carried out in accordance with this embodiment, a decision as to whether or not contents 1011 are to be grouped in a cluster 1021 is made on the basis of a result of a determination as to whether or not the contents 1011 pertain to the same grid 1031 including the cluster 1021. That is to say, the result of such a determination is used as the basic criterion of the clustering. Thus, as a rule, the area of a cluster 1021 is included in the area of the grid 1031 associated with the cluster 1021. As a result, the grid-based positional clustering carried out in accordance with this embodiment probably does not generate a clustering result in which a cluster 1021 partially overlaps or includes another cluster 1021.

Comparison with the Distance-Based Positional Clustering: Demerits of the Grid-Based Positional Clustering

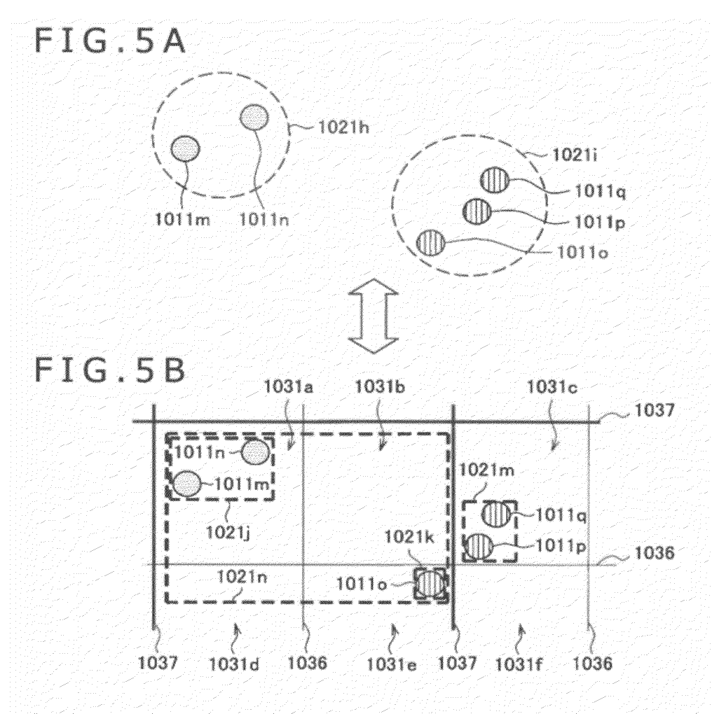

FIGS. 5A and 5B are other explanatory diagrams referred to in the following description of other typical comparison of the grid-based positional clustering carried out in accordance with the first embodiment of the present disclosure with the ordinary distance-based positional clustering. To be more specific, FIG. 5A is an explanatory diagram referred to in the following description of the ordinary distance-based positional clustering carried out on contents 1011m to 1011q. On the other hand, FIG. 5B is an explanatory diagram referred to in the following description of the grid-based positional clustering carried out on the same contents 1011m to 1011q in accordance with this embodiment.

As shown in FIG. 5A, as a result of the ordinary distance-based positional clustering carried out on the contents 1011m to 1011q, the contents 1011m and 1011n are grouped in a cluster 1021h whereas the contents 1011o to 1011q are grouped in a cluster 1021i. In the case of the ordinary distance-based positional clustering, basically, contents 1011 separated from each other by short distances are grouped in the same cluster 1021 as shown in the figure.

As a result of the grid-based positional clustering carried out on the contents 1011m to 1011q in accordance with this embodiment, on the other hand, as shown in FIG. 5B, the contents 1011m and 1011n are grouped in a cluster 1021j, the content 1011o is put in a cluster 1021k whereas the contents 1011p and 1011q are grouped in a cluster 1021m. As described above, in the case of the grid-based positional clustering carried out in accordance with this embodiment, a decision as to whether or not contents 1011 are to be grouped in a cluster 1021 is made on the basis of a result of a determination as to whether or not the contents 1011 pertain to the same grid 1031 including the cluster 1021. That is to say, the result of such a determination is used as the basic criterion of the clustering. Thus, contents 1011 not pertaining to the same grid 1031 including a cluster 1021 are not grouped in the cluster 1021 in some cases even if the contents 1011 are separated from each other only by short distances so that the contents 1011 would be grouped in a cluster 1021 if the ordinary distance-based positional clustering were carried out.

In addition, FIG. 5B also shows grid boundaries 1036 and upper-level grid boundaries 1037. A grid boundary 1036 is a boundary of a grid 1031 of a specific level. An upper-level grid boundary 1037 is a boundary of a grid 1031 of the specific level as well as a boundary of a grid 1031 provided at a level immediately higher than the specific level to serve as a grid 1031 including four child grids of the specific level. In the typical configuration shown in the figure, the contents 1011m and 1011n are included in a grid 1031a, the content 10110 is included in a grid 1031e whereas the contents 1011p and 1011q are included in a grid 1031c. In the following description, the grid 1031 of a level immediately higher than the specific level is referred to simply as an upper-level grid 1031.

The following description explains a case in which the grid-based positional clustering based on the high-level grid 1031 is carried out. As shown in FIG. 5B, the same high-level grid 1031 is composed of the grid 1031a including the contents 1011m and 1011n as well as the grid 1031e including the content 1011. Thus, as a result of the grid-based positional clustering carried out on the basis of the high-level grid 1031, the contents 1011m, 1011n and 10110 are grouped in a cluster 1021n of the high-level grid 1031.

On the other hand, the grid 1031c including the contents 1011p and 1011q pertains to an upper-level grid other than the high-level grid 1031. Thus, as a result of the grid-based positional clustering carried out on the basis of the other upper-level grid, the cluster including the contents 1011p and 1011q does not change. That is to say, the contents 1011p and 1011q are grouped in the aforementioned cluster 1021m of the other upper-level grid as they are.

As is obvious from the above description, the grid-based positional clustering has a big merit that the grid-based positional clustering can be carried out at an extremely high speed. The reader is advised to keep in mind, however, that contents 1011 not pertaining to the same grid 1031 including a cluster 1021 are not grouped in the cluster 1021 in some cases even if the contents 1011 are separated from each other only by short distances so that the contents 1011 would be grouped in a cluster 1021 if the ordinary distance-based positional clustering were carried out. To put it concretely, in the typical case shown in FIG. 5B for example, the contents 1011o, 1011p and 1011q are not group in the same cluster as a result of the grid-based positional clustering because the content 1011o pertains to the upper-level grid 1031 whereas the contents 1011p and 1011q pertain to the other grid even though the contents 1011o, 1011p and 1011q are separated from each other only by short distances.

In such a case, the result of the grid-based positional clustering can be made closer to the natural shape by carrying out merging processing to be described later. It is to be noted that, as will be described later, this merging processing can be carried out at a high speed by taking advantage of the properties of the grid-based positional clustering.

### 1-2: Configuration of the Information Processing Apparatus

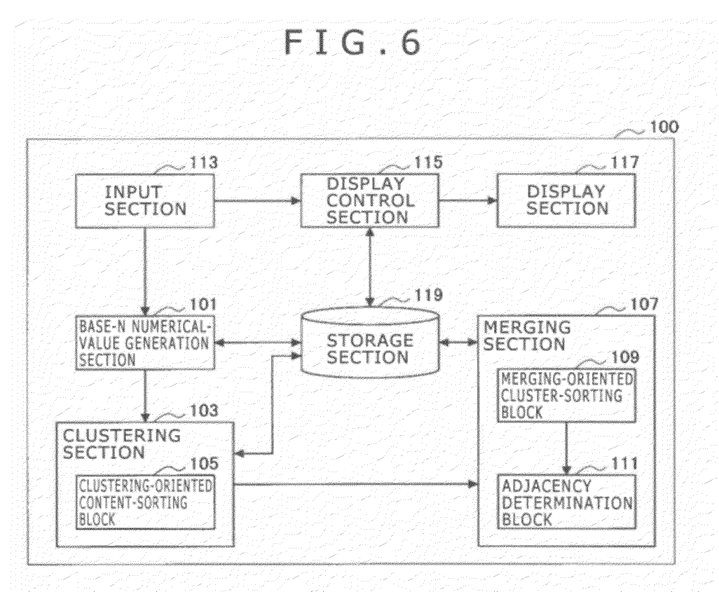

Next, by referring to FIGS. 6 to 8, the following description explains the configuration of the information processing apparatus according to the first embodiment of the present disclosure.

FIG. 6 is a block diagram showing the configuration of the information processing apparatus 100 according to the first embodiment of the present disclosure. In FIG. 6, the information processing apparatus 100 is shown as an apparatus employing components mainly included in the information processing apparatus 100. The components typically include a base-N numerical-value generation section 101, a clustering section 103, a merging section 107, an input section 113, a display control section 115, a display section 117 and a storage section 119.

The information processing apparatus 100 handles the contents 1011 described above as data. Typical examples of the content 1011 are image contents, various kinds of character information or various kinds of image information. The image content can be a standstill-image content of a moving-image content. The various kinds of character information and the various kinds of image information are registered in advance in a server or the like so as to allow users to share the stored information. Other typical examples of the content 1011 are a mail, a musical composition, a schedule, an electronic-money spending history, a phone-call history, a content viewing/listening history, information on sightseeing, information on districts, news, weather forecasts and a ringtone-mode history.

In the following description, image contents such as standstill-image or moving-image contents are taken as an example. However, the information processing apparatus 100 is capable of handling any arbitrary information and/or any arbitrary content data as long as the information and/or the content data are provided with positional information indicating a position in a feature space as typically metadata attached to the information and/or the content data.

In addition, it is desirable to store such content data and/or data representing various kinds of information in a memory embedded in the information processing apparatus 100. Since the data itself has been stored in an external apparatus such as a server provided externally to the information processing apparatus 100, however, the information processing apparatus 100 may be used for storing metadata associated with the data stored in the external apparatus. The following description explains a case in which a memory embedded in the information processing apparatus 100 is used for storing the content data and/or data representing various kinds of information as well as metadata associated with them.

### Base-N Numerical-Value Generation Section

The base-N numerical-value generation section 101 is configured to employ typically a CPU (Central Processing Unit), a ROM (Read Only Memory) and a RAM (Random Access Memory). In this embodiment, as described earlier, each content 1011 has positional information which is information on a content position on the earth surface 1001. The position on the earth surface 1001 is prescribed in a two-dimensional coordinate system in terms of a latitude and a longitude. The base-N numerical-value generation section 101 generates a combined base-N numerical value for a latitude and a longitude where N=2. That is to say, the base-N numerical-value generation section 101 generates a base-2 numerical value, which is also referred to as a binary-system numerical value, for a latitude and a longitude. The technical term ‘digit’ for binary-system numerical values is also referred to as a bit. For this reason, the technical term ‘digit’ used in the following description can be interpreted as a bit. To put it in detail, the latitude is a component binary-system numerical value represented by a string having a predetermined digit count representing the number of latitude digits composing the latitude. By the same token, the longitude is a component binary-system numerical value represented by a string having a predetermined digit count representing the number of longitude digits composing the longitude. The base-N numerical-value generation section 101 generates a combined binary-system numerical value representing the latitude and the longitude by alternately arranging the latitude digits and the longitude digits sequentially on a digit-after-digit basis to form a new digit string composed of the latitude digits and the longitude digits placed alternately with the latitude digits.

If the predetermined digit count representing the number of latitude digits or longitude digits is set in advance at 29 for example, the base-N numerical-value generation section 101 generates a combined binary-system numerical value having 29 latitude digits and 29 longitude digits. To put it concretely, let the component binary-system numerical value of the latitude be 29 latitude digits of “a₂₈a₂₇a₂₆ . . . a₀” whereas the component binary-system numerical value of the longitude be 29 longitude digits of “b₂₈b₂₇b₂₆ . . . b₀.” In this case, the base-N numerical-value generation section 101 generates a combined binary-system numerical value having 58 digits of “a₂₈b₂₈a₂₇b₂₇a₂₆ . . . b₀a₀” obtained by alternately arranging the latitude digits and the longitude digits sequentially on a digit-after-digit basis. The generated combined binary-system numerical value represents the latitude and the longitude.

It is to be noted that, on the assumption that the radius of the earth is 20,000 km, the smallest resolution of the latitude having 29 digits is about 0.04 m (=20,000 km/2²⁹). On the other hand, on the assumption that the diameter of the earth is 40,000 km, the smallest resolution of the longitude having 29 digits is about 0.07 m (=40,000 km/2²⁹). The predetermined digit count is set at a proper value found by considering the required minimum resolution and the size of a data unit used by the information processing apparatus 100. Typical examples of the size of the data unit are 32 digits and 64 digits.

As described above, from the component binary-system numerical value of the latitude and the component binary-system numerical value of the longitude, the base-N numerical-value generation section 101 generates a combined binary-system numerical value, allowing the positional information expressed in terms of two coordinates of the two-dimensional coordinate system to be held as one combined binary-system numerical value. In addition, since the base-N numerical-value generation section 101 generates a combined binary-system numerical value by alternately arranging the digits of the component binary-system numerical value of the latitude and the digits of the component binary-system numerical value of the longitude sequentially on a digit-after-digit basis, clustering can be carried out by the clustering section 103 with ease as will be described later.

### Clustering Section

The clustering section 103 is typically implemented by, among others, a CPU, a ROM and a RAM. The clustering section 103 includes a clustering-oriented content-sorting block 105 to be described later. The clustering section 103 groups contents 1011, which are represented by the binary-system numerical values generated by the base-N numerical-value generation section 101 as values having k most significant digits common to the contents 1011 (where k=1, 2 and so on) in the same cluster 1021.

If the relation k=2×m (where m=1, 2 and so on) holds true, the clustering section 103 groups contents 1011, which are represented by the binary-system numerical values generated by the base-N numerical-value generation section 101 as values having k most significant digits common to the contents 1011, in the same cluster 1021 on an mth layer of a cluster (2²)-child tree structure, that is, a four-child tree structure of clusters 1021.

Included in the clustering section 103 as described above, the clustering-oriented content-sorting block 105 is typically implemented by, among others, a CPU, a ROM and a RAM. The clustering-oriented content-sorting block 105 sorts contents 1011 in the order of binary-system numerical values each generated by the base-N numerical-value generation section 101 to represent one of the contents 1011. The contents 1011 sorted by the clustering-oriented content-sorting block 105 are then clustered by the clustering section 103. As will be described later, the clustering section 103 identifies contents 1011 to be grouped in the same cluster 1021 from the result of the sorting carried out by the clustering-oriented content-sorting block 105.

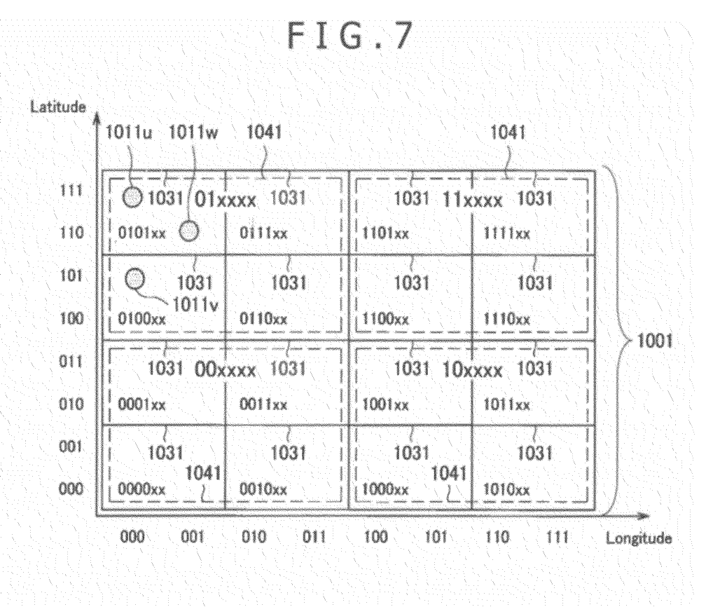

Next, the function of the clustering section 103 is explained by referring to FIG. 7. FIG. 7 is an explanatory diagram referred to in the following description of clustering carried out in accordance with the first embodiment of the present disclosure. FIG. 7 shows lower-level grids 1031 defined on the earth surface 1001, upper-level grids 1041 each serving as a grid at a level higher than the level of the grids 1031 and contents 1011u to 1011w each serving as a subject of clustering.

It is to be noted that, as explained earlier by referring to FIG. 1, in this embodiment, a cluster 1021 in which a content 1011 is to be grouped is defined by a grid 1031 including the content 1011. That is to say, at the clustering stage, if a grid 1031 including a content 1011 serving as a subject of clustering is identified, a cluster 1021 in which the content 1011 is to be grouped is defined automatically. Therefore, the processing carried out by the clustering section 103 to group contents 1011 in a cluster 1021 is essentially the same processing to determine a grid 1031 including the contents 1011. Thus, the description with reference to FIG. 7 mainly explains the processing carried out by the clustering section 103 to identify a grid 1031 including contents 1011 each serving as a subject of clustering.

In order to make the description of the typical example shown in the figure simple, each of the latitude and the longitude which compose the information on the position of every content 1011 is expressed by a component binary-system numerical value having three digits. In this typical example, each of the latitude and the longitude is expressed by a component binary-system numerical value having three digits in a range of 000 to 111. Thus, the base-N numerical-value generation section 101 alternately arranges the digits of the component binary-system numerical values of the latitude and the longitude sequentially on a digit-after-digit basis in order to generate a six-digit combined binary-system numerical value in a range of 000000 to 111111 as the value representing both the latitude and the longitude. As a result, for the content 1011u having a longitude of 000 and a latitude of 111, the base-N numerical-value generation section 101 generates a combined binary-system numerical value of 010101 obtained by alternately arranging the digits 000 of the longitude and the digits 111 of the latitude sequentially on a digit-after-digit basis. In addition, for the content 1011v having a longitude of 001 and a latitude of 110, the base-N numerical-value generation section 101 generates a combined binary-system numerical value of 010110 obtained by alternately arranging the digits 001 of the longitude and the digits 110 of the latitude sequentially on a digit-after-digit basis. On top of that, for the content 1011w having a longitude of 000 and a latitude of 101, the base-N numerical-value generation section 101 generates a combined binary-system numerical value of 010001 obtained by alternately arranging the digits 000 of the longitude and the digits 101 of the latitude sequentially on a digit-after-digit basis.

By the way, in the typical example shown in the figure, the earth surface 1001 is divided into four upper-level grids 1041 whereas each of the upper-level grids 1041 is divided into 4 lower-level grids 1031. That is to say, in the typical example shown in the figure, the grids 1031 have a four-child tree structure. If the entire earth surface 1001 is taken as the highest-level grid on the zeroth layer of the four-child tree structure, each of the four upper-level grids 1041 is a grid on the first layer of the tree structure whereas each of the 16 lower-level grids 1041 is a grid on the second layer of the structure. As explained before, the zeroth layer is also referred to as the root node of the tree structure.

As described above, in the clustering carried out in accordance with this embodiment, the cluster 1021 is associated with the grid 1031. Thus, in the typical example shown in the figure, the clusters 1021 have a four-child tree structure as the grids 1031 do. To put it concretely, the cluster 2021 including all contents 1011 existing on the earth surface 1001 corresponds to the root node of the four-child tree structure or the zeroth layer of the four-child tree structure. A cluster 1021 including contents 1011 included in an upper-level grid 1041 is a cluster on the first layer whereas a cluster 1021 including contents 1011 included in a lower-level grid 1031 is a cluster on the second layer.

The following description explains an operation carried out by the clustering section 103 to group contents 1011, which are each represented by one of binary-system numerical values generated by the base-N numerical-value generation section 101 as values having k most significant digits common to the contents 1011, in the same cluster 1021.

For example, contents 1011 each having a longitude in a range of 000 to 011 and a latitude in a range of 100 to 111 pertain to the upper-level grid 1041 on the left upper corner of the earth surface 1001. In these ranges, the most significant digit of the longitude is 0 whereas the most significant digit of the latitude is 1. Thus, the two most significant digits of binary-system numerical values each representing one of the contents 1011 are 01. That is to say, the binary-system numerical values each representing one of the contents 1011 in the upper-level grid 1041 on the left upper corner of the earth surface 1001 are 01xxxx. By the same token, the binary-system numerical values each representing one of the contents 1011 in the upper-level grid 1041 on each of the three other corners of the earth surface 1001 are 11xxxx, 00xxxx and 10xxxx respectively. That is to say, grids of the four-child tree structure include four upper-level grids 1041 which are each a grid on the first layer. An upper-level grid 1041 including a content 1011 can be identified from the two most significant digits of the binary-system numerical value representing the content 1011. Thus, a plurality of contents 1011 each represented by one of binary-system numerical values having the two most significant digits common to the contents 1011 pertain to the same upper-level grid 1041. That is to say, the contents 1011 are grouped in the same cluster 1021 associated with the upper-level grid 1041. In other words, the contents 1011 are grouped in the same cluster 1021 on the first layer of the four-child tree structure.

The grid 1031 on the left upper corner of the earth surface 1001 includes a content 1011 having a longitude of 000 and a latitude of 110 and a content 1011 having a longitude of 001 and a latitude of 111. In the range of longitudes, the two most significant digits of the longitudes are 00. In the range of latitudes, on the other hand, the two most significant digits of the latitudes are 11. Thus, the four most significant digits of a binary-system numerical value representing a content 1011 in the grid 1031 are 0101. That is to say, a binary-system numerical value representing a content 1011 in the grid 1031 is 0101xx. By the same token, binary-system numerical values each representing a content 1011 in any of the other grids 1031 have the four most significant digits unique to the other grid 1031. That is to say, grids of the four-child tree structure include 16 grids 1031 which are each a grid on the second layer. A grid 1031 including a content 1011 can be identified from the four most significant digits of the binary-system numerical value representing the content 1011. Thus, a plurality of contents 1011 each represented by one of binary-system numerical values having the four most significant digits common to the contents 1011 pertain to the same grid 1031. That is to say, the contents 1011 are grouped in the same cluster associated with the grid 1031. In other words, the contents 1011 are grouped in the same cluster on the second layer of the four-child tree structure.

Next, by referring to FIG. 7, clustering of the contents 1011u to 1011w is explained below as a concrete typical example of clustering. First of all, the content 1011u is represented by a binary-system numerical value of 010101. Since the four most significant digits of the binary-system numerical value representing the content 1011u are 0101, the content 1011u is determined to pertain to a grid 1031 represented by the binary-system numerical value of 0101xx as a grid 1031 on the left upper corner of the earth surface 1001.

Then, the content 1011v is represented by a binary-system numerical value of 010001. Since the four most significant digits of the binary-system numerical value representing the content 1011v are 0100, the content 1011v is determined to pertain to a grid 1031 represented by the four most significant digits of the binary-system numerical value of 0100xx as a grid 1031 other than the grid 1031 to which the content 1011u pertains. In a word, the content 1011v is determined to pertain to a grid 1031 different from the grid 1031 to which the content 1011u pertains.

Then, the content 1011w is represented by a binary-system numerical value of 010110. Since the four most significant digits of the binary-system numerical value representing the content 1011w are also 0101, the content 1011w is determined to pertain to a grid 1031 represented by the four most significant digits of the binary-system numerical value of 0101xx as a grid 1031 on the left upper corner of the earth surface 1001. That is to say, the content 1011w is determined to pertain to the same grid 1031 as the content 1011u.

The reader is requested to consider a case in which the clustering-oriented content-sorting block 105 has sorted the contents 1011u to 1011w in the order of the binary-system numerical values each representing one of the contents 1011u to 1011w. The result of the sorting the contents 1011u to 1011w in the order of increasing binary-system numerical values each representing one of the 1011u to 1011w is given as follows:

Content 1011v “010001”
Content 1011u “010101”
Content 1011w “010110”

The contents 1011u and 1011w pertaining to the same grid or grouped in the same cluster are adjacent to each other in the result of the sorting. Thus, the clustering section 103 is capable of identifying contents 1011 grouped in the same cluster from the result of the sorting carried out by the clustering-oriented content-sorting block 105.

It is to be noted that the processing carried out by the clustering section 103 and the clustering-oriented content-sorting block 105 will be described in detail later.

### Merging Section

The merging section 107 is implemented by making use of components including a CPU, a ROM and a RAM. As shown in FIG. 6, the merging section 107 has a merging-oriented cluster-sorting block 109 and an adjacency determination block 111 which are described later. The merging-oriented cluster-sorting block 109 sorts clusters 1021 identified by the clustering section 103 whereas the adjacency determination block 111 determines whether or not the clusters 1021 which have been sorted by the merging-oriented cluster-sorting block 109 are adjacent to each other. Then, the merging section 107 carries out merging processing on clusters 1021 which have been determined by the adjacency determination block 111 to be adjacent to each other in a certain direction on the earth surface 1001. As will be explained later, the merging processing carried out by the merging section 107 can be search-order merging or distance-order merging. In addition, in order to determine clusters 1021 to serve as subjects of the merging processing, the merging section 107 may make use of results of processing carried out by the merging-oriented cluster-sorting block 109 and the adjacency determination block 111 in some cases. On top of that, in order to set a condition for the merging processing, the merging section 107 may refer to predetermined merging-condition setting information stored in advance in the storage section 119.

The merging-oriented cluster-sorting block 109 employed in the merging section 107 is implemented by components including a CPU, a ROM and a RAM. The merging-oriented cluster-sorting block 109 sorts clusters 1021 in a certain direction on the earth surface 1001 on the basis of the result of ranking determination processing based on latitudes and longitudes as described below. The merging-oriented cluster-sorting block 109 supplies the result of the sorting to the adjacency determination block 111. In this embodiment, the aforementioned ranking determination processing is processing carried out to sort grids 1031 in a certain direction on the earth surface 1001 in order to set a sorting order of the grids 1031 and provide the sorting order of the grids 1031 to clusters 1021 each associated with one of the sorted grids 1031 as a ranking of the clusters 1021. Typical examples of the certain direction on the earth surface 1001 are an east-west direction, a south-north direction, a northwest-southeast direction and a southwest-northeast direction.

The adjacency determination block 111 employed in the merging section 107 is implemented by components including a CPU, a ROM and a RAM. The adjacency determination block 111 determines whether or not clusters 1021, which have been sorted by the merging-oriented cluster-sorting block 109 in a certain direction on the earth surface 1001, are adjacent to each other in the direction. The determination result produced by the adjacency determination block 111 is used by the merging section 107 in processing to merge the clusters 1021 with each other. In this embodiment, the adjacency determination processing carried out by the adjacency determination block 111 to determine whether or not clusters 1021 are adjacent to each other can be processing to determine whether or not grids 1031 each including one of the clusters 1021 are adjacent to each other.

The function of the merging section 107 is explained below by referring to FIG. 8. FIG. 8 is an explanatory diagram referred to in the following description of the processing to merge clusters 1021 with each other in accordance with the first embodiment of the present disclosure. FIG. 8 shows grids 1031x and 1031y adjacent to each other in the longitude direction and clusters 1021x and 1021y which are included in the grids 1031x and 1031y respectively.

In the typical example shown in the figure, the clusters 1021x and 1021y included in respectively the grids 1031x and 1031y adjacent to each other can be treated as clusters 1021 adjacent to each other. In this case, the merging section 107 may compute the distance d between clusters 1021 adjacent to each other. The distance d between clusters 1021 adjacent to each other is typically the distance d between the centers of the clusters 1021. If the distance d between clusters 1021 adjacent to each other is not greater than a threshold value determined in advance, the merging section 107 merges the clusters 1021 with each other into one cluster. In the case of the typical example shown in the figure, if the distance d between the clusters 1021x and 1021y treated as clusters 1021 adjacent to each other is not greater than a threshold value determined in advance, the merging section 107 merges the clusters 1021x and 1021y with each other into one cluster 1021z.

As described above, if clusters 1021 are adjacent to each other in the latitude or longitude direction, the merging section 107 may compute the distance between the clusters 1021. In addition, the merging section 107 may compute the distance between clusters 1021 without regard to whether or not the clusters 1021 are adjacent to each other. On top of that, if the distance between clusters 1021 is not greater than a threshold value determined in advance, the merging section 107 may store the clusters 1021 in the storage section 119 as merging-candidate clusters 1021 instead of merging the clusters 1021 with each other right away. In this case, the merging section 107 later merges the merging-candidate clusters 1021 with each other in an order starting with merging-candidate clusters 1021 having the shortest distance among the merging-candidate clusters, that is, in an order of increasing distances between merging-candidate clusters 1021.

It is to be noted that the processing carried out by the merging section 107, the merging-oriented cluster-sorting block 109 and the adjacency determination block 111 will be described in detail later.

### Input Section

The reader is requested to refer back to FIG. 6. The input section 113 is a typical input section employed in the information processing apparatus 100 according to the embodiment. The input section 113 is typically implemented by components including a CPU, a ROM, a RAM and an input unit. The input unit employed in the input section 113 of the information processing apparatus 100 typically has a keyboard, a mouse and a touch panel which are operated by the user. The input section 113 generates an electrical signal representing an operation carried out by the user on the input section 113 and supplies the electrical signal to the base-N numerical-value generation section 101 and the display control section 115. To put it concretely, if the user carries out an operation on the input section 113 to make a request for execution of the clustering or an operation to make a request for a change of the clustering granularity for example, the input section 113 generates information indicating the request and supplies the information to the base-N numerical-value generation section 101 and other sections.

### Display Control Section

The display control section 115 is typically implemented by components including a CPU, a ROM and a RAM. When the input section 113 notifies the display control section 115 that the user has carried out an operation to make a request for a display of a clustering result of contents 1011 for example, the display control section 115 acquires the result of the clustering of contents 1011 from the storage section 119 or the like. This is because such a result has been stored in the storage section 119 or the like by the clustering section 103 and the merging section 107. Later on, the display control section 115 may create an image of the clustering result and carries out control to display the image on the display section 117 to be described below. A typical example of the clustering-result image is the image explained earlier by referring to FIG. 3.

### Display Section

The display section 117 is a typical display section employed in the information processing apparatus 100 according to the embodiment. The display section 117 is a section for displaying, among others, a variety of contents that can be processed by the information processing apparatus 100 and execution images of a variety of applications. In addition, the display section 117 may also display a variety of objects to be used in executing, among others, operations on a variety of contents 1011 and display execution states of a variety of applications. In accordance with control carried out by the display control section 115, the display screen of the display section 117 shows various kinds of information such as a clustering-result image like the one described earlier by referring to FIG. 3.

### Storage Section

The storage section 119 is a typical storage device employed in the information processing apparatus 100 according to the embodiment. The storage section 119 may be used for storing various kinds of data. The data stored in the storage section 119 includes various kinds of content data of the information processing apparatus 100 and various kinds of metadata associated with the content data. In addition, the storage section 119 may also be used for storing binary-system numerical values generated by the base-N numerical-value generation section 101, results of clustering carried out by the clustering section 103 to group contents 1011 in clusters 1021 and results of merging carried out by the merging section 107 to merge clusters 1021 with each other. On top of that, the storage section 119 may also be used for storing execution data to be utilized by a variety of applications in processing carried out by the display control section 115 to display various kinds of information on the display section 117. Furthermore, the storage section 119 may also be used for properly storing other information such as a variety of parameters, a variety of intermediate results and a variety of databases. The parameters are required during some processing carried out by the information processing apparatus 100 whereas the intermediate results are produced in the course of processing carried out by the information processing apparatus 100. A variety of processing sections employed in the information processing apparatus 100 according to this embodiment are capable of freely writing information and/or data into the storage section 119 and reading out information and/or data from the storage section 119 with a high degree of freedom.

### Supplementary Information on the Information Processing Apparatus

It is to be noted that the information processing apparatus 100 according to the embodiment can be any apparatus as long as the apparatus has a function to acquire positional information associated with a content 1011 from the content 1011 itself or an additional data file. Typical examples of the information processing apparatus 100 include an image taking apparatus, a multi-media content viewer having a memory embedded therein, a portable information terminal, a portable game terminal, a hand phone, a digital home electrical appliance and a game machine. Typical examples of the image taking apparatus include a digital still camera and a digital video camera. The portable information terminal can be typically used for recording as well as saving contents and can be typically used for browsing recorded or saved contents. The portable game terminal typically renders services of providing maps on networks and services of managing and browsing joint contents. In addition, the portable game terminal typically also has application software of personal computers and a function for managing picture data. The hand phone typically has a camera embedded therein and a memory. The digital home electrical appliance typically has a memory and a function for managing picture data.

The above descriptions have explained typical functions of the information processing apparatus 100. Each of the configuration elements employed in the information processing apparatus 100 can be a general-purpose member and/or a general-purpose circuit or can be a piece of hardware designed specially for the function of the configuration element. In addition, the functions of all the configuration elements can be carried out by a CPU. Thus, the configuration used for implementing the information processing apparatus 100 can be modified properly in accordance with the technological level which is improved from time to time as the level of a technology for realizing the embodiment.

It is to be noted that a computer program written for implementing the functions of the information processing apparatus 100 according to the embodiment described above can be executed by a personal computer or the like. In addition, it is possible to provide the user with a recording medium used for storing the computer program in such a way that the personal computer or the like is capable of reading out the program from the medium. Typical examples of the recording medium include a magnetic disc, an optical disc, an opto-magnetic disc and a flash memory. In addition, instead of storing the computer program on a recording medium, the computer program can be distributed to users through a network or the like.

### 1-3: Details of Clustering and Merging

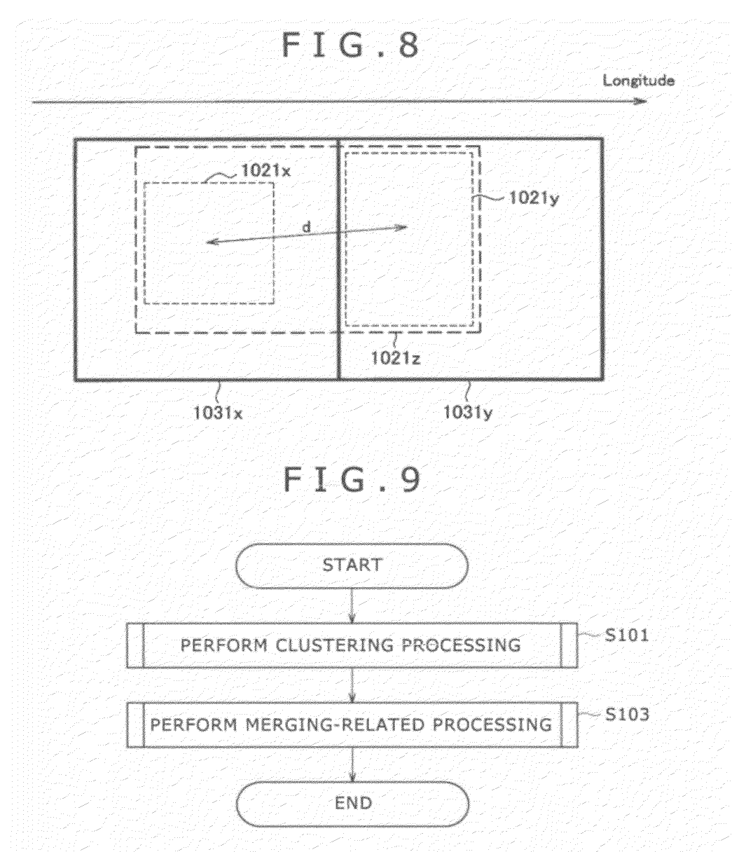

Next, by referring to FIGS. 9 to 29, the following description explains details of the clustering processing and the merging processing which are carried out in accordance with the first embodiment of the present disclosure.

FIG. 9 shows a flowchart representing the clustering processing and the merging processing which are carried out in accordance with the first embodiment of the present disclosure. As described earlier by referring to FIG. 6, in the information processing apparatus 100 according to the embodiment, the merging section 107 carries out the merging processing on clusters 1021 obtained as a result of the clustering processing carried out by the clustering section 103 on contents 1011.

Thus, the flowchart representing the clustering processing and the merging processing begins with a step S101 at which the clustering processing is carried out by the clustering section 103 to group contents 1011 in clusters 1021. Then, at the next step S103, merging-related processing is carried out by the merging section 107 on the clusters 1021. It is to be noted that the merging-related processing is processing including the merging processing itself and related processing which includes parameter setting. The clustering processing and the merging-related processing will be described in detail later.

TABLE 1

| grid level | merging threshold value (km) |
|---|---|
| 5 | 1500 |
| 6 | 800 |
| 7 | 400 |
| 8 | 200 |
| 9 | 100 |
| 10 | 50 |
| 11 | 25 |
| 12 | 10 |
| 13 | 5 |
| 14 | 2.5 |
| 15 | 1 |

Each entry in Table 1 shows a combination composed of a grid level set in the clustering processing and a merging threshold value set in the merging processing as a value associated with the grid level. If a combination composed of a grid level of 10 and a merging threshold value of 50 km is selected for example, the grid level of 10 is used in the clustering processing. In the grid hierarchical structure explained before by referring to FIG. 2, an upper-level grid is divided into four child grids at a level immediately lower than the level of the upper-level grid. Thus, the level-10 grid has an area obtained as a result of dividing the entire earth surface 1001 by 4¹⁰. As described before, the entire earth surface 1001 is the area of the level-0 grid. In addition, the merging threshold value set in the merging processing is the threshold value for a distance d explained earlier by referring to FIG. 8 as the distance between clusters 1021. In the case of the selected combination described above, if the distance d between a plurality of clusters 1021 is found equal to or smaller than the merging threshold value of 50 km in the process of merging the clusters 1021 each included in one of grids 1031 adjacent to each other, the clusters 1021 are merged with each other.

The merging threshold value for each of the grid levels can be set at any arbitrary value. Each combination shown in Table 1 as a combination composed of a grid level of a grid 1031 and a merging threshold value for the grid is a typical combination composed of such a grid level and such a threshold value that, in the neighborhood of the north latitude of 40 degrees, the grid 1031 is included in a circle having a radius equal to the merging threshold value. If the grid level is increased to a value relatively large in comparison with the merging threshold value, that is, if the size of the grid 1031 is decreased to a value relatively small in comparison with the merging threshold value, grids 1031 are determined to be grids 1031 not adjacent to each other so that clusters 1021 each included in one of the grids 1031 may not be merged with each other in some cases even if the distance between the clusters 1021 is not greater than the merging threshold value. If a four-direction search to be described later, an upper-level search also to be described later or another search is carried out in order to widen the range of the grid-adjacency determination, however, the smaller the size of the grid 1031, the higher the degree to which the result of the clustering approaches the natural shape in spite of the fact that, the smaller the size of the grid 1031, the larger the amount of the processing.

### Details of the Clustering

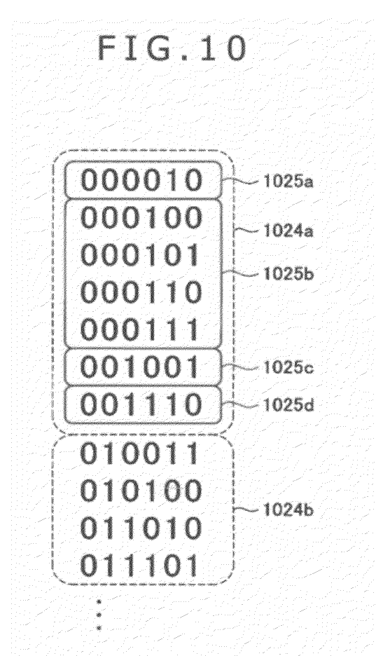

The clustering processing carried out by the clustering section 103 is explained in more detail by referring to FIG. 10 as follows. FIG. 10 is an explanatory diagram referred to in the following description of the clustering processing carried out in accordance with the first embodiment of the present disclosure. FIG. 10 shows a state of contents 1011 sorted by the clustering-oriented content-sorting block 105 of the clustering section 103 in the order of increasing binary-system numerical values which have been generated by the base-N numerical-value generation section 101 as values each representing one of the contents 1011. In the sorting result shown in the figure as the result of the sorting carried out by the clustering-oriented content-sorting block 105, the contents 1011 are arranged as contents 1011 grouped in the clusters 1024a and 1024b on the first layer. The contents 1011 grouped in the cluster 1024a are further arranged as contents 1011 grouped in the clusters 1025a to 1025d on the second layer. It is to be noted that, in order to make the explanation simple, also in the case of the clustering result shown in FIG. 10, each of the latitude and the longitude which compose the information on the position of a content 1011 is expressed by a binary-system numerical value having three digits.

As described above, in the clustering carried out in accordance with the embodiment, a plurality of contents 1011 each represented by one of binary-system numerical values generated by the base-N numerical-value generation section 101 as binary-system numerical values having k most significant digits common to the contents 1011 are grouped in the same cluster 1021. In addition, if the relation k=2×m (where m=1, 2 and so on) holds true, the cluster 1021 serving as a group including contents 1011 each represented by one of binary-system numerical values having k most significant digits common to the contents 1011 is a cluster 1021 on the mth layer of a 4 (=2²)-child tree structure of clusters 1021. For example, for m=1 or k=2, a plurality of contents 1011 each represented by one of binary-system numerical values having two most significant digits common to the contents 1011 are grouped in the same cluster 1021 on the first layer of the four-child tree structure of clusters 1021.

That is to say, there are 4 clusters 1021 on the first layer of the four-child tree structure. The first cluster 1021 on the first layer of the four-child tree structure serves as a group of contents 1011 each having one of the binary-system numerical values of 00xxxx. By the same token, the second cluster 1021 on the first layer of the four-child tree structure serves as a group of contents 1011 each having one of the binary-system numerical values of 01xxxx. In the same way, the third cluster 1021 on the first layer of the four-child tree structure serves as a group of contents 1011 each having one of the binary-system numerical values of 10xxxx. Likewise, the fourth cluster 1021 on the first layer of the four-child tree structure serves as a group of contents 1011 each having one of the binary-system numerical values of 11xxxx.

On the other hand, 16 clusters 1021 are on the second layer of the four-child tree structure. The 16 clusters 1021 on the second layer of the four-child tree structure serve as respectively 16 groups of contents 1011 represented by the binary-system numerical values of 0000xx, 0001xx, 0010xx, - - - and 1111xx respectively.

In the typical example shown in FIG. 10, the cluster 1024a which is a typical cluster 1021 on the first layer serves as a group of contents 1011 each represented by one of the binary-system numerical values of 00xxxx. By the same token, the cluster 1024b which is another typical cluster 1021 on the first layer serves as a group of contents 1011 each represented by one of the binary-system numerical values of 01xxxx.

On the other hand, the cluster 1025a which is a typical cluster 1021 on the second layer serves as a group including contents 1011 each represented by one of the binary-system numerical values of 0000xx. By the same token, the cluster 1025b which is another typical cluster 1021 on the second layer serves as a group including contents 1011 each represented by one of the binary-system numerical values of 0001xx. In the same way, the cluster 1025c which is a further typical cluster 1021 on the second layer serves as a group including contents 1011 each represented by one of the binary-system numerical values of 0010xx whereas the cluster 1025d which is a still further typical cluster 1021 on the second layer serves as a group including contents 1011 each represented by one of the binary-system numerical values of 0011xx.

In the case of the clusters 1021 on the second layer for example, the content 1011 represented by the binary-system numerical value of 000010 at the beginning of the sorted binary-system numerical values is included in the cluster 1025a on the second layer. In addition, the four following clusters 1021 represented by the four binary-system numerical values of 000100 to 000111 respectively are included in the cluster 1025b on the second layer. On top of that, the next content 1011 represented by the binary-system numerical value of 001001 is included in the cluster 1025c on the second layer whereas the next content 1011 represented by the binary-system numerical value of 001110 is included in the cluster 1025d on the second layer.

In the case of the clusters 1021 on the first layer for example, the seven contents 1011 represented by respectively the seven binary-system numerical values of 000010 to 001110 at the beginning of the sorted binary-system numerical values are included in the cluster 1024a on the first layer. In addition, the four following contents 1011 represented by respectively the four binary-system numerical values of 010011 to 011101 at the beginning of the sorted binary-system numerical values are included in the cluster 1024b on the first layer.

As described above, when contents 1011 are sorted in an order of increasing binary-system numerical values each generated by the base-N numerical-value generation section 101 as a binary-system numerical value representing one of the contents 1011 in the clustering carried out in accordance with the embodiment as described above, the contents 1011 are arranged in cluster units each serving as a group of contents 1011. That is to say, the clustering according to the embodiment is carried out by sorting contents 1011 in an order of increasing binary-system numerical values each generated by the base-N numerical-value generation section 101 as a binary-system numerical value representing one of the contents 1011.

In the ordinary distance-based positional clustering, the processing to search for a pair of contents separated from each other by a short distance is carried out as many times as the number of content combinations. That is to say, the processing to search for such a pair of contents is carried out O (N²) times where notation N denotes the number of contents. In the case of the clustering processing carried out in accordance with the embodiment of the present disclosure, on the other hand, the clustering processing is virtually the sorting processing described above. Thus, the processing is carried out only O (N log N) times where notation N denotes the number of contents 1011. That is to say, the processing needs to be carried out few times in comparison with the ordinary distance-based positional clustering. In addition, in each processing in the distance-based positional clustering, a distance between positions in a two-dimensional coordinate system is computed whereas, in each processing in the clustering carried out in accordance with the embodiment, two numerical values are merely compared so that the load borne by a processor for carrying out the processing can be reduced.

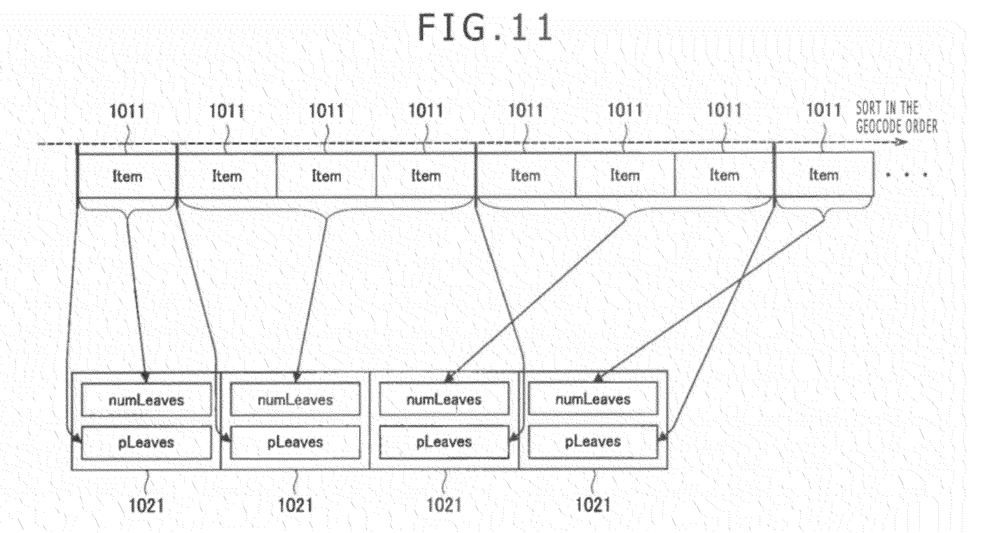

FIG. 11 is an explanatory diagram referred to in the following description of cluster identifying information according to the first embodiment of the present disclosure. FIG. 11 shows an array of pieces of information each used for identifying a content 1011 and an array of pieces of information each used for identifying a cluster 1021. In the following description, each piece of information used for identifying a cluster 1021 is also referred to as cluster identifying information.

In the embodiment, the clustering section 103 generates cluster identifying information used for identifying a cluster 1021 of a sorting result produced by the clustering-oriented content-sorting block 105. The cluster identifying information is composed of the position of a first content 1011 appearing in the cluster 1021 and the number of contents 1011 grouped in the cluster 1021.

In the typical example shown in the figure, a content 1011 is defined by a data structure referred to as an Item. The Item typically has a data structure like one described as follows:

```
struct Item {
    uint32  id;
    uint64  geocode;
};
```

In the data structured described above, a data-structure element id is an ID assigned to the content 1011 as an ID unique to the content 1011 and is used for identifying the content 1011. A data-structure element geocode is a binary-system numerical value generated by the base-N numerical-value generation section 101 to represent the content 1011. An array of data structures Item shown in the figure is the result of clustering carried out on the data structures Item on the basis of the binary-system numerical values each representing one of the data-structure elements geocode.

In addition, in the typical example shown in the figure, a cluster 1021 is defined by a data structure referred to as a Cluster. The Cluster typically has a data structure like one described as follows:

```
struct Cluster {
    uint64_t  clusterid;
    uint32_t  latcode;
    uint32_t  lngcode;
    float  latitude;
    float  longitude;
    float  halfEW;
    float  halfNS;
    uint32  numLeaves;
    Item  *pLeaves;
};
```

In the data structured described above, a data-structure element clusterid is an ID assigned to the cluster 1021 as an ID unique to the cluster 1021 and is used for identifying the cluster 1021. Data-structure elements latcode and lngcode are the codes of respectively the latitude and longitude of (typically the center of) a grid 1031 associated with the cluster 1021. If a binary-system numerical value of 100111 represents (typically the center of) a grid 1031 associated with the cluster 1021 for example, the code of the data-structure element latcode is 011 whereas the code of the data-structure element lngcode is 101. Data-structure elements latitude, longitude, halfEW and halfNS are each information used for defining the area of the cluster 1021.

A data-structure element numLeaves is the number of contents 1011 grouped in the cluster 1021. On the other hand, a data-structure element *pLeaves is a pointer pointing to the position of the first content 1011 included in the cluster 1021 as one of the contents 1011 obtained as the result of sorting carried out by the clustering-oriented content-sorting block 105 on the data structures Item on the basis of the data-structure elements geocode each included in one of the data structures Item. The two data-structure elements numLeaves and *pLeaves which are included in the data structure Cluster representing a cluster 1021 are information used for identifying the cluster 1021 serving as a group including the first content 1011. As is the case with the typical example explained before by referring to FIG. 8, the array of the data structures Item obtained as a result of clustering carried out on the data structures Item on the basis of the data-structure elements geocode each included in one of the data structures Item is an array of contents 1011 each defined by one of the data structures Item, and each array of contents 1011 is provided for a cluster 1021 serving as a group including the contents 1011. Thus, the data-structure elements numLeaves and *pLeaves can be used for identifying a cluster 1021 serving as a content group starting with the first content 1011 pointed to by the data-structure element *pLeaves and including contents 1011 the number of which is specified by the data-structure element numLeaves.

If contents have been grouped in a cluster in the case of the ordinary distance-based positional clustering, information used for defining the cluster is information used for identifying each of the contents already grouped in the cluster. Typically, the information used for defining the cluster includes an array of content IDs each used for identifying one of the contents grouped in the cluster. In this case, the size of array of content IDs increases proportionally to the number of contents grouped in the cluster. Thus, the amount of information used for defining a cluster also increases proportionally to the number of contents grouped in the cluster.

In the case of the distance-based positional clustering carried out in accordance with the embodiment, on the other hand, as described above, the data-structure elements numLeaves and *pLeaves are used as information for identifying a cluster 1021 serving as a group starting with the first content 1011 pointed to by the data-structure element *pLeaves and including contents 1011 the number of which is specified by the data-structure element numLeaves. Thus, the amount of information used for defining a cluster 1021 can be reduced to a small value and sustained at this value even if the number of contents 1011 grouped in the cluster 1021 increases.

### Details of the Merging-Related Processing

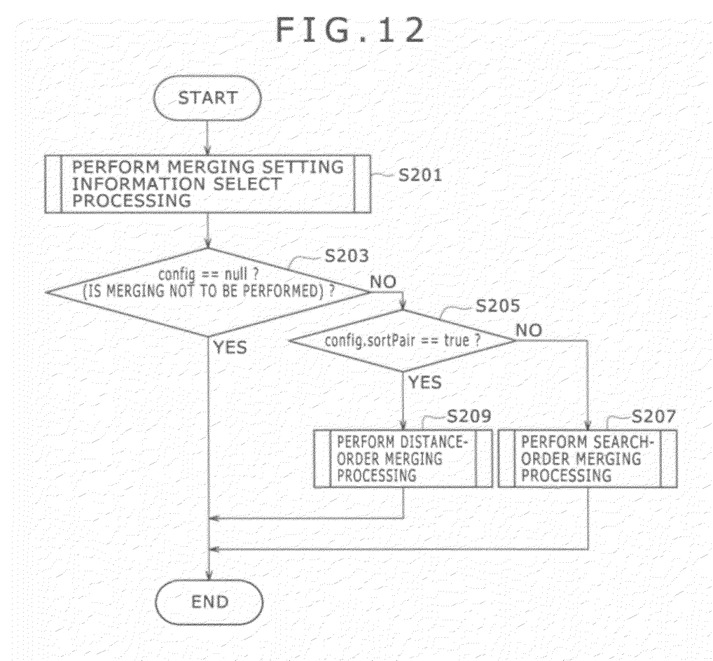

FIG. 12 shows a flowchart representing merging-related processing carried out by the merging section 107 in accordance with the first embodiment of the present disclosure. As shown in the flowchart, the merging-related processing includes a step S203 of making a determination as to whether or not merging setting information (config) has been set in order to make a decision as to whether or not merging processing is to be carried out. If the decision to carry out the merging processing is made, the contents of the merging setting information (config) are examined at a step S205 in order to determine whether the merging processing is to be carried out as search-order merging or distance-order merging. It is to be noted that the merging setting information (config) is also used in setting parameters in the search-order merging and the distance-order merging.

The flowchart representing the merging-related processing is explained in detail as follows. As shown in the figure, the flowchart begins with a step S201 at which the merging section 107 carries out merging setting information select processing. In the merging setting information select processing, merging setting information (config) is selected. It is to be noted that details of the merging setting information select processing will be described later.

Then, at the next step S203, the merging section 107 determines whether or not data has been set in the merging setting information (config).

If the merging section 107 determines at the step S203 that data has been set in the merging setting information (config), the flow of the merging-related processing goes on to the step S205 at which the merging section 107 determines whether or not a distance-order merging flag (sortPair) of the merging setting information (config) is true, that is, whether or not the distance-order merging is enabled.

If the merging section 107 determines at the step S205 that the distance-order merging flag (sortPair) of the merging setting information (config) is false, that is, the distance-order merging is not enabled, the flow of the merging-related processing goes on to a step S207 at which the merging section 107 carries out the search-order merging processing. It is to be noted that details of the search-order merging processing will be described later.

If the merging section 107 determines at the step S205 that the distance-order merging flag (sortPair) of the merging setting information (config) is true, that is, if the distance-order merging is enabled, on the other hand, the flow of the merging-related processing goes on to a step S209 at which the merging section 107 carries out the distance-order merging processing. It is to be noted that details of the distance-order merging processing will be described later.

If the merging section 107 determines at the step S203 that the merging setting information (config) is null, that is, data has not been set in the merging setting information (config), on the other hand, the merging section 107 carries out neither the search-order merging processing nor the distance-order merging processing and terminates the merging-related processing.

### Details of the Merging Setting Information Select Processing

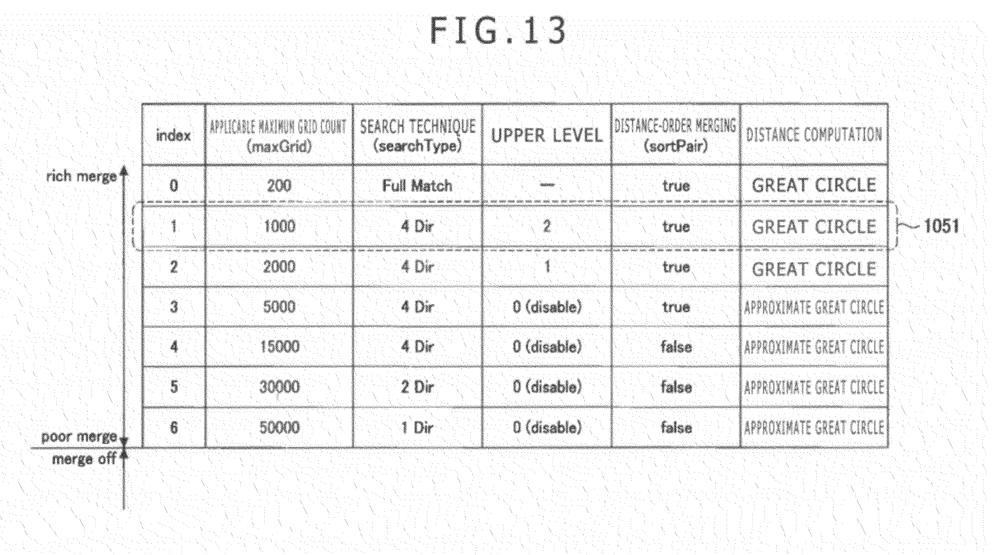

FIG. 13 is a table of typical merging setting information according to the first embodiment of the present disclosure. Each entry of the table shown in FIG. 13 shows an applicable maximum grid count (maxGrid), a search technique (searchType), an upper-level search (upperLevel), a distance-order merging flag (sortPair) and distance calculation as elements of the merging setting information for each level of merging.

These pieces of merging setting information may be stored in the storage section 119 of the information processing apparatus 100 typically as a table like the one shown in FIG. 13. As an alternative, every piece of merging setting information may be stored in the form of a merging setting record 1051 which is identified by making use of an index. The elements of the merging setting information are explained as follows.

The applicable maximum grid count (maxGrid) is the maximum number of grids 1031 for which the merging setting information can be set. The merging setting information (config) is selected from pieces of merging setting information (config) as merging setting information (config) with an applicable maximum grid count (maxGrid) equal to or greater than the number of grids 1031. It is to be noted that, in this case, the number of grids 1031 is the number of grids 1031 each associated with one of clusters 1021 obtained as a result of the clustering processing. Thus, even if the grid level is high or the gridsize is small, merging setting information (config) with a relatively small applicable maximum grid count may be selected provided that the number of clusters 1021 is small or the clusters 1021 are distributed in a specific-gridsided distribution.

The search technique (searchType) specifies a search technique to be adopted in the merging processing. A “Full Match” search technique is a search technique in accordance with which all combinations of grids 1031 each associated with one of the clusters 1021 obtained as a result of the clustering processing are used as subjects of the merging processing. In the following description, the merging processing carried out by adoption of the “Full Match” search technique is referred to as full-match merging processing. In addition, “4 Dir,” “2 Dir” and “1 Dir” search techniques are search techniques representing four-direction, two-direction and one-direction search operations respectively. Each of the “4 Dir,” “2 Dir” and “1 Dir” search techniques is a search technique in accordance with which grids 1031 adjacent to each other in a specific direction are taken as the subject of the merging processing. In the following description, the merging processing carried out by adoption of any of the “4 Dir,” “2 Dir” and “1 Dir” search techniques is referred to as neighborhood-search merging processing. It is to be noted that details of the full-match merging processing and the neighborhood-search merging processing will be described later.

The upper-level search (upperLevel) indicates whether or not a upper-level search is to be carried out and, if the upper-level search indicates that a upper-level search is to be carried out, the upper-level search indicates the number of search upper levels through which the upper-level search is to be carried out. An upper-level search (upperLevel) of 2 indicates that the upper-level search is to be carried out through two search upper levels whereas an upper-level search (upperLevel) of 1 indicates that the upper-level search is to be carried out through one search upper level. An upper-level search (upperLevel) of 0 (disable) indicates that the upper-level search is not to be carried out.

In the full-match merging processing, since all combinations of grids 1031 each associated with one the clusters 1021 obtained as a result of the clustering processing are used as subjects of the merging processing, the upper-level search is not required. Thus, the upper-level search (upperLevel) is not defined. It is to be noted that details of the upper-level search will be described later.

The distance-order merging flag (sortPair) indicates whether or not the distance-order merging is to be carried out. The distance-order merging performed on each pair of grids 1031 each including the associated cluster 1021 is merging processing adopting a technique in accordance with which the merging processing is carried out in an order starting with a pair of grids 1031 having a shortest distance among all the pairs. If the distance-order merging is carried out, clusters 1021 separated away from each other by short distances can be merged with absolute certainty. Since each pair of grids 1031 each including the associated cluster 1021 needs to be held in advance temporarily, however, the storage capacitance of a memory has to be increased by a quantity corresponding to such pairs. The distance-order merging flag (sortPair) having the ‘true’ value indicates that the distance-order merging is to be carried out whereas the distance-order merging flag (sortPair) having the ‘false’ value indicates that the distance-order merging is not to be carried out and the search-order merging to be described later is to be carried out in place of the distance-order merging. It is to be noted that details of the distance-order merging will be described later.

The distance computation specifies a distance computation technique to be adopted in an operation to compute the distance between two clusters 1021. If the distance computation specifies a great circle, the distance d between first and second clusters 1021 is computed in accordance with Eq. (1) given below. In the equation, notation lon1 denotes the longitude coordinate of the center of the first cluster 1021 whereas notation lat1 denotes the latitude coordinate of the center of the first cluster 1021. By the same token, notation lon2 denotes the longitude coordinate of the center of the second cluster 1021 whereas notation lat2 denotes the latitude coordinate of the center of the second cluster 1021.

d=sin(lat1)sin(lat2)+cos(lat1)cos(lat2)cos(lon2−lon1) (1)

In addition, if the distance computation specifies an approximate great circle, on the other hand, the distance d between the first and second clusters 1021 is computed in accordance with Eq. (2) given as follows.

$$Δ lat = lat 2 - lat 1 \\ Δ lon = ( lon 2 - lon 1 ) cos ( \frac{lat 2 + lat 1}{2} ) \\ d = \sqrt{Δ {lat}^{2} + Δ {lon}^{2}} \qquad ( 2 )$$

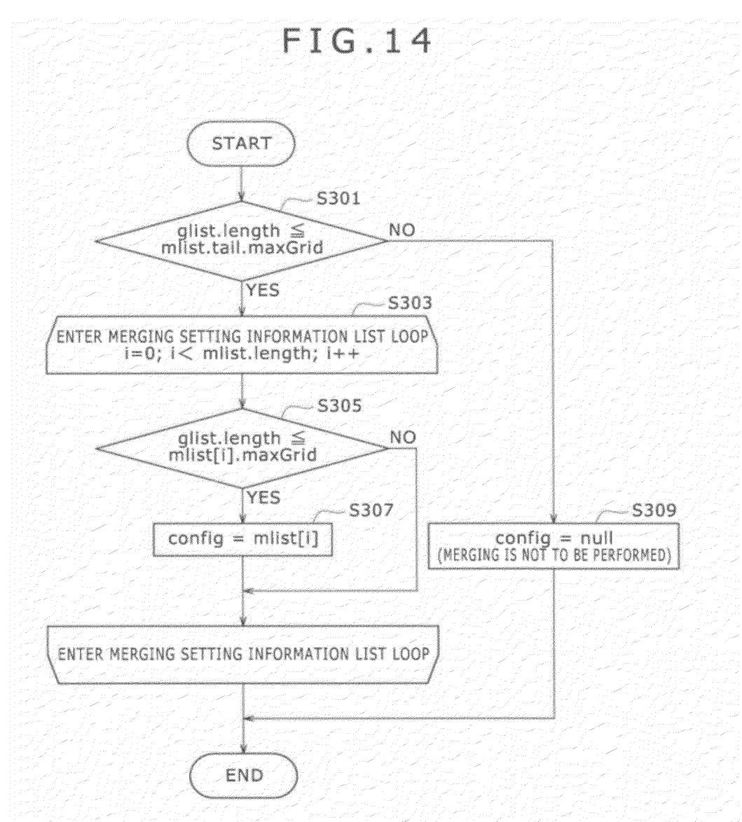

Such merging setting information (config) may be typically set in advance and stored in the storage section 119. The smaller the applicable maximum grid count (maxGrid) set in the merging setting information (config), the more advanced the merging processing which can be carried out. On the other hand, the larger the applicable maximum grid count (maxGrid) set in the merging setting information (config), the simpler the merging processing which can be carried out. The merging setting information for grids 1031 the number of which is greater than 50,000 is not defined. That is to say, if the number of grids 1031 exceeds 50,000, the merging processing is not carried out due to an excessively large processing load imposed by the merging processing. This is because, the larger the number of grids 1031, the larger the load imposed by the merging processing. It is thus necessary to adjust the maximum load imposed by the merging processing by properly selecting merging setting information (config) of the merging processing in accordance with the number of grids 1031 serving as the subject of merging processing as explained below by referring to FIG. 14.

FIG. 14 shows a flowchart representing merging setting information select processing carried out in accordance with the first embodiment of the present disclosure. The merging setting information select processing is carried out in order to select merging setting information (config) to be used in the merging processing from the pieces of merging setting information explained earlier by referring to FIG. 13. It is to be noted that, as described above, there is also a case in which the merging setting information (config) is not set and, hence, the merging processing is not carried out.

As shown in the figure, the flowchart begins with a step S301 at which the merging section 107 determines whether or not the length of a grid list (glist) is equal to or smaller than the applicable maximum grid count (maxGrid) of the tail element of a merging setting information list mlist. The grid list (glist) is a list of grids 1031 each including one of the clusters 1021 to be merged. Thus, the length of the grid list (glist) is the number of grids 1031 on the list. On the other hand, the merging setting information list mlist is a list of pieces of merging setting information (config) shown in FIG. 13.

If the merging section 107 determines at the step S301 that the number of grids 1031 is equal to or smaller than the applicable maximum grid count (maxGrid) of the tail element of the merging setting information list mlist, the flow of the merging setting information select processing goes on to a step S303 at which the merging section 107 carries out iteration of a merging setting information list loop including the following steps S305 and S307 sequentially for elements of the merging setting information list mlist. To put it concretely, at the step S303, the merging section 107 increments an index i of the merging setting information list mlist if the index i is smaller than the length of the merging setting information list mlist. Then, the flow of the merging setting information select processing goes on to the step S305.

At the step S305, the merging section 107 determines whether or not the length of the grid list (glist) is equal to or smaller than the applicable maximum grid count (maxGrid) of an element pointed to by the index i, which has been incremented at the step S303, as an element of the merging setting information list mlist.

If the merging section 107 determines at the step S305 that the number of grids 1031 is equal to or smaller than the applicable maximum grid count (maxGrid) of the element pointed to by the index i as an element of the merging setting information list mlist, the flow of the merging setting information select processing goes on to the step S307 at which the merging section 107 sets the element pointed to by the index i in the merging setting information (config). If the merging setting information (config) already exists, the element pointed to by the index i is written over the existing merging setting information (config).

If the merging section 107 determines at the step S305 that the number of grids 1031 is greater than the applicable maximum grid count (maxGrid) of the element pointed to by the index i as an element of the merging setting information list mlist, on the other hand, the flow of the merging setting information select processing goes back to the step S303 in order to repeat the merging setting information list loop starting with the step S303 without carrying out the step S307 to set the setting of the merging setting information (config). As a matter of fact, the steps S303 and S305 are carried out repeatedly till the merging section 107 finds out at the step S305 that the number of grids 1031 is equal to or smaller than the applicable maximum grid count (maxGrid) of the element pointed to by the index i as an element of the merging setting information list mlist. In this case, the flow of the merging setting information select processing goes on to a step S307 as described above before repeating the merging setting information list loop.

After the iteration of the merging setting information list loop starting with the step S303 has been completed, the merging section 107 terminates the merging setting information select processing.

If the merging section 107 determines at the step S301 that the number of grids 1031 is greater than the applicable maximum grid count (maxGrid) of the tail element of the merging setting information list mlist, on the other hand, the flow of the merging setting information select processing goes on to a step S309 at which the merging section 107 sets a null value in the merging setting information (config) to indicate that no data has been set in the merging setting information (config). With the merging setting information (config) set at a null value, the merging section 107 does not carry out the merging processing.

### Details of the Search-Order Merging Processing

The search-order merging processing includes a process of searching for clusters 1021 separated from each other by a distance equal to or smaller than a threshold value determined in advance and a process of sequentially merging the clusters 1021 in the order of the search for the clusters 1021. It is to be noted that, in the full-match merging processing to be described later, distances between clusters 1021 obtained as a result of the clustering processing are computed for all combinations of grids 1031 each associated with one of the clusters 1021. In addition, in neighborhood-search merging processing also to be described later, grids 1031 each associated with a cluster 1021 are sorted in a specific direction and distances between clusters 1021 each included in one of the grids 1031 adjacent in the specific direction are computed.

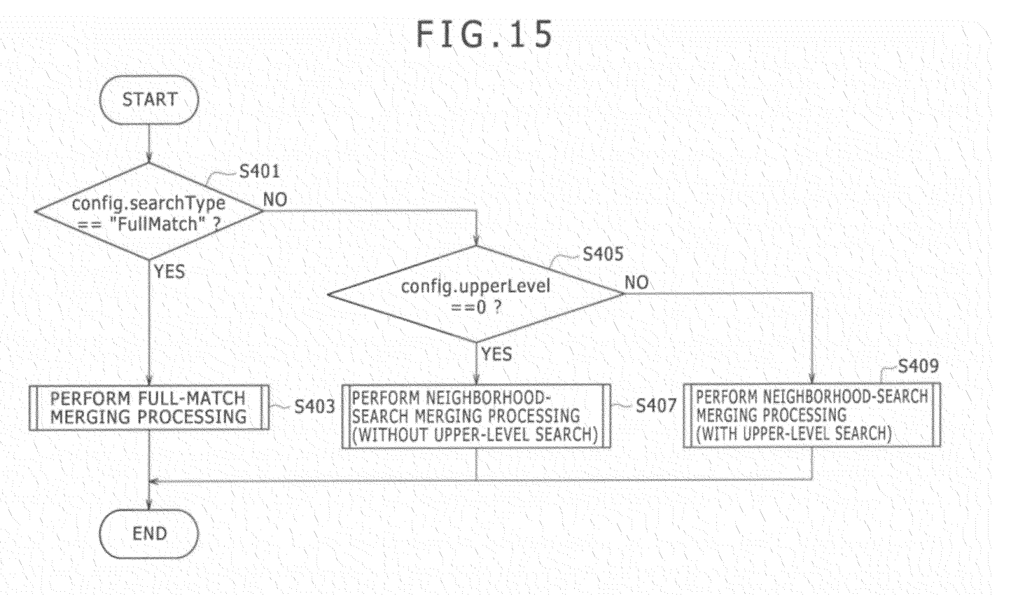

FIG. 15 shows a flowchart representing search-order merging processing carried out in accordance with the first embodiment of the present disclosure. In the search-order merging processing, in accordance with the contents of the merging setting information (config), either full-match merging processing or neighborhood-search merging processing is carried out. If the neighborhood-search merging processing is selected, the neighborhood-search merging processing is carried out with or without an upper-level search, in accordance with the contents of the merging setting information (config).

As shown in the figure, the flowchart begins with a step S401 at which the merging section 107 determines whether or not the search technique (searchType) of the merging setting information (config) is Full Match.

If the merging section 107 determines at the step S401 that the search technique (searchType) of the merging setting information (config) is Full Match, the flow of the search-order merging processing goes on to a step S403 at which the merging section 107 carries out full-match merging processing. It is to be noted that the full-match merging processing will be described later in more detail.

If the merging section 107 determines at the step S401 that the search technique (searchType) of the merging setting information (config) is not Full Match, on the other hand, the flow of the search-order merging processing goes on to a step S405 at which the merging section 107 determines whether or not the upper-level search (upperLevel) of the merging setting information (config) is 0.

If the merging section 107 determines at the step S405 that the upper-level search (upperLevel) of the merging setting information (config) is 0, the flow of the search-order merging processing goes on to a step S407 at which the merging section 107 carries out the neighborhood-search merging processing without an upper-level search. It is to be noted that the neighborhood-search merging processing carried out without an upper-level search will be described later in detail.

If the merging section 107 determines at the step S405 that the upper-level search (upperLevel) of the merging setting information (config) is not 0, on the other hand, the flow of the search-order merging processing goes on to a step S409 at which the merging section 107 carries out the neighborhood-search merging processing with an upper-level search. It is to be noted that the neighborhood-search merging processing carried out with an upper-level search will be described later in detail.

As described above, the merging section 107 carries out either the full-match merging processing, the neighborhood-search merging processing without an upper-level search or the neighborhood-search merging processing with an upper-level search. Then, the merging section 107 terminates the search-order merging processing.

### Details of the Full-Match Merging Processing

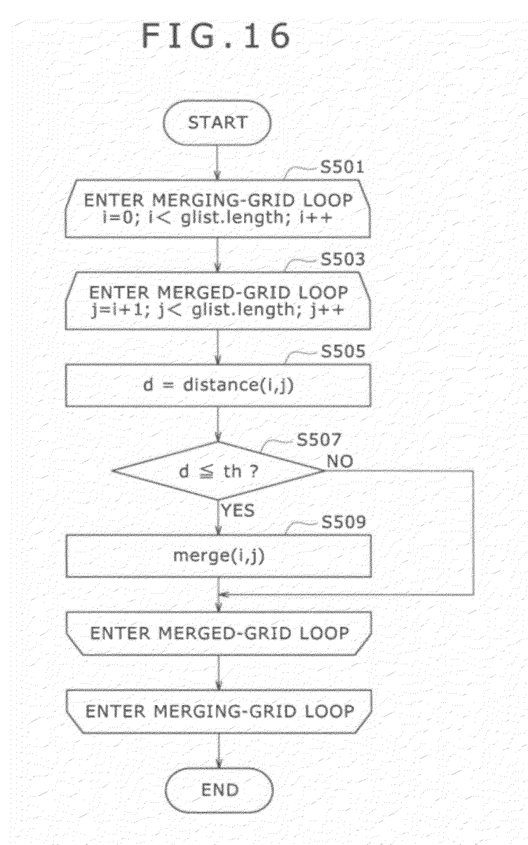

FIG. 16 shows a flowchart representing the full-match merging processing carried out in accordance with the first embodiment of the present disclosure. In the full-match merging processing, all combinations of grids 1031 each including a cluster 1021 are the subject of search processing.

As shown in the figure, the flowchart begins with a step S501 at which the merging section 107 carries out iteration of a merging-grid loop including the following step S503 sequentially for elements of a grid list (glist) which is a list of grids 1031 each including a cluster 1021. It is to be noted that an element included in the grid list (glist) as an element subjected to the processing in the merging-grid loop starting with the step S501 is an element included in the grid list (glist) as an element indicated by an index i.

Then, at the step S503, the merging section 107 carries out iteration of a merged-grid loop including the following steps S505 to S509 sequentially for elements of the grid list (glist), starting with an element immediately following the element indicated by the index to serve as the current subject of the processing. It is to be noted that an element included in the grid list (glist) as an element subjected to the processing in the merged-grid loop starting with the step S503 is an element included in the grid list (glist) as an element indicated by an index j.

At the step S505, the merging section 107 computes the distance d between the merging grid 1031 which is an element indicated by the index i as an element of the grid list (glist) and the merged grid 1031 which is an element indicated by the index j as an element of the grid list (glist). The computed distance d between the element indicated by the index i and the element indicated by the index j is typically the distance between the center of the cluster 1021 included in the grid 1031 which is the element indicated by the index i and the center of the cluster 1021 included in the grid 1031 which is the element indicated by the index j.

At the step S507, the merging section 107 compares the distance d computed at the step S505 with a threshold value th determined in advance in order to determine whether of not the distance d is equal to or shorter than the threshold value th. The threshold value th determined in advance can be typically the merging threshold value explained earlier by referring to Table 1.

If the merging section 107 determines at the step S507 that the distance d is equal to or shorter than the threshold value th, the flow of the full-match merging processing goes on to the step S509 at which the merging section 107 merges the element indicated by the index i as an element of the grid list (glist) with the element indicated by the index j as an element of the grid list (glist). In this case, the merging section 107 merges the cluster 1021 included in the grid 1031 which is the element indicated by the index i as an element of the grid list (glist) with the cluster 1021 included in the grid 1031 which is the element indicated by the index j as an element of the grid list (glist) in order to create a new cluster 1021. The new cluster 1021 is associated with a grid 1031 including the clusters 1021 included in respectively the merging and merged grids 1031 which exist prior to the merging processing. That is to say, as a result of the merging processing, the merging section 107 forms the new cluster 1021 by merging the cluster 1021 included in the grid 1031 which is the element indicated by the index i with the cluster 1021 included in the grid 1031 which is the element indicated by the index j.

If the merging section 107 determines at the step S507 that the distance d is longer than the threshold value th, on the other hand, the merging section 107 repeats the merged-grid loop starting with the step S503 without carrying out the step S509 to merge the element indicated by the index i as an element of the grid list (glist) with the element indicated by the index j as an element of the grid list (glist). Instead, the merging section 107 increments the index j by 1 in order to process the next element included in the grid list (glist) at the step S503. As a matter of fact, the merged-grid loop is carried out repeatedly till the last element of the grid list (glist) is processed.

After the last element of the grid list (glist) has been processed in the merged-grid loop starting with the step S503, the merging section 107 repeats the merging-grid loop starting with the step S501 by incrementing the index i by 1 in order to process the next element included in the grid list (glist) at the step S501.

After the last element of the grid list (glist) has been processed in the merging-grid loop starting with the step S501, the merging section 107 terminates the full-match merging processing.

The processing carried out at the step S509 is typical concrete processing for a case in which the merging section 107 is implemented by software. In this case, the merging section 107 refers to the single grid list (glist), which has been stored in advance in the storage section 119, by making use of both the indexes i and j and updates the contents of the grid list (glist) from time to time. It is to be noted that, if the merging section 107 is implemented by some means other than software and if the merging section 107 is implemented by software having specifications different from the typical example explained above, the way to refer to a grid 1031 used as the subject the processing, the timing to reflect the merging of clusters 1021 in data and other things can be properly designed provided that the essential processing substances conform to the flowchart explained above.

### Details of the Neighborhood-Search Merging Processing

Next, the following description explains details of the neighborhood-search merging processing carried out in accordance with the embodiment. In the neighborhood-search merging processing, the merging-oriented cluster-sorting block 109 sorts clusters 1021 in a certain direction on the earth surface 1001 on the basis of the result of the first ranking determination processing based on latitudes and longitudes. Then, the adjacency determination block 111 determines whether or not any two of the clusters 1021 obtained as a result of the sorting processing carried out in the certain direction are adjacent to each other in the direction. Subsequently, the merging section 107 computes the distance between any two clusters 1021 which have been determined to be adjacent to each other in the direction. The merging section 107, the merging-oriented cluster-sorting block 109 and the adjacency determination block 111 may also merge clusters 1021 in another direction on the earth surface 1001 with each other by carrying out the same processing.

In this embodiment, typical directions on the earth surface 1001 include the longitudinal direction, the lateral direction, an oblique right downward direction and an oblique right upward direction. The merging section 107 employing the merging-oriented cluster-sorting block 109 may carry out the neighborhood-search merging processing to be described below in any one of these typical directions. In this case, the neighborhood search is referred to as a one-direction search. In addition, the merging section 107 employing the merging-oriented cluster-sorting block 109 may also carry out the neighborhood-search merging processing to be described below in any two of these typical directions. In this case, the neighborhood search is referred to as a two-direction search. On top of that, the merging section 107 employing the merging-oriented cluster-sorting block 109 may also carry out the neighborhood-search merging processing to be described below in these four typical directions. In this case, the neighborhood search is referred to as a four-direction search.

In addition, in this embodiment, as the first ranking determination processing, the merging-oriented cluster-sorting block 109 may sort grids 1031 each including a cluster 1021 in a certain direction on the earth surface 1001 and provide the clusters 1021 each included in one of the grids 1031 with a sorting order, which has been obtained as the result of the processing, as a ranking of the clusters 1021. As explained earlier by referring to FIG. 1, in this embodiment, grids 1031 and clusters 1021 each included in one of the grids 1031 are associated with each other on a one-with-one basis. Thus, a ranking provided to grids 1031 as a result of sorting of the grids 1031 can be used as the ranking of clusters 1021 each included in one of the grids 1031 as it is. Since each grid 1031 is an area defined in known boundaries, grids 1031 can be sorted with ease in any specific direction on the earth surface 1001. Therefore, by taking advantage of the configuration of an embodiment for providing a ranking to clusters 1021 on the basis of the result of sorting carried out on grids 1031 each including one of the clusters 1021, the clusters 1021 can be sorted at a high speed.

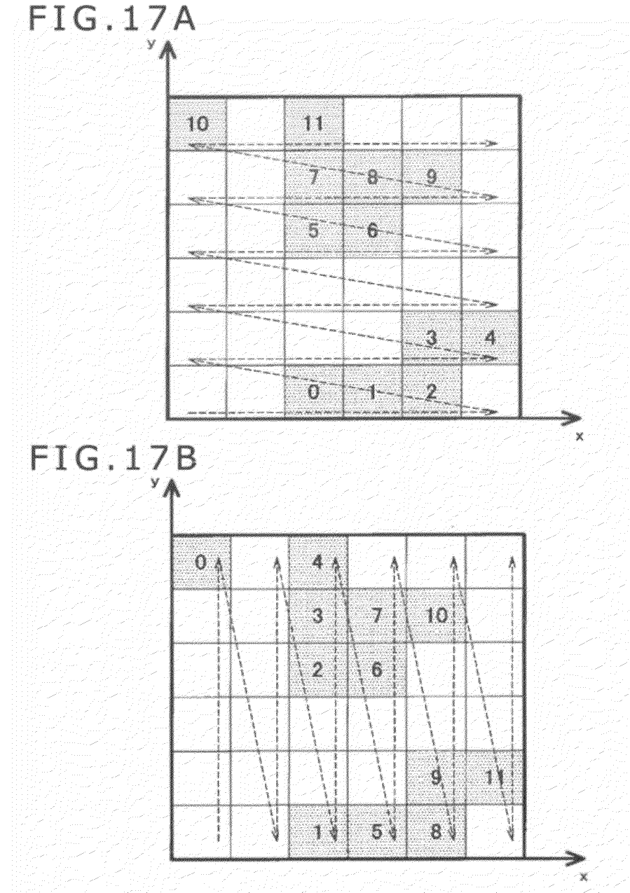

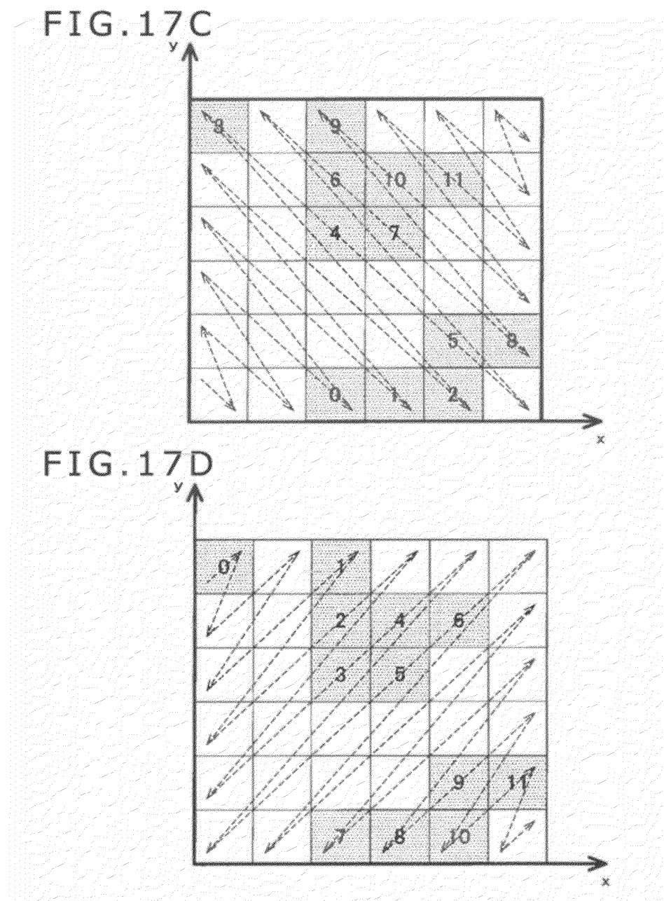

FIGS. 17A to 17D are each a diagram showing a direction of search for grids 1031 in neighborhood-search merging processing carried out in accordance with the first embodiment of the present disclosure. In the neighborhood-search merging processing, grids 1031 on a grid list (glist) are sorted in a specific direction and the sorted grids 1031 adjacent to each other are taken as the object of the merging processing. As described before, the grid list (glist) is a list of grids 1031 each including a cluster 1021. In each of FIGS. 17A to 17D, indexes each assigned to one of grids 1031 on the grid list (glist) are shown after defining the sorting order for the sorting of the grids 1031 by taking a specific direction for the figure as a reference direction. It is to be noted that the array of the grids 1031 themselves is the same for all FIGS. 17A to 17D.

To be more specific, FIG. 17A is a diagram showing a case in which the search of the grid list (glist) is carried out in the horizontal direction in accordance with the first embodiment of the present disclosure. The horizontal direction on the earth surface 1001 is also referred to as an east-west direction. It is to be noted that, in the following figures, the longitude and latitude directions are shown as the directions of the x axis and the y axis respectively. In this case, the horizontal direction is the direction of the x axis.

In this case, the grids 1031 on the grid list (glist) are sorted in the horizontal direction. The direction of assignment of increasing indexes 0 to 10 to the grids 1031 on the grid list (glist) in the course of the sorting is determined by for example defining the preceding/succeeding relation of two grids 1031 at coordinates (x1, y1) and (x2, y2) as follows.

If y1≠y2, make a determination based on the relation between the magnitudes of coordinates y1 and y2. That is to say, a grid 1031 with the smaller y coordinate is regarded as a grid 1031 preceding a grid 1031 with the larger y coordinate.

Otherwise, make a determination based on the relation between the magnitudes of coordinates x1 and x2. That is to say, a grid 1031 with the smaller x coordinate is regarded as a grid 1031 preceding a grid 1031 with the larger x coordinate.

FIG. 17B is a diagram showing a case in which the search of the grid list (glist) is carried out in the vertical direction in accordance with the first embodiment of the present disclosure. The vertical direction on the earth surface 1001 is also referred to as a south-north direction. In this case, the grids 1031 on the grid list (glist) are sorted in the vertical direction. The direction of assignment of increasing indexes 0 to 10 to the grids 1031 on the grid list (glist) in the course of the sorting is determined by for example defining the preceding/succeeding relation of two grids 1031 at coordinates (x1, y1) and (x2, y2) as follows.

If x1≠x2, make a determination based on the relation between the magnitudes of coordinates x1 and x2. That is to say, a grid 1031 with the smaller x coordinate is regarded as a grid 1031 preceding a grid 1031 with the larger x coordinate.

Otherwise, make a determination based on the relation between the magnitudes of coordinates y1 and y2. That is to say, a grid 1031 with the smaller y coordinate is regarded as a grid 1031 preceding a grid 1031 with the larger y coordinate.

FIG. 17C is a diagram showing a case in which the search of the grid list (glist) is carried out in the oblique right downward direction in accordance with the first embodiment of the present disclosure. The oblique right downward direction on the earth surface 1001 is also referred to as a northwest-southeast direction. In this case, the grids 1031 on the grid list (glist) are sorted in the oblique right downward direction. The direction of assignment of increasing indexes 0 to 10 to the grids 1031 on the grid list (glist) in the course of the sorting is determined by for example defining the preceding/succeeding relation of two grids 1031 at coordinates (x1, y1) and (x2, y2) as follows.

sum1=x1+y1

sum2=x2+y2

If sum1≠sum2, make a determination based on the relation between the magnitudes of coordinate sums sum1 and sum2. That is to say, a grid 1031 with the smaller coordinate sum is regarded as a grid 1031 preceding a grid 1031 with the larger coordinate sum.

Otherwise, make a determination based on the relation between the magnitudes of coordinates y1 and y2. That is to say, a grid 1031 with the smaller y coordinate is regarded as a grid 1031 preceding a grid 1031 with the larger y coordinate.

FIG. 17D is a diagram showing a case in which the search of the grid list (glist) is carried out in the oblique right upward direction in accordance with the first embodiment of the present disclosure. The oblique right upward direction on the earth surface 1001 is also referred to as a southwest-northeast direction. In this case, the grids 1031 on the grid list (glist) are sorted in the oblique right upward direction. The direction of assignment of increasing indexes 0 to 10 to the grids 1031 on the grid list (glist) in the course of the sorting is determined by for example defining the preceding/succeeding relation of two grids 1031 at coordinates (x1, y1) and (x2, y2) as follows.

sum1=x1+y1′

sum2=x2+y2′

where distances from the largest y coordinate to coordinates y1 and y2 are represented as y1′ and Y2′ respectively.

If sum1≠sum2, make a determination based on the relation between the magnitudes of coordinate sums sum1 and sum2. That is to say, a grid 1031 with the smaller coordinate sum is regarded as a grid 1031 preceding a grid 1031 with the larger coordinate sum.

Otherwise, make a determination based on the relation between the magnitudes of coordinates y1 and y2. That is to say, a grid 1031 with the smaller y coordinate is regarded as a grid 1031 preceding a grid 1031 with the larger y coordinate.

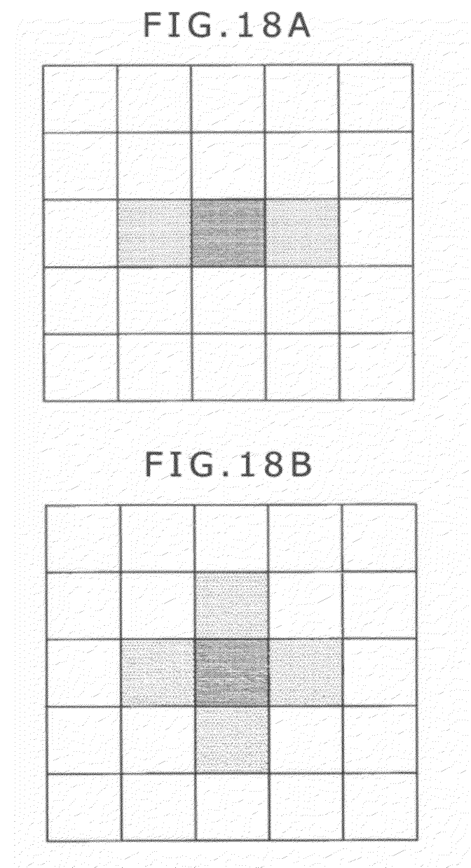

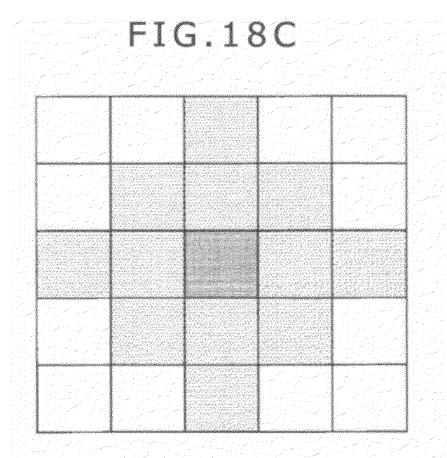

FIGS. 18A to 18C are explanatory diagrams referred to in the following description of a one-direction search, a two-direction search and four-direction search respectively in the neighborhood-search merging processing carried out in accordance with the first embodiment of the present disclosure. In the neighborhood-search merging processing carried out in accordance with the embodiment, three different search techniques are established. The three different search techniques are respectively a one-direction search technique, a two-direction search technique and four-direction search technique which are each established by selecting or combining the gridsearch directions explained above by referring to FIGS. 17A to 17D.

To be more specific, FIG. 18A is a diagram showing a case in which a one-direction search is carried out in accordance with the first embodiment of the present disclosure. In the one-direction search, only one direction of the grids 1031 is selected. In the typical example shown in the figure, the horizontal direction is selected as the direction of the grids 1031. In this case, two grids 1031 adjacent to a certain grid 1031 in the horizontal direction are taken as a subject of the merging processing. Since there is only one direction of the search, the sorting of grids 1031 on the grid list (glist) in the merging processing needs to be carried out only once. It is to be noted that the selected direction of the grids 1031 is by no means limited to the horizontal direction. That is to say, the selected direction of the grids 1031 can also be the vertical direction, an oblique right downward direction or an oblique right upward direction. In the case of such a one-direction search, as described above, the number of times the sorting of grids 1031 on the grid list (glist) is carried out in the merging processing is 1 whereas the maximum number of times the distance computation is carried out in the merging processing is about N which is a cluster count representing the number of clusters 1021.

FIG. 18B is a diagram showing a case in which a two-direction search is carried out in accordance with the first embodiment of the present disclosure. In the two-direction search, two directions of the grids 1031 are combined. In the typical example shown in the figure, the horizontal and vertical directions are combined. In this case, two grids 1031 adjacent to a specific grid 1031 in the horizontal direction and two grids 1031 adjacent to the specific grid 1031 in the vertical direction are taken as a subject of the merging processing. Thus, a total of four grids 1031 adjacent to the specific grid 1031 are taken as a subject of the merging processing. Since there are two directions of the search, the sorting of grids 1031 on the grid list (glist) in the merging processing needs to be carried out twice. It is to be noted that the combined directions of the grids 1031 are by no means limited to the horizontal and vertical directions. That is to say, the combined directions of the grids 1031 can also be any two of the horizontal direction, the vertical direction, an oblique right downward direction or an oblique right upward direction. In the case of such a two-direction search, as described above, the number of times the sorting of grids 1031 on the grid list (glist) is carried out in the merging processing is 2 whereas the maximum number of times the distance computation is carried out in the merging processing is about 2N where notation N is a cluster count representing the number of clusters 1021.

FIG. 180 is a diagram showing a case in which a four-direction search is carried out in accordance with the first embodiment of the present disclosure. In the four-direction search, four directions of the grids 1031 are combined. In the typical example shown in the figure, the horizontal direction, the vertical direction, the oblique right downward direction and the oblique right upward direction are combined. That is to say, a total of four directions are combined. In this case, four grids 1031 adjacent to a specific grid 1031 in the horizontal direction, four grids 1031 adjacent to the specific grid 1031 in the vertical direction, two grids 1031 adjacent to the specific grid 1031 in the oblique right downward direction and two grids 1031 adjacent to the specific grid 1031 in the oblique right upward direction are taken as a subject of the merging processing. Thus, a total of 1 two grids 1031 adjacent to the specific grid 1031 are taken as a subject of the merging processing. This is because the distance between two grids 1031 adjacent to each other in the oblique right downward direction is longer than the distance between two grids 1031 adjacent to each other in the horizontal or vertical direction. By the same token, the distance between two grids 1031 adjacent to each other in the oblique right upward direction is longer than the distance between two grids 1031 adjacent to each other in the horizontal or vertical direction. Since there are four directions of the search, the sorting of grids 1031 on the grid list (glist) in the merging processing needs to be carried out 4 times. In the case of such a four-direction search, as described above, the number of times the sorting of grids 1031 on the grid list (glist) is carried out in the merging processing is 4 whereas the maximum number of times the distance computation is carried out in the merging processing is about 4N where notation N is a cluster count representing the number of clusters 1021.

It is to be noted that the maximum number of times the distance computation is carried out in the one-direction search, the two-direction search and the four-direction search is O (N). In addition, the number of times the sorting processing is carried out at a high speed is O (N log N). Thus, for a large cluster count N, the amount of the sorting processing is conceivably predominant in comparison with the distance computation.

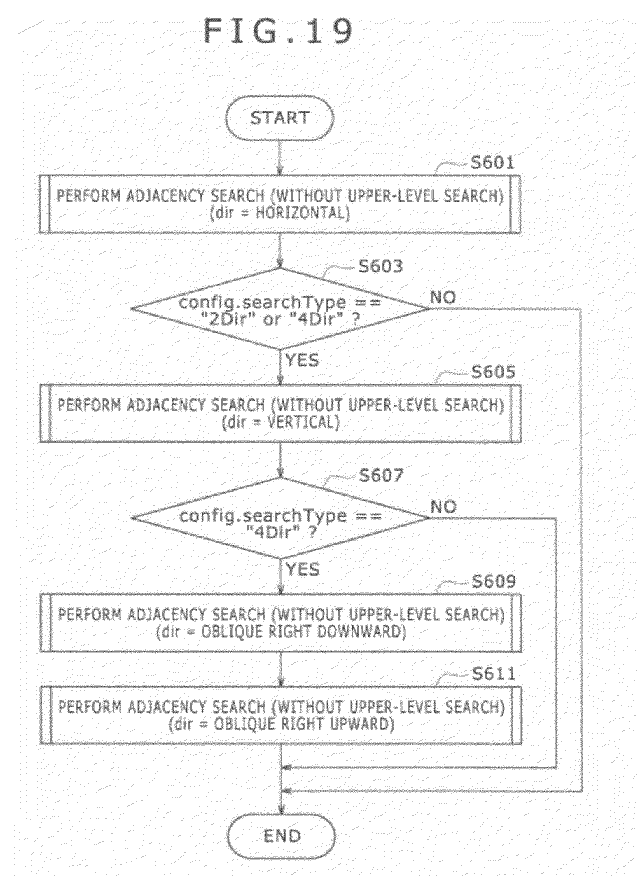

FIG. 19 shows a flowchart representing the neighborhood-search merging processing (without an upper-level search) carried out in accordance with the first embodiment of the present disclosure. It is to be noted that the neighborhood-search merging processing (with an upper-level search) and details of the upper-level search will be explained later.

As shown in the figure, the flowchart begins with a step S601 at which the merging section 107 carries out the adjacency-search processing without an upper-level search by taking the horizontal direction as its direction (dir). The adjacency-search processing (without an upper-level search) will be described later.

Then, at the next step S603, the merging section 107 determines whether or not the search technique (searchType) of the merging setting information (config) is “2 Dir” or “4 Dir.” If the merging section 107 determines at the step S603 that the search technique (searchType) of the merging setting information (config) is neither “2 Dir” nor “4 Dir,” the merging section 107 determines that a one-direction search has been specified. In this case, the merging section 107 terminates the neighborhood-search merging processing.

If the merging section 107 determines at the step S603 that the search technique (searchType) of the merging setting information (config) is either “2 Dir” or “4 Dir,” on the other hand, the flow of the neighborhood-search merging processing goes on to a step S605 at which the merging section 107 carries out the adjacency-search processing without an upper-level search by taking the vertical direction as its direction (dir).

Then, at the next step S607, the merging section 107 determines whether or not the search technique (searchType) of the merging setting information (config) is “4 Dir.” If the merging section 107 determines at the step S607 that the search technique (searchType) of the merging setting information (config) is not “4 Dir,” the merging section 107 determines that a two-direction search has been specified. In this case, the merging section 107 terminates the neighborhood-search merging processing.

If the merging section 107 determines at the step S607 that the search technique (searchType) of the merging setting information (config) is “4 Dir,” on the other hand, the flow of the neighborhood-search merging processing goes on to a step S609 at which the merging section 107 carries out the adjacency-search processing (without an upper-level search) by taking the oblique right downward direction as its direction (dir). Then, at the next step S611, the merging section 107 carries out the adjacency-search processing (without an upper-level search) by taking the oblique right upward direction as its direction (dir). Then, finally, the merging section 107 terminates the neighborhood-search merging processing.

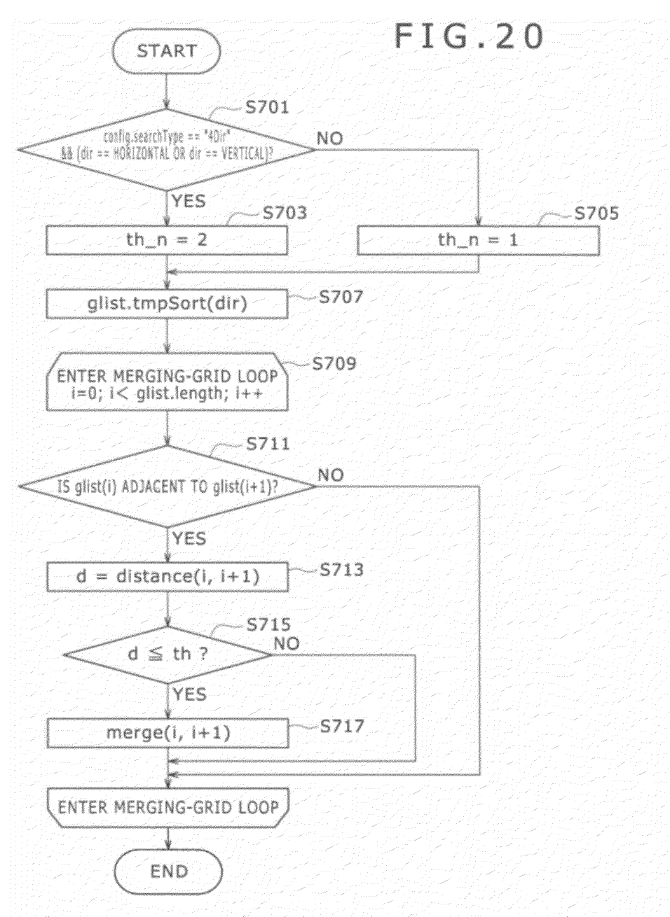

FIG. 20 shows a flowchart representing the adjacency search processing (without an upper-level search) carried out in accordance with the first embodiment of the present disclosure. It is to be noted that the neighborhood-search merging processing (with an upper-level search) and details of the upper-level search will be explained later.

As shown in the figure, the flowchart begins with a step S701 at which the adjacency determination block 111 determines whether or not the search technique (searchType) of the merging setting information (config) is “4 Dir” and the direction (dir) is the horizontal or vertical direction.

If the adjacency determination block 111 determines at the step S701 that the search technique (searchType) of the merging setting information (config) is “4 Dir” and the direction (dir) is the horizontal or vertical direction, the flow of the adjacency search processing goes on to a step S703 at which the adjacency determination block 111 sets an adjacency determination threshold value th_n at 2. In this embodiment, the adjacency determination block 111 can set the adjacency determination threshold value th_n by taking the distance between grids 1031 as the unit of the adjacency determination threshold value th_n. The adjacency determination threshold value th_n is a threshold value used in determining the adjacency between grids 1031 as will be described later and can be set at a value different from the predetermined threshold value th used in merging determination.

If the adjacency determination block 111 determines at the step S701 that the search technique (searchType) of the merging setting information (config) is not “4 Dir” and/or the direction (dir) is neither the horizontal direction nor the vertical direction, that is, if the adjacency determination block 111 determines at the step S701 that the search technique (searchType) of the merging setting information (config) is “1 Dir” or “2 Dir” and/or the direction (dir) is an oblique direction, on the other hand, the flow of the adjacency search processing goes on to a step S705 at which the adjacency determination block 111 sets the adjacency determination threshold value th_n at 1. It is to be noted that, in this embodiment, the adjacency search processing is carried out if the search technique (searchType) of the merging setting information (config) is “1 Dir,” “2 Dir” or “4 Dir.”

The adjacency determination threshold value th_n is set at a value depending on the search technique (searchType) of the merging setting information (config) as described above because of the following reasons. As explained earlier by referring to FIGS. 18A to 18C, in the one-direction search, grids 1031 adjacent to a specific grid 1031 typically in the horizontal or vertical direction are taken as the subject of the merging processing whereas, in the two-direction search, grids 1031 adjacent to a specific grid 1031 typically in the horizontal and vertical directions are taken as the subject of the merging processing. In these cases, the distance between the adjacent grids 1031 in the horizontal and vertical directions is equal to the size of the specific grid 1031. In the four-direction search, on the other hand, four grids 1031 adjacent to a specific grid 1031 in the horizontal direction, four grids 1031 adjacent to the specific grid 1031 in the vertical direction, two grids 1031 adjacent to the specific grid 1031 in the oblique right downward direction and two grids 1031 adjacent to the specific grid 1031 in the oblique right upward direction are taken as the subject of the merging processing. The four grids 1031 adjacent to the specific grid 1031 in the vertical or horizontal direction are two grids 1031 on one side of the specific grid 1031 and two grids 1031 on the other side.

Then, at the next step S707, the merging-oriented cluster-sorting block 109 carries out tmpSort on grids 1031 on the grid list (glist) in the direction (dir). To put it concretely, the merging-oriented cluster-sorting block 109 temporarily sorts the grids 1031 on the grid list (glist) in the direction (dir). The direction (dir) is specified as a parameter typically when the adjacency search processing (without an upper-level search) is carried out at steps S601, S605, S609 and S611 of the flowchart shown in FIG. 19.

The temporary sorting (tmpSort) can be processing to temporarily assign an index to every grid 1031 on the grid list (glist) as explained earlier by referring to FIGS. 17A to 17D. To put it concretely, if the direction (dir) is the horizontal direction for example, an index is assigned temporarily to every grid 1031 on the grid list (glist) as explained earlier by referring to FIG. 17A. By the same token, if the direction (dir) is the vertical direction, an index is assigned temporarily to every grid 1031 on the grid list (glist) as explained earlier by referring to FIG. 17B. In the same way, if the direction (dir) is the oblique right downward direction, an index is assigned temporarily to every grid 1031 on the grid list (glist) as explained earlier by referring to FIG. 17C. Likewise, if the direction (dir) is the oblique right upward direction, an index is assigned temporarily to every grid 1031 on the grid list (glist) as explained earlier by referring to FIG. 17D.

Then, at the next step S709, the flow of the adjacency search processing enters a merging-grid loop which is executed in accordance with the indexes each temporarily assigned to one of the grids 1031 on the grid list (glist). It is to be noted that, later on, the indexes of the grids 1031 on the grid list (glist) are restored to stored original indexes.

To put it in detail, at the step S709, in accordance with the indexes i set at the step S707, the merging section 107 and the adjacency determination block 111 repeat the following steps S711 to S717 included in the merging-grid loop for the grids 1031 each indicated by one of the indexes i as a grid 1031 on the grid list (glist) sequentially one grid after another, starting with the grid 1031 at the beginning of the list. It is to be noted that, in the merging-grid loop starting with the step S709, a grid 1031 included in the grid list (glist) to serve as a subject of the processing is a grid 1031 indicated by the index i. In the following description, a grid 1031 on the grid list (glist) is also referred to as a list element.

At the step S711, the adjacency determination block 111 determines whether or not a specific list element indicated by the index i as a grid 1031 on the grid list (glist) and the list element immediately following the specific list element are adjacent to each other. The list element immediately following the specific list element is a list element indicated by (the index i+1). In this embodiment, two grids 1031 are determined to be adjacent to each other if the distance between the grids 1031 is equal to or shorter than an adjacency determination threshold value th_n. If the direction (dir) is the horizontal direction for example, the vertical-direction position of one of the grids 1031 is the same as the vertical-direction position of the other grid 1031. In the case of the typical example shown in FIG. 17A for example, the y coordinate of one of the grids 1031 is equal to the y coordinate of the other grid 1031. Thus, in the case of the typical example shown in FIG. 17A, the difference between the horizontal-direction position of one of the grids 1031 and the horizontal-direction position of the other grid 1031 is examined in order to merely determine whether or not the difference is equal to or shorter than the adjacency determination threshold value th_n. That is to say, the difference between the x coordinate of one of the grids 1031 and the x coordinate of the other grid 1031 is examined in order to merely determine whether or not the difference is equal to or shorter than the adjacency determination threshold value th_n. Thus, the amount of the processing carried out at the step S711 as processing to determine the adjacency between grids 1031 is small in comparison with the processing including an operation to compute the distance between a grid 1031 located at a position represented by coordinates and another grid 1031 located at another position represented by other coordinates.

If the adjacency determination block 111 determines at the step S711 that the specific list element indicated by the index i as a grid 1031 on the grid list (glist) and the next list element indicated by (the index i+1) as a grid 1031 on the grid list (glist) are adjacent to each other, the flow of the adjacency search processing goes on to the step S713 at which the merging section 107 computes the distance d between the specific list element indicated by the index i as a grid 1031 on the grid list (glist) and the next list element indicated by (the index i+1) as a grid 1031 on the grid list (glist). The computed distance d between the specific list element indicated by the index i as a grid 1031 on the grid list (glist) and the next list element indicated by (the index i+1) as a grid 1031 on the grid list (glist) is typically the distance between the center of the cluster 1021 included in the grid 1031 which is the list element indicated by the index i and the center of the cluster 1021 included in the grid 1031 which is the element indicated by (the index i+1).

Then, at the next step S715, the distance d computed at the step S713 is compared with a threshold value th determined in advance. The threshold value th can be the merging threshold value explained before by referring to Table 1.

If the distance d is determined at the step S715 to be equal to or shorter than the threshold value th, the flow of the adjacency search processing goes on to the step S717 at which the merging section 107 merges the cluster 1021 of the specific list element indicated by the index i as a grid 1031 on the grid list (glist) with the cluster 1021 of the next list element indicated by (the index i+1) as a grid 1031 on the grid list (glist). In this case, the merging section 107 merges the cluster 1021 of the grid 1031 indicated by the index i as a grid 1031 on the grid list (glist) with the cluster 1021 of the grid 1031 indicated by (the index i+1) as a grid 1031 on the grid list (glist) in order to create a new cluster 1021 which is associated with both the grid 1031 indicated by the index i as a grid 1031 on the grid list (glist) and the grid 1031 indicated by (the index i+1) as a grid 1031 on the grid list (glist). That is to say, in this merging processing, the cluster 1021 of the grid 1031 indicated by the index i as a grid 1031 on the grid list (glist) and the cluster 1021 of the grid 1031 indicated by (the index i+1) as a grid 1031 on the grid list (glist) form the new cluster 1021.

If the adjacency determination block 111 determines at the step S711 that the specific list element indicated by the index i as a grid 1031 on the grid list (glist) and the next list element indicated by (the index i+1) as a grid 1031 on the grid list (glist) are not adjacent to each other, on the other hand, the flow of the adjacency search processing goes back to the step S709 in order to repeat the merging-grid loop, skipping the processes carried out at the steps S713 to S717. At the step S709, the merging section 107 increments the index i in order to refer to the next list element of the grid list (glist).

By the same token, if the distance d is determined at the step S715 to be longer than the threshold value th, on the other hand, the flow of the adjacency search processing goes back to the step S709 in order to repeat the merging-grid loop, skipping the process carried out at the step S717.

As described above, the adjacency determination process carried out at the step S711 to determine the adjacency between grids 1031 imposes a relatively small processing load. Thus, as described above, by making use the result of the adjacency determination process of the step S711 to determine whether or not to carry out the process to compute the distance d at the step S713 as a distance computation process imposing a relatively big processing load, the load of the entire processing can be reduced.

In addition, the adjacency determination process described above includes a process of computing the distance between clusters 1021 which are limited to clusters 1021 each included in one of adjacent grids 1031 on the grid list (glist) already subjected to the sorting process. Thus, for a certain direction, the maximum number of times the process of computing the distance between clusters 1021 is carried out is (N−1) where notation N denotes a cluster count representing the number of clusters 1021. However, as described before, the additional sorting processing needs to be carried out O (N log N) times.

### Details of the Upper-Level Search

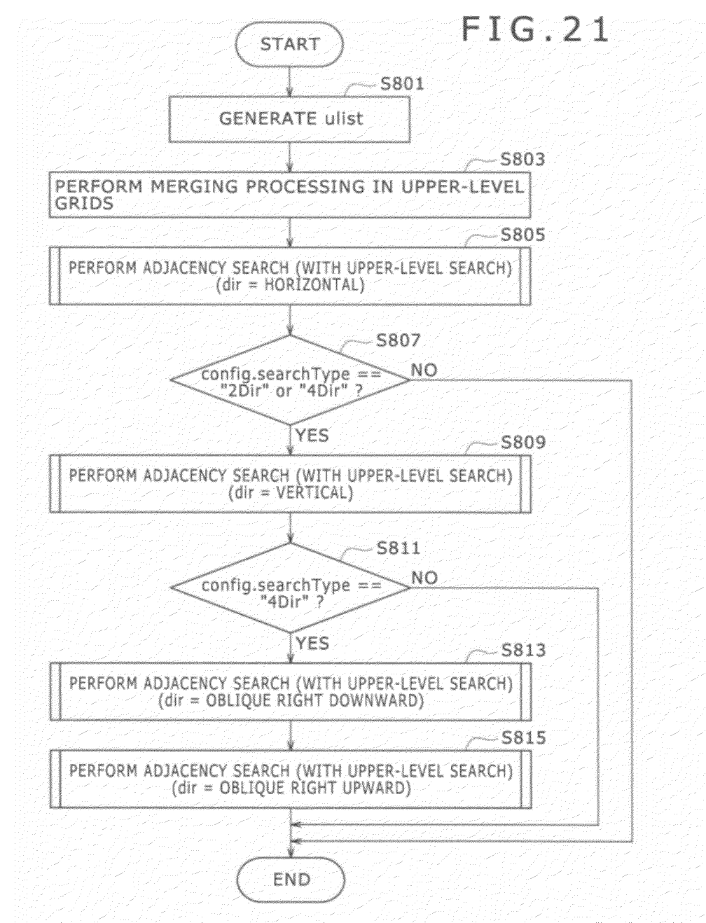

FIG. 21 shows a flowchart representing the neighborhood-search merging processing (with an upper-level search) carried out in accordance with the first embodiment of the present disclosure.

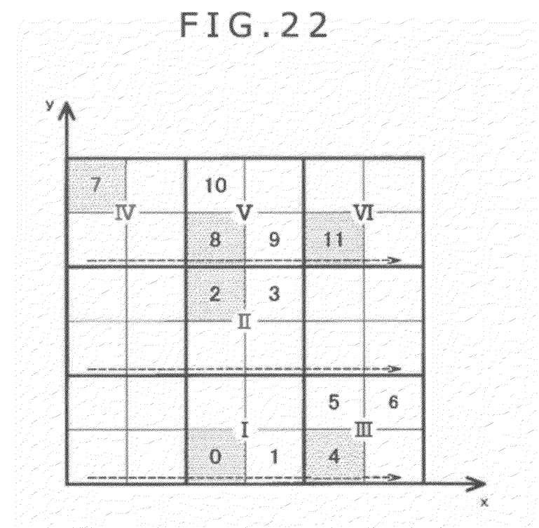

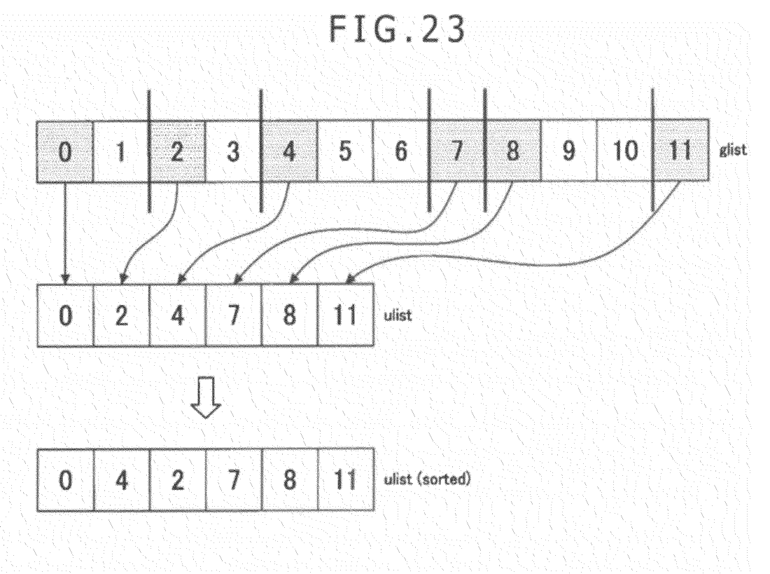

As shown in the figure, the flowchart begins with a step S801 at which the merging section 107 generates an upper-level grid list (ulist). The generated upper-level grid list (ulist) is described below by referring to FIGS. 22 and 23.

FIGS. 22 and 23 are explanatory diagrams referred to in the following description of an upper-level grid list generated in an upper-level search carried out in accordance with the first embodiment of the present disclosure. In the following description, the upper-level grid list is explained by taking a case, in which an upper-level search is carried out in the horizontal direction, as an example. It is to be noted that the upper-level search can also be carried out as well in the vertical direction, the oblique right downward direction and the oblique right upward direction.

In a typical example shown in FIG. 22, 1two grids having the numbers 0 to 11 respectively assigned thereto pertain to six different upper-level grids I to VI. By arranging the grids 0 to 11 in the order of the upper-level grids I to VI located at such positions, a grid list (glist) shown in FIG. 23 is created. An upper-level grid list (ulist) shown in FIG. 23 is formed from the grid list (glist) as shown in FIG. 23. Each grid on the upper-level grid list (ulist) is a grid at the beginning of one of the upper-level grids I to VI. Grids on each of the upper-level grids I to VI have been sorted in the horizontal direction. As will be described later, the grids on the upper-level grid list (ulist) can be sorted in the horizontal direction.

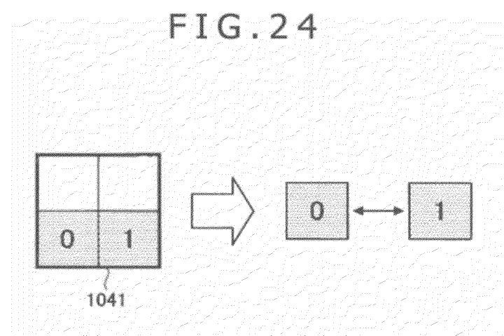

The reader is advised to refer back to FIG. 21. At the next step S803, the merging section 107 carries out merging processing in each of the high-level grids. The merging processing in a high-level grid is explained by referring to FIG. 24.

FIG. 24 shows typical merging processing carried out in a high-level grid which is the high-level grid I of the typical example shown in FIG. 22. As shown in FIG. 24, a gridset selected from round-robin combinations of grids in the high-level grid I serves as the subject of the merging processing. The maximum number of times the computation of a distance is carried out during the merging processing on such a high-level grid is about (N/4)×6=1.5N where notation N denotes the cluster count representing the number of clusters in the high-level grids.

The reader is advised to refer back to FIG. 21. At the next step S805, the merging section 107 carries out adjacency-search processing (with an upper-level search) by taking the horizontal direction as its direction (dir). The adjacency-search processing (with an upper-level search) will be described later.

Then, at the next step S807, the merging section 107 determines whether or not the search technique (searchType) of the merging setting information (config) is “2 Dir” or “4 Dir.” If the merging section 107 determines at the step S807 that the search technique (searchType) of the merging setting information (config) is neither “2 Dir” nor “4 Dir,” the merging section 107 determines that a one-direction search has been specified. In this case, the merging section 107 terminates the neighborhood-search merging processing.

If the merging section 107 determines at the step S807 that the search technique (searchType) of the merging setting information (config) is either “2 Dir” or “4 Dir,” on the other hand, the flow of the neighborhood-search merging processing goes on to a step S809 at which the merging section 107 carries out the adjacency-search processing with an upper-level search by taking the vertical direction as its direction (dir).

Then, at the next step S811, the merging section 107 determines whether or not the search technique (searchType) of the merging setting information (config) is “4 Dir.” If the merging section 107 determines at the step S607 that the search technique (searchType) of the merging setting information (config) is not “4 Dir,” the merging section 107 determines that a two-direction search has been specified. In this case, the merging section 107 terminates the neighborhood-search merging processing.

If the merging section 107 determines at the step S811 that the search technique (searchType) of the merging setting information (config) is “4 Dir,” on the other hand, the flow of the neighborhood-search merging processing goes on to a step S813 at which the merging section 107 carries out the adjacency-search processing (with an upper-level search) by taking the oblique right downward direction as its direction (dir). Then, at the next step S815, the merging section 107 carries out the adjacency-search processing (with an upper-level search) by taking the oblique right upward direction as its direction (dir). Then, finally, the merging section 107 terminates the neighborhood-search merging processing.

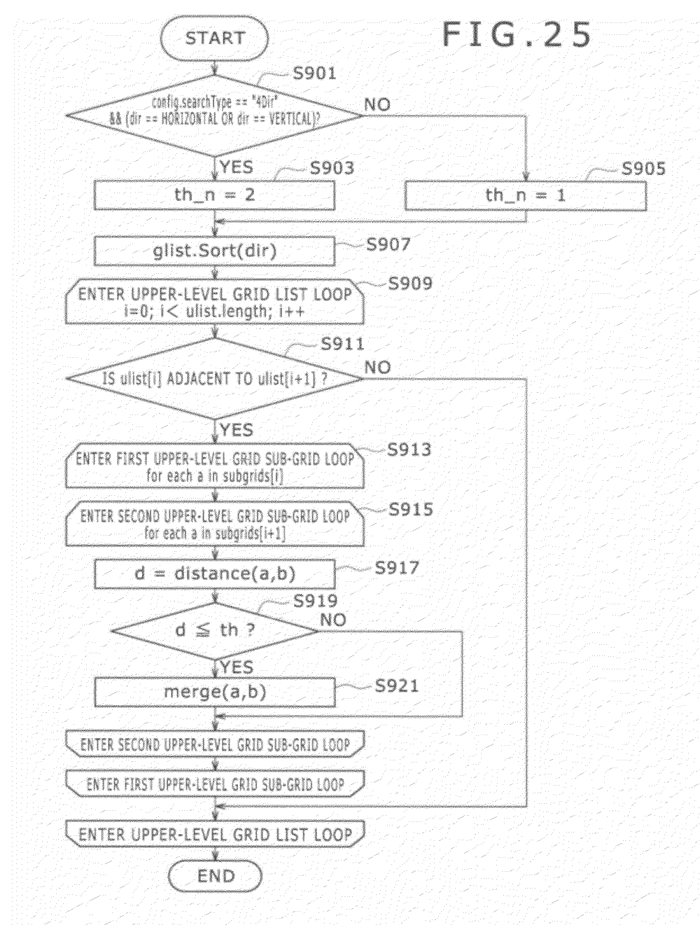

FIG. 25 shows a flowchart representing the adjacency search processing (with an upper-level search) carried out in accordance with the first embodiment of the present disclosure.

As shown in the figure, the flowchart begins with a step S901 at which the adjacency determination block 111 determines whether or not the search technique (searchType) of the merging setting information (config) is “4 Dir” and the direction (dir) is the horizontal or vertical direction.

If the adjacency determination block 111 determines at the step S901 that the search technique (searchType) of the merging setting information (config) is “4 Dir” and the direction (dir) is the horizontal or vertical direction, the flow of the adjacency search processing goes on to a step S903 at which the adjacency determination block 111 sets the adjacency determination threshold value th_n at 2. In this embodiment, the adjacency determination block 111 can set the adjacency determination threshold value th_n by taking the distance between upper-level grids as the unit of the adjacency determination threshold value th_n. It is to be noted that the distance between upper-level grids is twice the distance between grids. The adjacency determination threshold value th_n is a threshold value used in determining the adjacency between upper-level grids as will be described later and can be set at a value different from the predetermined threshold value th used in merging determination.

If the adjacency determination block 111 determines at the step S901 that the search technique (searchType) of the merging setting information (config) is not “4 Dir” and/or the direction (dir) is neither the horizontal direction nor the vertical direction, that is, if the adjacency determination block 111 determines at the step S901 that the search technique (searchType) of the merging setting information (config) is “1 Dir” or “2 Dir” and/or the direction (dir) is an oblique direction, on the other hand, the flow of the adjacency search processing goes on to a step S905 at which the adjacency determination block 111 sets the adjacency determination threshold value th_n at 1. It is to be noted that, in this embodiment, the adjacency search processing is carried out if the search technique (searchType) of the merging setting information (config) is “1 Dir,” “2 Dir” or “4 Dir.”

The adjacency determination threshold value th_n is set at a value depending on the search technique (searchType) of the merging setting information (config) as described above because of the following reasons. As explained earlier by referring to FIGS. 18A to 18C, in the one-direction search, grids 1031 adjacent to a specific grid 1031 typically in the horizontal or vertical direction are taken as the subject of the merging processing whereas, in the two-direction search, grids 1031 adjacent to a specific grid 1031 typically in the horizontal and vertical directions are taken as the subject of the merging processing. In these cases, the distance between the adjacent grids 1031 in the horizontal and vertical directions is equal to the size of the specific grid 1031. In the four-direction search, on the other hand, four grids 1031 adjacent to a specific grid 1031 in the horizontal direction, four grids 1031 adjacent to the specific grid 1031 in the vertical direction, two grids 1031 adjacent to the specific grid 1031 in the oblique right downward direction and two grids 1031 adjacent to the specific grid 1031 in the oblique right upward direction are taken as the subject of the merging processing. The four grids 1031 adjacent to the specific grid 1031 in the vertical or horizontal direction are two grids 1031 on one side of the specific grid 1031 and two grids 1031 on the other side.

Then, at the next step S907, the merging-oriented cluster-sorting block 109 carries out sort processing (sort) on grids 1031 on the upper-level grid list (ulist) in the direction (dir) as explained earlier by referring to FIG. 23. The direction (dir) is specified as a parameter typically when the adjacency search processing (with an upper-level search) is carried out at steps S805, S809, S813 and S815 of the flowchart shown in FIG. 21.

The sort processing (sort) is carried out typically in the same way as the temporary sorting (tmpSort) to assign an index to every grid on the grid list (glist) as explained earlier by referring to FIGS. 17A to 17D. However, the sort processing (sort) is carried out assign an index to every grid on the upper-level grid list (ulist). As explained earlier by referring to FIG. 23, every grid on the upper-level grid list (ulist) is a grid at the beginning of one of the upper-level grids.

Then, at the next step S909, the flow of the adjacency search processing enters an upper-level grid list loop in which, in accordance with the result of the sorting carried out at the step S907, the merging section 107 and the adjacency determination block 111 repeat the following steps S911 and S923 included in the upper-level grid list loop for the grids 1031 each indicated by one of the indexes i as a grid 1031 on the upper-level grid list (ulist) sequentially one grid after another, starting with the grid 1031 at the beginning of the list. It is to be noted that, in the upper-level grid list loop starting with the step S909, a grid 1031 included in the upper-level grid list (ulist) to serve as a subject of the processing is a grid 1031 indicated by the index i. In the following description, a grid 1031 on the upper-level grid list (ulist) is also referred to as a list element.

At the step S911, the adjacency determination block 111 determines whether or not a specific list element indicated by the index i as a grid 1031 on the upper-level grid list (ulist) and the list element immediately following the specific list element are adjacent to each other. The list element immediately following the specific list element is a list element indicated by (the index i+1). In this embodiment, two grids 1031 are determined to be adjacent to each other if the distance between the grids 1031 is equal to or shorter than the adjacency determination threshold value th_n. If the direction (dir) is the horizontal direction for example, the vertical-direction position of one of the grids 1031 is the same as the vertical-direction position of the other grid 1031. In the case of the typical example shown in FIG. 17A for example, the y coordinate of one of the grids 1031 is equal to the y coordinate of the other grid 1031. Thus, in the case of the typical example shown in FIG. 17A, the difference between the horizontal-direction position of one of the grids 1031 and the horizontal-direction position of the other grid 1031 is examined in order to merely determine whether or not the difference is equal to or shorter than the adjacency determination threshold value th_n. That is to say, the difference between the x coordinate of one of the grids 1031 and the x coordinate of the other grid 1031 is examined in order to merely determine whether or not the difference is equal to or shorter than the adjacency determination threshold value th_n. Thus, the amount of the processing carried out at the step S911 as processing to determine the adjacency between grids 1031 is small in comparison with the processing including an operation to compute the distance between a grid 1031 located at a position represented by coordinates and another grid 1031 located at another position represented by other coordinates.

If the adjacency determination block 111 determines at the step S911 that the specific list element indicated by the index i as a grid 1031 on the upper-level grid list (ulist) and the next list element indicated by (the index i+1) as a grid 1031 on the upper-level grid list (ulist) are adjacent to each other, the flow of the adjacency search processing goes on to a step S913 to enter a first upper-level gridsub-grade loop. In the first upper-level gridsub-grade loop, the merging section 107 repeats the following step S915 of the first upper-level gridsub-grade loop starting with the step S913 for every sub-grid pertaining to a first upper-level grid which is a list element indicated by the index i as a list element of the upper-level grid list (ulist). In the following description, the sub-gridserving as the subject of processing carried out in the first upper-level gridsub-grade loop starting with the step S913 is denoted by notation ‘a.’

At the step S915, the flow of the adjacency search processing enters a second upper-level gridsub-grade loop. In the second upper-level gridsub-grade loop, the merging section 107 repeats the following steps S917 to S921 of the second upper-level gridsub-grade loop starting with the step S915 for every sub-grid pertaining to a second upper-level grid which is a list element indicated by (the index i+1) as a list element of the upper-level grid list (ulist). In the following description, the sub-gridserving as the subject of processing carried out in the second upper-level gridsub-grade loop starting with the step S915 is denoted by notation ‘b.’

At the step S917, the merging section 107 computes the distance d between the sub-grids ‘a’ and ‘b.’ The computed distance d between the sub-grids ‘a’ and ‘b’ is typically the distance between the center of the cluster 1021 included in the sub-grade ‘a’ and the center of the cluster 1021 included in the sub-grade ‘b.’

Then, at the next step S919, the distance d computed at the step S917 is compared with a threshold value th determined in advance. The threshold value th can be the merging threshold value explained before by referring to Table 1.

If the distance d is determined at the step S919 to be equal to or shorter than the threshold value th, the flow of the adjacency search processing goes on to a step S921 at which the merging section 107 merges the cluster 1021 included in the sub-grade ‘a’ with the cluster 1021 included in the sub-grade ‘b.’ In this case, the merging section 107 merges the cluster 1021 included in the sub-grade ‘a’ with the cluster 1021 included in the sub-grade ‘b’ in order to create a new cluster 1021 which is associated with both the sub-grids ‘a’ and ‘b.’ That is to say, in this merging processing, the clusters 1021 of both the sub-grids ‘a’ and ‘b’ form the new cluster 1021.

If the adjacency determination block 111 determines at the step S911 that the specific list element indicated by the index i as a grid 1031 on the upper-level grid list (ulist) and the next list element indicated by (the index i+1) as a grid 1031 on the upper-level grid list (ulist) are not adjacent to each other, on the other hand, the flow of the adjacency search processing goes back to the step S909 in order to repeat the upper-level grid list loop, skipping the processes carried out at the steps S913 and S921. At the step S909, the merging section 107 increments the index i in order to refer to the next list element of the upper-level grid list (ulist).

By the same token, if the distance d is determined at the step S919 to be longer than the threshold value th, on the other hand, the flow of the adjacency search processing goes back to the step S915 in order to repeat the second upper-level gridsub-grid loop, skipping the process carried out at the step S921.

As described above, the adjacency determination process carried out at the step S911 to determine the adjacency between grids 1031 imposes a relatively small processing load. Thus, as described above, by making use the result of the adjacency determination process of the step S911 to determine whether or not to carry out the process to compute the distance d at the step S917 as a distance computation process imposing a relatively big processing load, the load of the entire processing can be reduced.

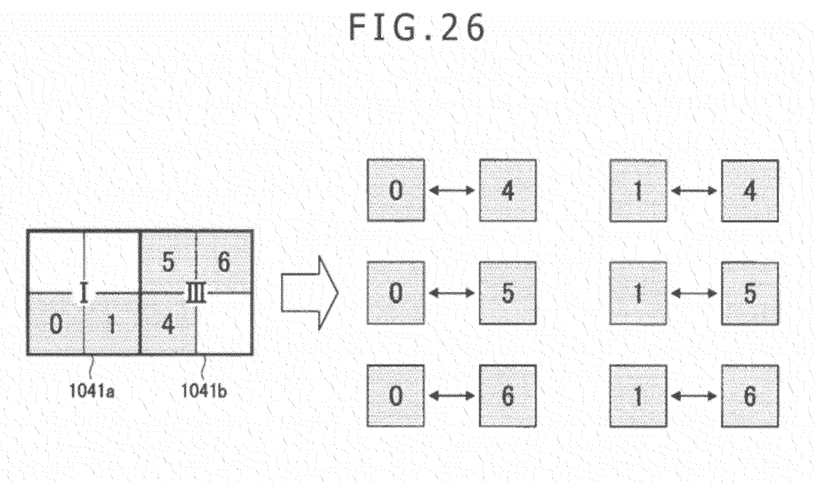

The processes carried out at the steps S913 to S921 are further explained by referring to FIG. 26. FIG. 26 is a diagram showing typical processes carried out at the steps S913 to S921 for a case in which the horizontal direction is taken as the direction (dir) and the upper-level grids I and III of the typical example shown in FIG. 22 serve as respectively the first and second upper-level grids cited above.

In the typical example shown in FIG. 26, a gridserving as the sub-grid ‘a’ subjected to the processing of the loop starting with the step S913 represents each grid pertaining to the upper-level grid I. In addition, a gridserving as the sub-grid ‘b’ subjected to the processing of the loop starting with the step S915 represents each grid pertaining to the upper-level grid III. Thus, a combination of grids serving as the subject of the merging processing carried out at the steps S917 to S921 to merge the sub-grade ‘a’ with the sub-grade ‘b’ is a round-robin combination of each of grids pertaining to the upper-level grid I and each of grids pertaining to the upper-level grid III as show in FIG. 26. There are six such combinations as shown in the figure. The maximum number of times the computation of a distance is carried out in the merging processing to merge clusters pertaining to such upper-level grids is about 4N (=N/4×4²) where notation N denotes a cluster count representing the number of clusters pertaining to the upper-level grids.

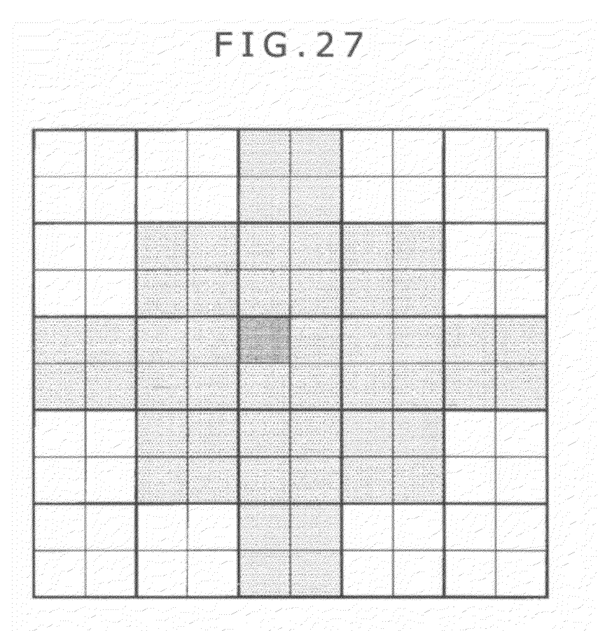

FIG. 27 is a diagram showing grids each serving as a subject of merging processing carried out on a specific grid for a case in which the neighborhood-search merging processing (with an upper-level search) is performed in accordance with the first embodiment of the present disclosure. In the figure, the grids each serving as a subject of merging processing are each shown as a sparsely hatched grid whereas the specific grid is shown as a densely hatched grid. FIG. 27 shows a case in which the search technique (searchType) of the merging setting information (config) is “4 Dir” whereas the upper-level search (upperLevel) of config is 1.

In this case, 12 upper-level grids each enclosed by bold lines as a grid in the neighborhood of the center upper-level grid including the specific grid in the four directions are taken as the subject of the merging processing in the upper-level search. In addition, since the center upper-level grid also includes three grids other than the specific grid, these three grids are also taken as the subject of the processing to merge grids with each other in the center upper-level grid. Thus, the total number of grids serving as the merging-processing subject in the neighborhood-search merging processing including an upper-level search is 51. Since the search is carried out in the four directions, the number of times the sorting is performed is four whereas the maximum number of times the computation of a distance is carried out in the merging processing to merge clusters pertaining to such upper-level grids with each other is about 17.5N (=4×4N+1.5N) where notation N denotes a cluster count representing the number of clusters pertaining to the upper-level grids.

The upper-level search processing like the one described above can be carried out as a one-direction search or a two-direction search. Due to the shape of the search range according to the embodiment, however, it is desirable, to carry out the upper-level search processing as a four-direction search. In addition, the number of times the sorting is carried out remains the same without regard to whether or not the upper-level search processing is performed. However, the maximum number of times the computation of a distance is carried out increases.

### Details of the Distance-Order Merging Processing

The distance-order merging processing includes processing to search for clusters 1021 each serving as a merging candidate and processing to merge the clusters 1021 each serving as a merging candidate with each other. The clusters 1021 each serving as a merging candidate are clusters 1021 separated from each other by a distance not greater than a threshold value determined in advance. The clusters 1021 each serving as a merging candidate are stored in a memory. The processing to merge the clusters 1021 each serving as a merging candidate is processing carried out to select clusters 1021 separated from each other by a short distance among the stored clusters 1021 each serving as a merging candidate and merge the selected clusters 1021 with each other.

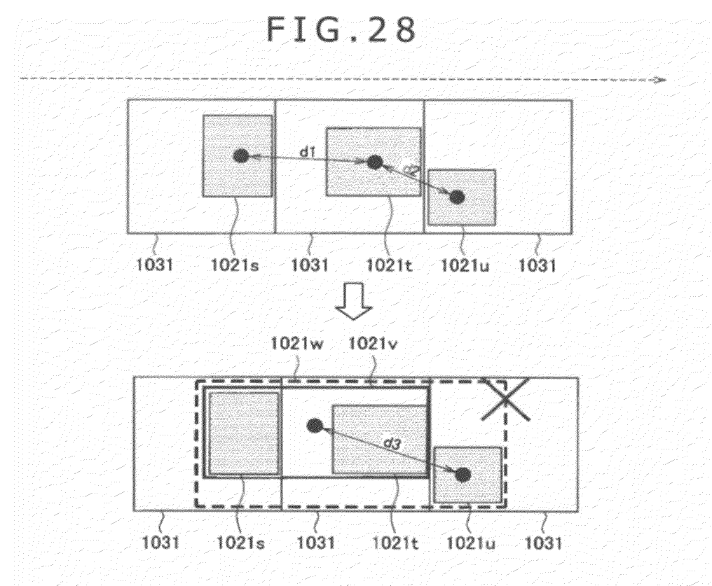

FIG. 28 is an explanatory diagram referred to in the following description of an outline of the distance-order sorting carried out in accordance with the first embodiment of the present disclosure. FIG. 28 shows clusters 1021s, 1021t and 1021u each included in one of three grids 1031 adjacent to each other in the horizontal direction which is taken as the search direction in this typical example. In this typical example, the centers of the clusters 1021s and 1021t are separated from each other by a distance d1 whereas the centers of the clusters 1021t and 1021u are separated from each other by a distance d2. Both the distances d1 and d2 are shorter than a threshold value th determined in advance for a merging-processing purpose and the distance d1 is longer than the distance d2, that is, the relation d1>d2 holds true.

If the adjacency-search processing like the one described before is carried out in the search order from the left to the right like the one shown in the figure, a combination of the clusters 1021s and 1021t becomes the first subject of the merging processing. Since the distance d1 between the centers of the clusters 1021s and 1021t is shorter than the predetermined threshold value th provided for the merging-processing purpose, the clusters 1021s and 1021t are merged with each other to form a cluster 1021v. Let the distance between the centers of the clusters 1021v and 1021u be denoted by notation d3. Also let the distance d3 be longer than both the distances d1 and d2 as well as longer than the predetermined threshold value th provided for the merging-processing purpose.

Then, a combination of the clusters 1021v and 1021u is taken as the next subject of the merging processing. Since the distance d3 between the centers of the clusters 1021v and 1021u is longer than the predetermined threshold value th provided for the merging-processing purpose, however, the clusters 1021v and 1021u are not merged with each other. Thus, a cluster 1021w is not formed as a result of merging the clusters 1021s to 1021u with each other.

As described above, if the merging processing is carried out in the search order, there is a problem that the clusters 1021s and 1021t are merged with each other but the cluster 1021u is not merged in spite of the fact that the distance d2 between the centers of the clusters 1021t and 1021u is shorter than the distance d1 between the centers of the clusters 1021s and 1021t.

In order to solve the problem described above, distance-order merging is carried out. In this embodiment, as described above, the merging setting information (config) includes the distance-order merging flag (sortPair). If the distance-order merging flag (sortPair) is set at “true,” the distance-order merging is carried out.

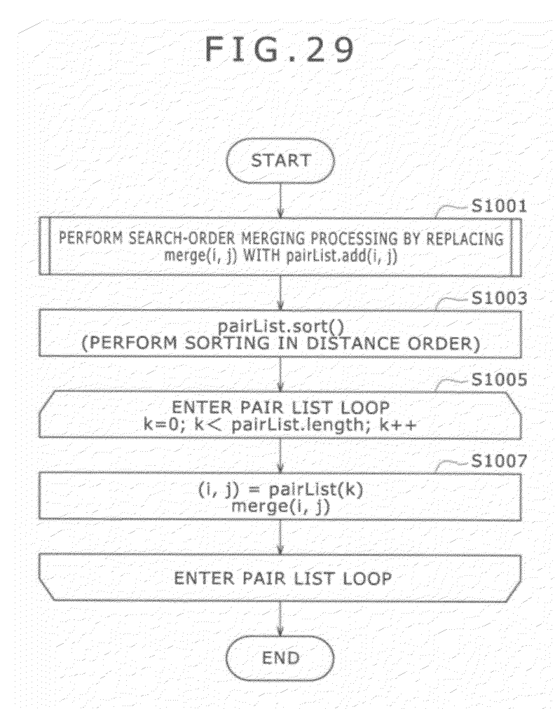

FIG. 29 shows a flowchart representing the distance-order merging processing carried out in accordance with the first embodiment of the present disclosure.

As shown in the figure, the flowchart begins with a step S1001 at which the merging section 107 carries out processing similar to the search-order merging processing explained earlier by referring to the flowchart shown in FIG. 15. In the case of the distance-order merging, however, processing (add) to add clusters 1021 each included in a grid 1031 as merging-candidate clusters 1021 to a pair list (pairList) instead of performing merging operation (merge) in either of the full-match merging processing and neighborhood-search merging processing which are called from the search-order merging processing. The pair list (pairList) is a list of pairs each composed of two merging-candidate clusters 1021. For example, in the case of the distance-order merging, the step S717 of the flowchart shown in FIG. 20 as a flowchart representing the adjacency search processing (without an upper-level search) is replaced by an operation described as follows.

If the distance d is determined at the step S715 to be equal to or shorter than the threshold value th, the flow of the adjacency search processing goes on to a step S717 at which the merging section 107 carries out processing (add) at the step S1001 to add the cluster 1021 of the specific list element indicated by the index as a grid 1031 on the grid list (glist) and the cluster 1021 of the next list element indicated by (the index i+1) as a grid 1031 on the grid list (glist) to the pair list (pairList) as merging-candidate clusters 1021.

Then, at the next step S1003, the merging section 107 sorts pairs each composed of two clusters 1021 included on the pair list (pairList) as an element of the list into an order of increasing distances each representing the distance d between clusters 1021 included in one of the pairs. For this reason, at the step S1001, for each pair on the pair list (pairList), the distance d between clusters 1021 included in the pair is added to information on the clusters 1021 included in the pair.

Then, at the next step S1005, the flow of the distance-order merging processing enters a pair list loop in which the merging section 107 repeats the following step S1007 included in the loop for pairs on the pair list (pairList) in an order set as a result of the sorting carried out at the step S1003 sequentially pair after pair, starting with the pair at the head of the list. The pairs each serving the subject of the processing carried out in the pair list loop starting with the step S1005 are each an element indicated by an index k as an element of the pair list (pairList). As described above, the pairs each composed of two clusters 1021 included on the pair list (pairList) as an element of the list are sorted into an order of increasing distances each representing the distance d between clusters 1021 included in one of the pairs. Then, the merging is carried out on the pairs in an order set as a result of the sorting, starting with the pair at the head of the pair list (pairList). Thus, the merging is carried out in the order starting with a pair having the shortest distance between the two clusters 1021 included in the pair.

At the step S1007, the merging section 107 carries out merging processing (merge) to merge merging-candidate clusters 1021, which are represented by an element indicated by an index k as an element of the pair list (pairList), with each other in order to create a new cluster 1021. As described earlier, each element of the pair list (pairList) is a pair of merging-candidate clusters 1021. Information on the new cluster 1021 may include information on each of the merging-candidate clusters 1021 merged with each other to form the new cluster 1021. If a specific one of the merging-candidate clusters 1021 serving as the subject of the merging carried out at the step S1007 has been merged with another cluster 1021 in previously executed loop processing starting with the step S1005, at the step S1007, the other merging-candidate cluster 1021 serving as the subject of the merging carried out at the step S1007 may be merged with the other cluster 1021. If both the merging-candidate clusters 1021 serving as the subject of the merging carried out at the step S1007 have been merged with other clusters 1021 in previously executed loop processing starting with the step S1005, the merging section 107 cancels the merging of the step S1007. Instead, the merging section 107 repeats the pair list loop starting with the step S1005 in order to make a transition to the processing of the next element on the pair list (pairList).

It is to be noted that, if the distance-order merging is enabled, it is necessary to provide a memory area for storing the pair list (pairList). The size of the pair list (pairList) is determined by the number of merging-candidate clusters 1021 which may probably be merged with each other. Thus, in the worst case, where the pair list (pairList) has a largest size, the size of the pair list (pairList) is proper for the maximum number of times the computation of a distance is carried out. In addition, the wider the range of the adjacency determination, the larger the size of the pair list (pairList). The larger the number of grids 1031 serving as the subject of processing, the larger the number of directions of the neighborhood search and, the larger the number of upper levels at which the upper-level search is to be carried out, the larger the maximum number of times the computation of a distance is carried out. Thus, in an environment having a limited storage area, it is desirable to enable the distance-order merging for a case in which the number of grids 1031 serving as the subject of processing is reduced to a certain degree by, among others, making use of typically the merging setting information described before by referring to FIG. 13.

The merging processing carried out in accordance with the first embodiment of the present disclosure has been explained so far. In the ordinary merging processing, it is necessary to compute the distances between every two clusters 1021 for all combinations of clusters 1021 so that the load imposed by the merging processing is large. In addition, in the ordinary merging processing, it is difficult to adjust the load imposed by the merging processing. In the case of the merging processing carried out in accordance with the embodiment, on the other hand, merging setting can be selected. To put it concretely, in accordance with the number of grids 1031 each including a cluster 1021 for example, it is possible to determine whether or not the merging is to be carried out and, if the merging is to be carried out, it is possible to select the search-order merging, the distance-order merging, the full-match merging or the neighborhood-search merging. In addition, the merging precision and the merging load can be adjusted. In the case of the neighborhood-search merging, grids 1031 the distances between which are to be computed for the merging purpose are sorted in a certain direction and the merging is carried out only for grids 1031 found adjacent to each other as a result of the sorting. Thus, it is possible to decrease the number of times the computation of a distance is carried out. As a result, the load of the neighborhood-search merging processing can be reduced.

### 2: Second Embodiment

A second embodiment of the present disclosure can be applied to a case in which the feature space is a three-dimensional space including the earth. In addition, in the case of this embodiment, the information on each position in the three-dimensional space is expressed by making use of a three-dimensional orthogonal coordinate system such as the system based on the x, y and z coordinates. On top of that, in this embodiment, a cluster is an area provided with information on the positions of contents included in a block defined in the three-dimensional feature space in terms of the x, y and z coordinates as a block associated with the cluster.

It is to be noted that the second embodiment of the present disclosure is different from the first embodiment of the present disclosure in that, in the case of the first embodiment of the present disclosure, the clustering is carried out on the basis of grids each defined in a two-dimensional space whereas, in the case of the second embodiment of the present disclosure, the clustering is carried out on the basis of blocks each defined in a three-dimensional space. Otherwise, the second embodiment of the present disclosure is approximately identical with the first embodiment of the present disclosure, making it unnecessary to explain details of the second embodiment.

### 2-1: Outline of the Block-Based Positional Clustering

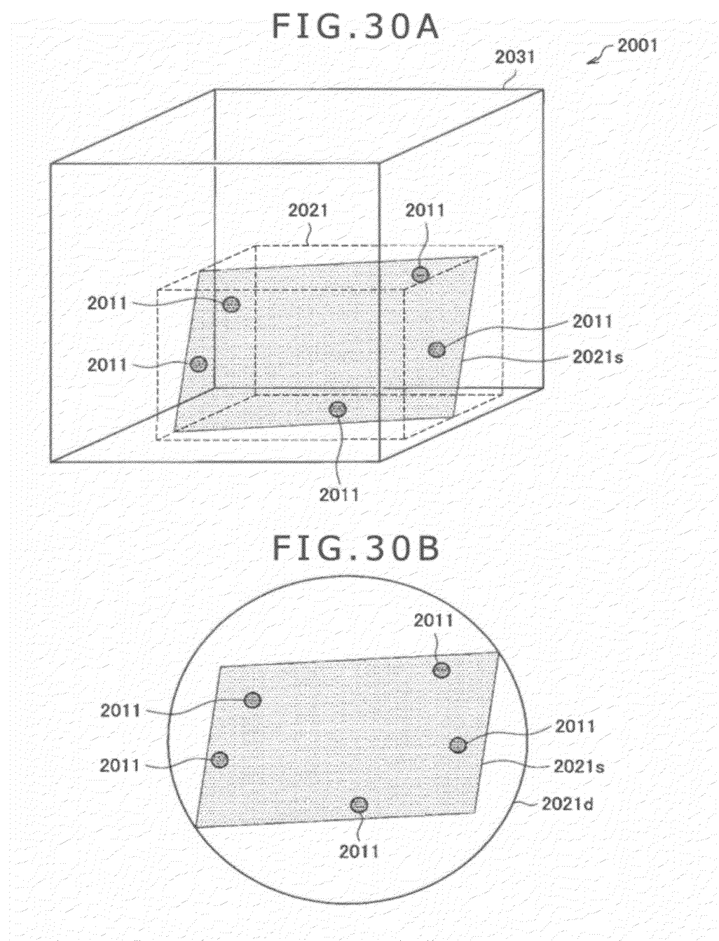

By referring to FIGS. 30A to 34, the following description explains an outline of clustering carried out in accordance with the second embodiment of the present disclosure. The clustering carried out in accordance with the embodiment is processing to group contents each having information on its position in a cluster by taking blocks, which are each defined for a cluster by making use of a three-dimensional orthogonal coordinate system, as a reference. Thus, the clustering carried out in accordance with the embodiment can be said to be block-based positional clustering.

### Blocks

FIG. 30A is a diagram showing typical relations between contents 2011, clusters 2021 and blocks 2031 in the second embodiment of the present disclosure. FIG. 30A shows the three-dimensional space 2001, the contents 2011, the clusters 2021 and the blocks 2031.

The three-dimensional space 2001 is a space including all or a portion of the earth. In this embodiment, the three-dimensional space 2001 is a three-dimensional space, each position in which is expressed in terms of three different coordinates referred to as x, y and z coordinates of a 3-dimensional coordinate system.

A content 2011 is data having information on the position of the data in the three-dimensional space 2001. The content 2011 can be the data position itself or data having main information to which information on the position of the data is added as additional information. A typical example of the three-dimensional space 2001 is the data of an image and additional information added to the data as information on a position at which the image has been taken.

A cluster 2021 is an area including contents 2011 at positions close to each other in the three-dimensional space 2001. The cluster 2021 is shown in the figure as a cube. However, the cluster 2021 can also be shown to have a shape other than that of the cube. In addition, a cluster 2021 can also be a cube having a shape circumscribing contents 2011 grouped in the cluster 2021. In the typical example shown in the figure, the contents 2011 are located at positions on the earth surface 2010. Thus, the contents 2011 are located at positions on a cut surface 2021s obtained as a result of cutting the cluster 2021 by the earth surface 2010.

A block 2031 is a block set in the three-dimensional space 2001. The block 2031 is defined as a spatial range of x, y and z coordinates in the three-dimensional space 2001. The size of the block 2031 is set properly in accordance with clustering conditions such as the number of contents 2011 and the size of a spatial area used as the subject of clustering.

As shown in the figure, in this embodiment, contents 2011 existing in the same block 2031 are grouped in the same cluster 2021 associated with the block 2031. That is to say, in the block-based positional clustering processing carried out in accordance with the embodiment, determination as to whether or not contents 2011 are included in the same block 2031 is the basic criterion of clustering. Since all the contents 2011 shown in the figure exist in the same block 2031, the contents 2011 are grouped in the same cluster 2021 included in the block 2031.

In the typical example shown in the figure, all the contents 2011 are located at positions on the earth surface 2010. It is to be noted, however, that a content 2011 may also be located inside the earth or under the ground for example. In this case, the content 2011 is located on the internal side of a cut surface 2021s obtained as a result of cutting the cluster 2021 by the earth surface 2010. In addition, a content 2011 may also be located on the external side of the earth or in the air. In this case, the content 2011 is located on the external side of the cut surface 2021s obtained as a result of cutting the cluster 2021 by the earth surface 2010. By taking blocks 2031 which may be spread over the inside and outside of the earth as the basic clustering criterion, a cluster 2021 of a block 2031 can be set to include contents 2011 even if the block 2031 is spread over the inside and outside of the earth.

FIG. 30B is a diagram showing a typical display of contents 2011 and a cluster 2021 in the second embodiment of the present disclosure. To be more specific, FIG. 30B shows the contents 2011 and the cluster 2021, which are shown in FIG. 30A, as a typical layout on the cut surface 2021s on the earth surface 2010.

In the typical example shown in the figure, a cluster display area 2021d is also shown in addition to the contents 2011 and the cluster 2021. The cluster display area 2021d is a circle circumscribing the cut surface 2021s obtained as a result of cutting the cluster 2021 by the earth surface 2010. In this way, the cluster display area 2021d can be formed as a figure circumscribing the cut surface 2021s obtained as a result of cutting the cluster 2021 by the earth surface 2010. In addition, if a content 2011 is located inside the earth or in the air as described above, the cluster display area 2021d may be formed as a cube.

In the block-based positional clustering carried out in accordance with this embodiment, the information on the positions of content 2011 by itself represents a block 2031 including the contents 2011. If contents 2011 are sorted in the order of combined base-N numerical values each representing one of the contents 2011 in the same way as the first embodiment of the present disclosure, the contents 2011 included in the area of the same block 2031 are adjacent to each other in the result of the sorting. Also in the same way as the first embodiment of the present disclosure, each of the combined base-N numerical values is obtained by alternately arranging digits representing the values of all the x, y and z coordinates each represented by a component base-N numerical value having a predetermined digit count representing the number of aforementioned digits representing the coordinate sequentially on a digit-after-digit basis.

Conversely, it is possible to determine whether or not contents 2011 adjacent to each other in the result of the processing are included in the same block 2031 by typically determining whether the combined base-N numerical values each representing one of the contents 2011 have k most significant digits (where k=1, 2 and so on) common to the base-N numerical values. As described above, contents 2011 included in the same block 2031 are contents 2011 grouped in the same cluster 2021 included in the block 2031. Therefore, the operation to sort contents 2011 by sorting numerical values each generated from the positional information of one of the contents 2011 is the main operation of the block-based positional clustering carried out in accordance with this embodiment.

### Hierarchical Structure of Blocks

In the same way as grids 1031 in the first embodiment, blocks 2031 in the second embodiment can be organized in a hierarchical structure. The following description explains a typical case in which the center of the hierarchical structure coincides with the center of the earth and a block including the entire earth is taken as a block at a level of 0. In this typical case, blocks at a level of 1 are obtained by dividing the block at the level of 0 into two equal halves adjacent to each other in the direction of the x coordinate, two equal halves adjacent to each other in the direction of the y coordinate and two equal halves adjacent to each other in the direction of the z coordinate. By the same token, blocks at a level of two are obtained by dividing a block at the level of 1 into two equal halves adjacent to each other in the direction of the x coordinate, two equal halves adjacent to each other in the direction of the y coordinate and two equal halves adjacent to each other in the direction of the z coordinate. In the same way, blocks at a level of 3 are obtained by dividing each a block at the level of 2 into two equal halves adjacent to each other in the direction of the x coordinate, two equal halves adjacent to each other in the direction of the y coordinate and two equal halves adjacent to each other in the direction of the z coordinate. Likewise, blocks at a level of 4 are obtained by dividing a block at the level of 3 into two equal halves adjacent to each other in the direction of the x coordinate, two equal halves adjacent to each other in the direction of the y coordinate and two equal halves adjacent to each other in the direction of the z coordinate. Thereafter, blocks at a specific level are obtained by dividing a block at a level immediately higher than the specific level into two equal halves adjacent to each other in the direction of the x coordinate, two equal halves adjacent to each other in the direction of the y coordinate and two equal halves adjacent to each other in the direction of the z coordinate. In this way, blocks at subsequent lower levels can be defined.

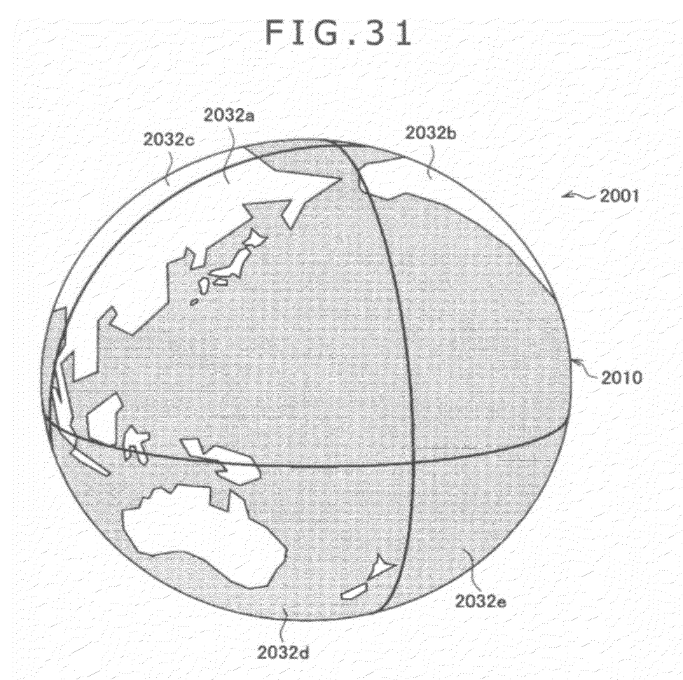

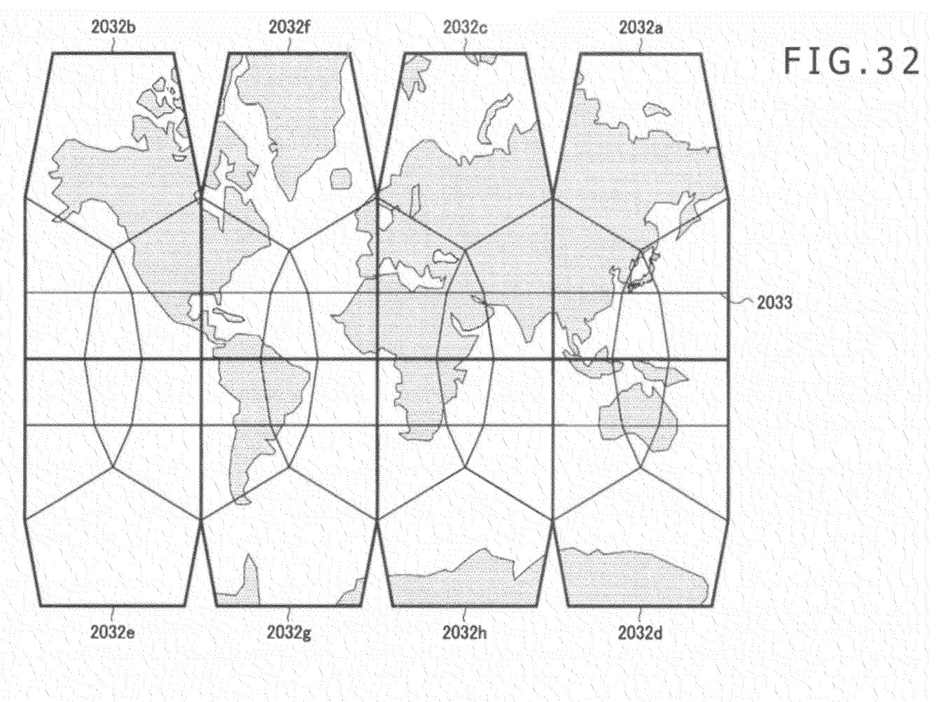

FIG. 31 is an explanatory diagram referred to in the following description of an operation to divide the earth surface 2010 by making use of blocks in accordance with the second embodiment of the present disclosure. If the center of the block at a level of 0 coincides with the center of the earth, as shown in the figure, the earth surface 2010 is divided by blocks at a level of 1 into eight areas 2032a to 2032h. FIG. 31 is a diagram showing the earth seen from a position outside the earth. The areas 2032a to 2032e of the eight areas 2032a to 2032h obtained as a result of dividing the earth surface 2010 by blocks at a level of 1 are shown in the figure.

FIG. 32 is an explanatory diagram referred to in the following description of an operation to divide the earth surface 2010 by making use of blocks in accordance with the second embodiment of the present disclosure. FIG. 32 is a diagram showing a plane obtained as a result of deploying the earth. The earth surface 2010 is divided by blocks at a level of 1 into eight areas 2032a to 2032h. An area 2033 on the earth surface 2010 is obtained by further dividing a block at a level of 1 by blocks at a level of 2. In this embodiment, each block at a level of 1 is divided into eight blocks at a level of 2. Since a specific one of the blocks at a level of 2 is located inside the earth, however, the specific block does not cross the earth surface 2010. For this reason, the eight areas 2032a to 2032h each resulting from the division of the earth surface 2010 by the blocks at a level of 1 as an area on the earth surface 2010 are each divided by the blocks at a level of 2 into 7 (=8-1) areas 2033.

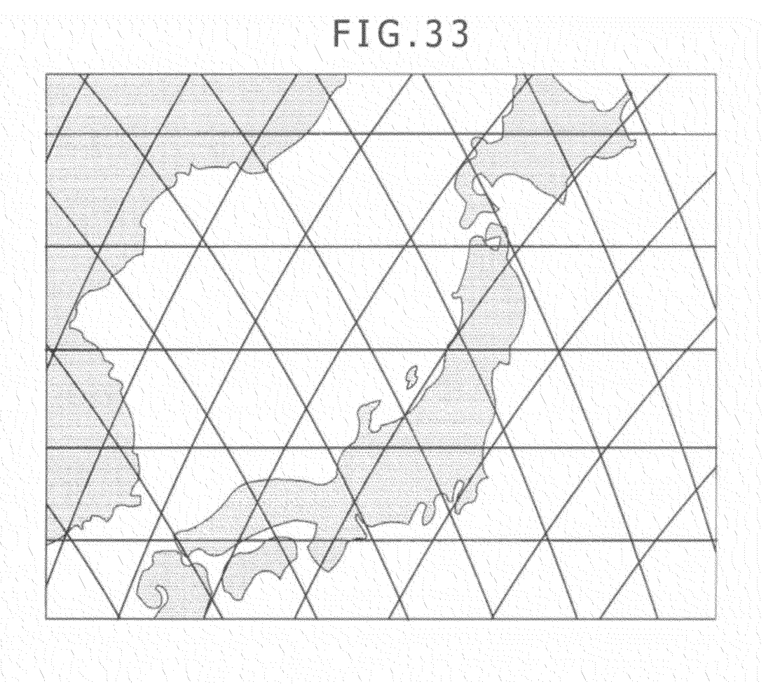

FIG. 33 is an explanatory diagram referred to in the following description of an operation to divide the earth surface 2010 by making use of blocks in accordance with the second embodiment of the present disclosure. FIG. 33 is a diagram showing areas obtained as a result of dividing the earth surface 2010 by the blocks at a level of 5. The blocks at a level of 5 are each a lower-level block hierarchically defined in the same way as the upper-level blocks at the levels 0 to 2. As shown in the figure, a block at a level of 0 has a size proper typically for grouping contents 2011 in areas of Japan. Also in the block-based positional clustering carried out in accordance with this embodiment, by adjusting the level of blocks used in the clustering processing, it is possible to establish a balance between the granularity of the clustering processing and the load of the processing.

As described above, blocks at a specific level are obtained by dividing a block at a level immediately higher than the specific level into two equal halves adjacent to each other in the direction of the x coordinate, two equal halves adjacent to each other in the direction of the y coordinate and two equal halves adjacent to each other in the direction of the z coordinate. In other words, the block at a level immediately higher than the specific level is divided into eight blocks at the specific level. Thus, the hierarchical structure of blocks 2031 in this embodiment is an 8-child tree structure having the block at the level of 0 used as the root node and other blocks at lower levels as nodes. Clusters 2021 each included in one of the blocks 2031 also have an 8-child tree structure identical with that of the blocks 2031.

In the case of the ordinary distance-based positional clustering, if a tree structure of clusters is defined, it is necessary to provide a memory area for storing information on the tree structure. In the case of the block-based positional clustering carried out in accordance with this embodiment, on the other hand, the 8-child tree structure of the blocks 2031 is uniquely determined as described above. Thus, by storing only information on the level of every block 2031, it is possible to know the tree structure of clusters 2021 with ease on the basis of the 8-child tree structure of the blocks 2031.

Comparison with the Grid-Based Positional Clustering

In the case of the grid-based positional clustering carried out in accordance with the first embodiment described above, the earth surface 1001 is treated as a two-dimensional plane and information on every position on the two-dimensional plane is expressed in terms of two different coordinates which are the latitude and longitude coordinates of a two-dimensional coordinate system. In this case, the size of a grid is defined in the form such as, for example, (a latitude of 1 degree)×(a longitude of 1 degree). As is generally known, however, a distance of a 1-degree latitude corresponds to an approximately fixed value of about 111 km whereas a distance of a 1-degree longitude decreases at high latitudes. To put it concretely, for example, a distance of a 1-degree longitude on the equator line having a latitude of 0 degrees corresponds to about 111 km but a distance of a 1-degree longitude at a location having a latitude of 60 degrees corresponds to about 55.7 km. Thus, expressed in terms of actual distances, the size of a grid at a location in the vicinity of the equator line is 111 km×111 km but the size of a grid at a location in the vicinity of a latitude of 60 degrees is 111 km×55.7 km. That is to say, the area of a grid at a location in the vicinity of a latitude of 60 degrees is about half the area of a grid at a location in the vicinity of the equator line.

In the case of the block-based positional clustering carried out in accordance with the second embodiment described above, on the other hand, a cluster 2021 including contents 2011 on the earth surface 2010 is set in a block 2031 by enclosing the contents 2011 in the block 2031 defined in the three-dimensional space 2001. Thus, the size of a block 2031 does not vary with the latitude. It is to be noted that, depending on the difference in how the earth surface 2010 cuts the block 2031, the size of an area occupied by an earth surface 2010 at a latitude may be different from the size of an area occupied by another earth surface 2010 at the same latitude. By adjusting the merging processing to such block-based positional clustering, it is possible to carry out clustering at a uniform granularity independently of the latitude.

Base-N Numerical Values Associated with Blocks

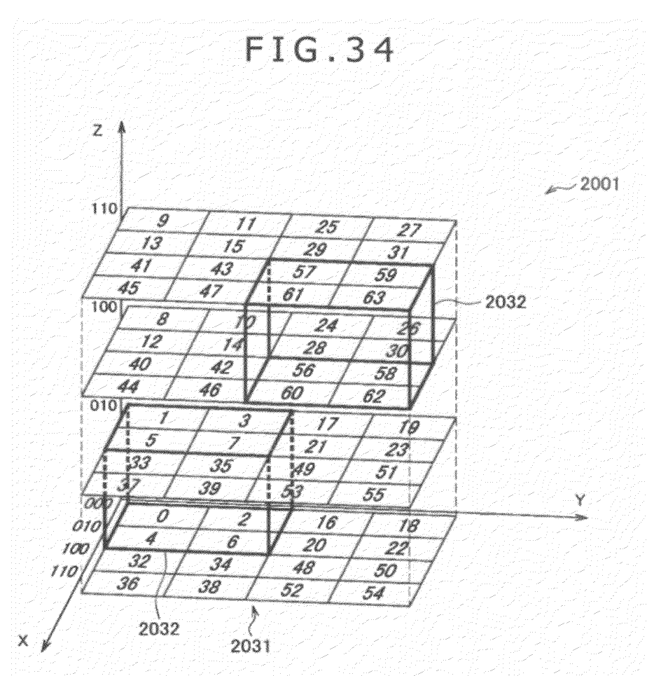

FIG. 34 is an explanatory diagram referred to in the following description of clustering carried out in accordance with the second embodiment of the present disclosure. A number assigned to every block 2031 is one of indexes obtained as a result of sorting the blocks 2031 in accordance with the magnitudes of base-N numerical values each associated with one of the blocks 2031.

Also in the case of this embodiment, the base-N numerical-value generation section 101 employed in the information processing apparatus 100 generates a combined base-N numerical value for each piece of data having positional information indicating a position prescribed in terms of three coordinates of a three-dimensional coordinate system set for the three-dimensional space 2001 as the position of the piece of data in the three-dimensional space 2001 by alternately arranging digits representing the values of all the three coordinates each represented by a component base-N numerical value having a predetermined digit count representing the number of aforementioned digits representing the coordinate sequentially on a digit-after-digit basis. In this embodiment, the base-N numerical value is a binary-system numerical value.

For example, the predetermined digit count representing the number of digits representing a coordinate is set at 21. In this case, the base-N numerical-value generation section 101 expresses the value of each of the x, y and z coordinates by the aforementioned component binary-system numerical value having 21 digits. Let the component binary-system numerical value having 21 digits representing the value of the x coordinate be “x₂₀x₁₉x₁₈ . . . x₀,” the component binary-system numerical value having 21 digits representing the value of the y coordinate be “y₂₀y₁₉y₁₈ . . . y₀” and the component binary-system numerical value having 21 digits representing the value of the z coordinate be “z₂₀z₁₉z₁₈ . . . z₀.” In this case, the base-N numerical-value generation section 101 alternately arranges the all the digits representing the x, y and z coordinates sequentially on a digit-after-digit basis in order to generate a combined binary-system numerical value having 63 (=3×21) digits, that is, “x₂₀y₂₀z₂₀x₁₉y₁₉z₁₉x₁₈y₁₈z₁₈ . . . x₀y₀z₀.” It is to be noted that, if the predetermined digit count representing the number of digits representing a coordinate is set at 21, the minimum resolution in the direction of the diagonal line of the block 2031 is 11 meters. The predetermined digit count can be set at a value proper for typically the required minimum resolution and the size of a data unit used by the information processing apparatus 100. Typical examples of the size of the data unit are 32 bits and 64 bits.

In the typical example shown in the figure, in order to make the following description easy to understand, it is assumed that each of the x, y and z coordinates of the position of a content 2011 in the three-dimensional space 2001 is represented by a component binary-system numerical value having only three digits. In this case, the block 2031 is a block prescribed by the k (=6) most significant digits of the combined binary-system numerical value generated by the base-N numerical-value generation section 101 from the three component binary-system numerical values representing the x, y and z coordinates respectively. The six most significant digits of the combined binary-system numerical value representing the position of a content 2011 is generated by combining the two most significant digits of each of the three component binary-system numerical values representing the x, y and z coordinates respectively as shown in Table 2 described below. The three-dimensional space 2001 is divided into 64 (=(2³)²) blocks 2031. In the typical example shown in the figure, each of indexes having values in a range of 0 to 63 is assigned to one of the blocks 2031. These indexes show an order obtained as a result of sorting contents 2011 included the blocks 2031 in accordance with combined binary-system numerical values each representing one of the contents 2011. That is to say, the order of increasing indexes cited above is the order of increasing binary-system numerical values mentioned above.

Each entry of Table 2 shows a relation between an index assigned to any specific one of the blocks 2031 and x, y and z coordinates of the position of any of contents 2011 included in the specific block 2031. The binary-system numerical value in the rightmost end of the entry is the combined binary-system numerical value generated by the base-N numerical-value generation section 101 from the x, y and z coordinates as a binary-system numerical value representing the position. As an example, in the case of a block 2031 having an index of 0, the x, y and z coordinates are 00x, 00y and 00z respectively whereas the combined binary-system numerical value is 000000xyz. The six most significant digits 000000 of the combined binary-system numerical value represent the block 2031 having an index of 0. As another example, in the case of a block 2031 having an index of 8, the x, y and z coordinates are 00x, 00y and 01z respectively whereas the combined binary-system numerical value is 001000xyz. The six most significant digits 001000 of the combined binary-system numerical value represent the block 2031 having an index of 8. As a further example, in the case of a block 2031 having an index of 55, the x, y and z coordinates are 11x, 11y and 01z respectively whereas the combined binary-system numerical value is 110111xyz. The six most significant digits 110111 of the combined binary-system numerical value represent the block 2031 having an index of 55. As a still further example, in the case of a block 2031 having an index of 63, the x, y and z coordinates are 11x, 11y and 11z respectively whereas the combined binary-system numerical value is 111111xyz. The six most significant digits 1111 of the combined binary-system numerical value represent the block 2031 having an index of 63. In this case, notations z, y and z used in the x, y and z coordinates and the combined binary-system numerical value each denote any digit value which can be 0 or 1.

TABLE 2

| | | | | Binary-system |
|---|---|---|---|---|
| Index | x coordinate | Y coordinate | z coordinate | numerical value |
| 0 | 0 0 x | 0 0 y | 0 0 z | 0 0 0 0 0 0 x y z |
| 1 | 0 0 x | 0 0 y | 0 1 z | 0 0 0 0 0 1 x y z |
| 2 | 0 0 x | 0 1 y | 0 0 z | 0 0 0 0 1 0 x y z |
| 3 | 0 0 x | 0 1 y | 0 1 z | 0 0 0 0 1 1 x y z |
| 4 | 0 1 x | 0 0 y | 0 0 z | 0 0 0 1 0 0 x y z |
| 5 | 0 1 x | 0 0 y | 0 1 z | 0 0 0 1 0 1 x y z |
| 6 | 0 1 x | 0 1 y | 0 0 z | 0 0 0 1 1 0 x y z |
| 7 | 0 1 x | 0 1 y | 0 1 z | 0 0 0 1 1 1 x y z |
| 8 | 0 0 x | 0 0 y | 1 1 z | 0 0 1 0 0 0 x y z |
| . | . | . | . | . |
| . | . | . | . | . |
| . | . | . | . | . |
| 55 | 1 1 x | 1 1 y | 0 1 z | 1 1 0 1 1 1 x y z |
| 56 | 1 0 x | 1 0 y | 1 0 z | 1 1 1 0 0 0 x y z |
| 57 | 1 0 x | 1 0 y | 1 1 z | 1 1 1 0 0 1 x y z |
| 58 | 1 0 x | 1 1 y | 1 0 z | 1 1 1 0 1 0 x y z |
| 59 | 1 0 x | 1 1 y | 1 1 z | 1 1 1 0 1 1 x y z |
| 60 | 1 1 x | 1 0 y | 1 0 z | 1 1 1 1 0 0 x y z |
| 61 | 1 1 x | 1 0 y | 1 1 z | 1 1 1 1 0 1 x y z |
| 62 | 1 1 x | 1 1 y | 1 0 z | 1 1 1 1 1 0 x y z |
| 63 | 1 1 x | 1 1 y | 1 1 z | 1 1 1 1 1 1 x y z |

In this embodiment, for N=2, the clustering section 101 groups a plurality of contents 2011, which are each represented by one of the combined base-N numerical values generated by the base-N numerical-value generation section 101 as numerical values each having k most significant digits common to the contents 2011 (where k=1, 2 and so on), in the same cluster 2021. If the relation k=3×m (m=1, 2 and so on) holds true, this cluster 2021 serving as a group of contents 2011, which are each represented by one of the combined base-N numerical values generated by the base-N numerical-value generation section 101 as numerical values each having k most significant digits common to the contents 2011, is a cluster 2021 on the mth layer of an 8 (=2³)-child tree structure of clusters 2021.

As shown in Table two contents 2011 included in the blocks 2031 having indexes of 0 to 7 are represented by binary-system numerical values each having three most significant digit of 000 common to the contents 2011. As is obvious from FIG. 34, the blocks 2031 including these clusters 2021 are eight blocks 2031 located on the left lower inner corner of the space shown in the figure. As shown in the figure, these blocks 2031 are eight blocks 2031 forming an upper-level block 2041 which is a block on a layer at a level higher by 1 level than the level of the layer of the eight blocks 2031 in the hierarchical structure. Thus, for example, contents 2011 included in a block 2031 having an index of 1 and contents 2011 included in a block 2031 having an index of 5 are in the same upper-level block 2041.

Also in the second embodiment, as explained earlier by referring to FIGS. 30A and 30B, each block 2031 is associated with a cluster 2021 included in the block 2031 in the same way as each grid 1031 is associated with a cluster 1021 included in the grid 1031 in the first embodiment described before. Thus, it is possible to easily understand the reason why the clustering section 101 groups a plurality of contents 2011, which are each represented by one of the combined base-N numerical values generated by the base-N numerical-value generation section 101 as numerical values each having k most significant digits common to the contents 2011, in the same cluster 2021 as described above.

It is to be noted that the clustering and the other processing related to the merging are carried out in the second embodiment in the same way as the first embodiment explained earlier.

### 3: Hardware Configuration of the Information Processing Apparatus According to the Embodiments of the Disclosure

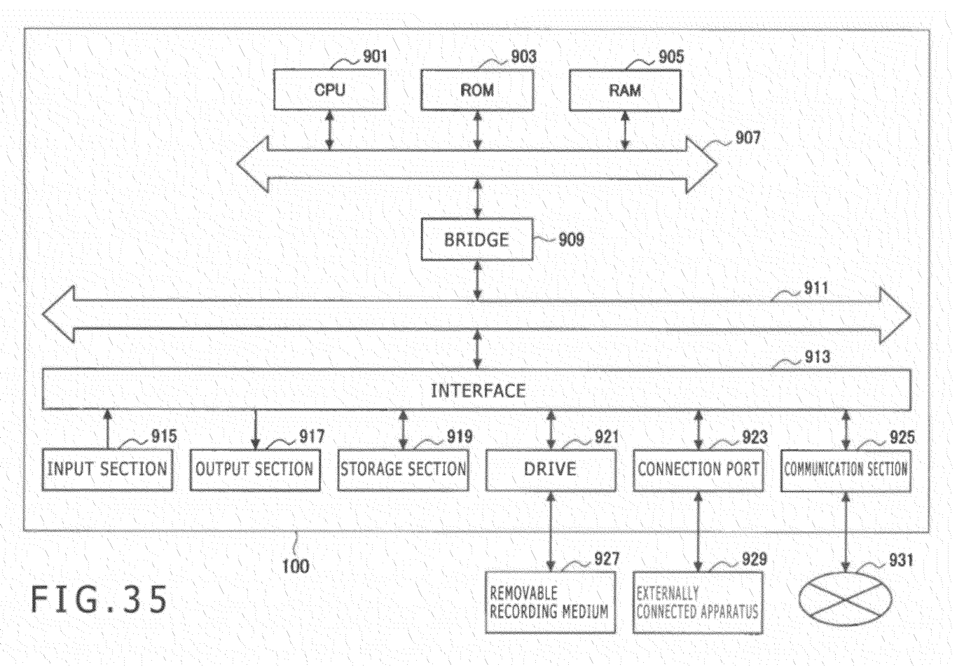

Next, by referring to FIG. 35, the following description explains details of the hardware configuration of the information processing apparatus 100 according to the embodiments of the present disclosure. FIG. 35 is a block diagram showing the hardware configuration of the information processing apparatus 100 according to the embodiments of the present disclosure.

As shown in the figure, the information processing apparatus 100 employs main components including a CPU 901, a ROM 903 and a RAM 905. In addition, the information processing apparatus 100 also has a host bus 907, a bridge 909, an external bus 911, an interface 913, an input section 915, an output section 917, a storage section 919, a drive 921, a connection port 923 and a communication section 925.

The CPU 901 functions as a processing section as well as a control section. The CPU 901 controls all or some operations, which are carried out in the information processing apparatus 100, in accordance with a variety of programs stored in the ROM 903, the RAM 905, the storage section 919 or a removable recording medium 927 mounted on the drive 921. The ROM 903 is a memory used for storing the programs to be executed by the CPU 901 and data such as processing parameters. The RAM 905 is a memory used for temporarily storing the programs to be executed by the CPU 901 and parameters changed in the course of the execution of the programs. The CPU 901, the ROM 903 and the RAM 905 are connected to each other by the host bus 907 which is an internal bus such as a CPU bus.

The host bus 907 is connected to the external bus 911 such as a PCI (Peripheral Component Interconnect/Interface) bus by the bridge 909.

The input section 915 is operation means to be operated by the user. The input section 915 typically includes a mouse, a keyboard, a touch panel, buttons, switches and a lever. The input section 915 can also be the so-called remote control means making use of typically infrared rays and/or other electrical waves. As another alternative, the input section 915 can also be the externally connected apparatus 929 provided for operating the information processing apparatus 100. Typical examples of the externally connected apparatus 929 are a hand phone and a PDA. As a further alternative, the input section 915 is configured as typically an input control circuit for generating an input signal on the basis of information entered by the user typically by operating the operation means and supplying the signal to the CPU 901. The user of the information processing apparatus 100 operates the input section 915 in order to enter various kinds of data to the information processing apparatus 100 and request the information processing apparatus 100 to carry out a processing operation.

The output section 917 is a section for visually or aurally informing the user of information. The output section 917 may be a CRT display section, a liquid-crystal display section, a plasma display section, an EL display section, a lamp display section, a sound outputting section such as a speaker or a head phone, a printer, a hand phone and/or a facsimile. The output section 917 typically outputs results of various kinds of processing carried out by the information processing apparatus 100. To put it concretely, the display section shows the results of various kinds of processing carried out by the information processing apparatus 100 as a text or an image. On the other hand, the sound outputting section converts an audio signal representing reproduced audio data and/or reproduced acoustic data into an analog signal and outputs the analog signal.

The storage section 919 is a typical storage section employed in the information processing apparatus 100. The storage section 919 is a memory used for storing data. Typical examples of the storage section 919 are a magnetic storage device such as an HDD (Hard Disc Drive), a semiconductor storage device, an optical storage device and an opto-magnetic storage device. To be more specific, the storage section 919 is used for storing a variety of programs to be executed by the CPU 901, various kinds of data generated internally and various kinds of data received from external sources.

The drive 921 is a reader/writer for the removable recording medium 927 mounted on the drive 921. The drive 921 can be embedded in the information processing apparatus 100 or connected externally to the information processing apparatus 100. The removable recording medium 927 mounted on the drive 921 can be a magnetic disc, an optical disc, an opto-magnetic disc or a semiconductor memory. The drive 921 reads out information from the removable recording medium 927 and supplies the information to the RAM 905. In addition, with the removable recording medium 927 mounted on the drive 921, the drive 921 is also capable of writing records onto the removable recording medium 927 which can be a magnetic disc, an optical disc, an opto-magnetic disc or a semiconductor memory as described above. Typical examples of the removable recording medium 927 are DVD media, HD-DVD media and Blu-ray media. Other typical examples of the removable recording medium 927 are a CF (Compact Flash which is a registered trademark) and an SD (Secure Digital) memory card. Further typical examples of the removable recording medium 927 are an IC (Integrated Circuit) card and an electronic device. The IC card has noncontact IC chips mounted thereon.

The connection port 923 is a port for connecting an external apparatus directly to the information processing apparatus 100. Typical examples of the connection port 923 are a USB (Universal Serial Bus) port, an IEEE1394 port and an SCSI (Small Computer System Interface) port. Other typical examples of the connection port 923 are an RS-232C port, an optical audio terminal and an HDMI (High-Definition Multi Media) port. With the externally connected apparatus 929 connected to the connection port 923, the information processing apparatus 100 is capable of acquiring various kinds of input data from the externally connected apparatus 929 and providing various kinds of output data to the externally connected apparatus 929.

The communication section 925 is a communication interface configured as a communication device to be connected to a communication network 931. The communication section 925 is typically a communication card for wire and radio LAN (Local Area Network) communications, Bluetooth (a registered trademark) communications or WUSB (Wireless USB) communications. In addition, the communication section 925 can be an optical communication router, an ADSL (Asymmetric Digital Subscriber Line) router or a modem provided for various kinds of communication. The communication section 925 is capable of exchanging signals and the like with the Internet and other communication apparatus in conformity with a predetermined protocol such as the TCP/IP.

In addition, the communication network 931 connected to the communication section 925 is typically configured as a network connected to the communication section 925 for wire and radio communications. Typical examples of the communication network 931 include the Internet, a home LAN, an infrared-ray communication network, a radio communication network or a satellite communication network.

The above descriptions explain a typical hardware configuration for implementing functions of the information processing apparatus 100 according to the embodiment of the present disclosure. Each of the configuration elements can be configured by making use of a general-purpose member or hardware specially tailored to the function of the configuration element. Thus, in accordance with a technological level which is improved from time to time as a level for implementing the embodiment, the configuration of the hardware for implementing every configuration element can be changed properly.

### 4: Conclusions

### Typical Configurations and Effects of the Embodiments

The embodiments described above implement an information processing apparatus employing:

a base-N numerical-value generation section (where N=2, 3 and so on) for generating a combined base-N numerical value for each piece of data having positional information indicating a position prescribed in terms of D different coordinates of a D-dimensional coordinate system set for a feature space as the position of the piece of data in the feature space (where D=2, 3 and so on) by alternately arranging digits representing the values of all the D different coordinates each represented by a component base-N numerical value having a predetermined digit count representing the number of aforementioned digits representing the coordinate sequentially on a digit-after-digit basis; and

a clustering section for grouping the pieces of data, which are each represented by one of the generated combined base-N numerical values each having k most significant digits common to the pieces of data (where k=1, 2 and so on), in the same cluster.

In accordance with the configuration described above, clustering processing carried out on pieces of data having information on the positions of the pieces of data can be replaced by processing to sort base-N numerical values each representing one of the pieces of data. To be more specific, the processing to compute a distance between positions can be replaced by processing to compare the magnitudes of numerical values with each other. In addition, the number of times the processing itself is carried out can be decreased. Thus, it is possible to carry out the clustering by making use of lower-performance or smaller-size resources such as processors and memory areas. In addition, the clustering can be carried out at a high speed.

In addition, it is possible to provide a configuration in which, if the relation k=D×m (where m=1, 2 and so on) holds true, the clustering section groups the pieces of data, which are each represented by one of the generated base-N numerical values each having k most significant digits common to the pieces of data, in the same cluster on an mth layer of a (N^{D})-child tree structure of clusters.

In accordance with the configuration described above, the hierarchical structure of clusters can be constructed with ease. In addition, since it is not necessary to hold the entire hierarchical structure, the size of the memory-area resource can be reduced.

In addition, it is possible to provide a configuration in which the clustering section has a clustering-oriented content-sorting block for sorting the pieces of data in the order of aforementioned base-N numerical values each generated by the base-N numerical-value generation section for one of the pieces of data. In this configuration, the clustering section identifies the pieces of data to be grouped in the same cluster from the result of the sorting carried out by the clustering-oriented content-sorting block.

In accordance with the configuration described above, pieces of data to be grouped in the same cluster can be identified with ease from the result of the sorting.

In addition, it is possible to provide a configuration in which the clustering section generates cluster identifying information used for identifying a cluster for the result of the sorting by creating the cluster identifying information from the position of the first piece of data appearing in the cluster and the number of pieces of data grouped in the cluster.

In accordance with the configuration described above, the cluster identifying information used for identifying a cluster does not have to include information used for identifying each piece of data grouped in the cluster. Thus, the performance and/or size of each of resources required for generating and storing the cluster identifying information can be reduced and the clustering can be carried out at a high speed.

In addition, it is possible to provide a configuration in which the information processing apparatus further employs:

a merging-oriented cluster-sorting block for sorting the clusters in a first direction in the feature space on the basis of the result of first ranking determination processing based on the D different coordinates of the D-dimensional coordinate system;

a cluster-adjacency determination block for determining whether or not the clusters sorted in the first direction are adjacent to each other in the first direction; and

a cluster merging section for merging clusters determined to be clusters adjacent to each other in the first direction.

In accordance with the configuration described above, merging is carried out on clusters determined to be clusters adjacent to each other in accordance with the result of the sorting. Thus, the size of the resource for the merging is small in comparison with merging carried out on all clusters. In addition, the clustering processing including the processing to merge sorted clusters can be carried out at a high speed.

In addition, it is possible to provide a configuration in which:

the merging-oriented cluster-sorting block sorts the clusters in a second direction in the feature space on the basis of the result of second ranking determination processing based on the D different coordinates of the D-dimensional coordinate system;

the cluster-adjacency determination block determines whether or not the clusters sorted in the second direction are adjacent to each other in the second direction; and

the cluster merging section further merges clusters determined to be clusters adjacent to each other in the second direction.

In accordance with the configurations described above, clusters sorted in two directions are examined in order to determine whether or not the clusters are adjacent to each other in the two directions respectively. Thus, it is possible to merge clusters determined to be clusters adjacent to each other with absolute certainty.

In addition, it is possible to provide a configuration in which:

the feature space is the surface of the earth;

the D different coordinates of the D-dimensional coordinate system are the latitude and longitude coordinates used as the two coordinates of a two-dimensional coordinate system;

the cluster is an area provided with information on the positions of the pieces of data which are included in a grid defined on the surface of the earth in terms of the two coordinates of the two-dimensional coordinate system; and

the first ranking determination processing is processing carried out to sort the grids in the first direction in order to set a sorting order of the grids and provide the sorting order of the grids to clusters each associated with one of the sorted grids as a ranking of the clusters.

In accordance with the configuration described above, pieces of data each having information on its position on the surface of the earth can be clustered at a high speed by making use of grids each defined in terms of a latitude and a longitude. In addition, the first ranking determination processing is carried out to sort the grids in the first direction in order to set a sorting order of the grids and provide the sorting order of the grids to clusters each associated with one of the sorted grids as a ranking of the clusters. Thus, the clusters can be sorted at a high speed.

In addition, it is possible to provide a configuration in which:

the feature space is a three-dimensional space;

the D different coordinates of the D-dimensional coordinate system are the three coordinates of a three-dimensional coordinate system used as an orthogonal-coordinate system; and

the cluster is an area provided with information on the positions of the pieces of data which are included in a block defined in the three-dimensional space in terms of the three coordinates of the three-dimensional coordinate system.

In accordance with the configuration described above, pieces of data each having information on its position in a three-dimensional space can be clustered at a high speed by making use of blocks each defined in an orthogonal coordinate system. In addition, since the surface of the earth is divided by making use of blocks, the pieces of data can be grouped in clusters not including generated latitude distortions on the surface of the earth.

In addition, it is possible to provide a configuration in which the processing to merge clusters includes:

processing to compute the distance between any two of the clusters; and

conditional cluster merging processing to merge any two of the clusters if the computed distance between the two clusters is equal to or shorter than a threshold value determined in advance.

In accordance with the configuration described above, the amount of the conditional cluster merging processing to conditionally merge any two of the clusters can be reduced so that the clustering processing including the conditional cluster merging processing to conditionally merge any two of the clusters can be carried out at a higher speed.

In addition, it is possible to provide a configuration in which the processing to merge clusters includes:

processing to compute the distance between any two of the clusters;

processing to store any two of the clusters as merging candidate clusters if the computed distance between the two clusters is equal to or shorter than a threshold value determined in advance; and

processing to merge the stored merging candidate clusters in an increasing-distance order starting with specific merging candidate clusters having a shortest distance between the specific merging candidate clusters.

In accordance with the configuration described above, clusters separated from each other by a short distance can be merged with absolute certainty. Thus, it is possible to improve the precision of the clustering processing including the processing to merge stored merging candidate clusters.

### Typical Modified Versions of the Embodiments

As described above, the feature space according to the first embodiment is the surface of the earth whereas the feature space according to the second embodiment is a three-dimensional space including the earth. However, feature spaces of the present disclosure are by no means limited to those according to the first and second embodiments. For example, instead of a real space, the feature space can be a color space such as the RGB or YUV color space. As an alternative, the feature space can also be a higher-order feature quantity space for expressing image feature quantities.

In addition, in the case of the first embodiment, D=2 and N=2. In the case of the second embodiment, on the other hand, D=3 and N=2. However, D and N values of the present disclosure are by no means limited to those according to the first and second embodiments. For example, D can have a value of 4 or a larger value. That is to say, each data can have information on its position in a feature space prescribed in terms of the coordinates of a high-dimensional coordinate system such as a coordinate system having four dimensions or a coordinate system of an even higher dimension count. As an example, if each coordinate value of the 4-dimensional coordinate system is represented by a component binary-system numerical value having 16 digits for D=4, the base-N numerical-value generation section 101 generates a combined binary-system numerical value having 64 (=16×4) digits. In addition, the base-N numerical-value generation section 101 may also generate a base-N numerical value making use of any base N such as N=8 representing the octal-system numerical values, N=10 representing the decimal-system numerical values or N=16 representing the hexadecimal-system numerical values. As another example, if each coordinate value of the two-dimensional coordinate system is represented by a component hexadecimal-system numerical value having 29 digits for D=2, the base-N numerical-value generation section 101 generates a combined hexadecimal-system numerical value having 58 (=29×2) digits. In this case, pieces of data are grouped in any of clusters pertaining to a 256 (16²)-child tree structure.

In addition, the first embodiment adopts a two-dimensional coordinate system based on two different coordinates which are the latitude and longitude coordinates. On the other hand, as a three-dimensional coordinate system, the second embodiment adopts the orthogonal coordinate system based on three different coordinates which are the x, y and z coordinates. However, coordinate systems of the present disclosure are by no means limited to those according to the first and second embodiments. That is to say, the two-dimensional coordinate system, the three-dimensional coordinate system and the D-dimensional coordinate system can be the orthogonal coordinate system, the oblique coordinate system or the polar coordinate system.

Preferred embodiments of the present disclosure have been explained in detail by referring to diagrams. However, implementations of the present disclosure are by no means limited to the embodiments. It is obvious that a person having ordinary knowledge in the field of the technology pertaining to the present disclosure is capable of coming up with a variety of changes made to the embodiments and modified versions of the embodiments in a range of technological concepts described in claims of this specification or the present disclosure. However, such changes and such modified versions are naturally regarded to fall within the range of the technological concepts described in the claims.

The present disclosure contains subject matter related to that disclosed in Japanese Priority Patent Application JP 2010-263820 filed in the Japan Patent Office on Nov. 26, 2010, the entire content of which is hereby incorporated by reference.

It should be understood by those skilled in the art that various modifications, combinations, sub-combinations and alterations may occur depending on design requirements and other factors in so far as they are within the scope of the appended claims or the equivalents thereof.

1. An information processing apparatus comprising:
a base-N numerical-value generation section (where N=2, 3 and so on) configured to generate a combined base-N numerical value for each piece of data having positional information indicating a position prescribed in terms of D different coordinates of a D-dimensional coordinate system set for a feature space as the position of said piece of data in said feature space (where D=2, 3 and so on) by alternately arranging digits representing the values of all said D different coordinates each represented by a component base-N numerical value having a predetermined digit count representing the number of said digits representing said coordinate sequentially on a digit-after-digit basis; and
a clustering section configured to group said pieces of data, which are each represented by one of said generated combined base-N numerical values each having k most significant digits common to said pieces of data (where k=1, 2 and so on), in the same cluster.

2. The information processing apparatus according to claim 1 wherein, if a relation k=D×m (where m=1, 2 and so on) holds true, said clustering section groups said pieces of data, which are each represented by one of said generated base-N numerical values each having k most significant digits common to said pieces of data, in the same cluster on an mth layer of a (N^{D})-child tree structure of clusters.

3. The information processing apparatus according to claim 1 wherein,
said clustering section has a clustering-oriented content-sorting block configured to sort said pieces of data in an order of said base-N numerical values each generated by said base-N numerical-value generation section for one of said pieces of data, and
said clustering section identifies said pieces of data to be grouped in the same cluster from a result of said sorting carried out by said clustering-oriented content-sorting block.

4. The information processing apparatus according to claim 3 wherein said clustering section generates cluster identifying information used for identifying a cluster for said result of said sorting by creating said cluster identifying information from the position of said first piece of data appearing in said cluster and the number of pieces of data grouped in said cluster.

5. The information processing apparatus according to claim 1 wherein said information processing apparatus further comprises:
a merging-oriented cluster-sorting block configured to sort said clusters in a first direction in said feature space on the basis of said result of first ranking determination processing based on said D different coordinates of said D-dimensional coordinate system;
a cluster-adjacency determination block configured to determine whether or not said clusters sorted in said first direction are adjacent to each other in said first direction; and
a cluster merging section configured to merge clusters determined to be clusters adjacent to each other in said first direction.

6. The information processing apparatus according to claim 5 wherein,
said merging-oriented cluster-sorting block sorts said clusters in a second direction in said feature space on the basis of said result of second ranking determination processing based on said D different coordinates of said D-dimensional coordinate system,
said cluster-adjacency determination block determines whether or not said clusters sorted in said second direction are adjacent to each other in said second direction, and
said cluster merging section further merges clusters determined to be clusters adjacent to each other in said second direction.

7. The information processing apparatus according to claim 5 wherein,
said feature space is the surface of the earth,
said D different coordinates of said D-dimensional coordinate system are the latitude and longitude coordinates used as the two coordinates of a two-dimensional coordinate system,
said cluster is an area provided with information on the positions of said pieces of data which are included in a grid defined on said surface of said earth in terms of said two coordinates of said two-dimensional coordinate system, and
said first ranking determination processing is processing carried out to sort said grids in said first direction in order to set a sorting order of said grids and provide said sorting order of said grids to clusters each associated with one of said sorted grids as a ranking of said clusters.

8. The information processing apparatus according to claim 1 wherein,
said feature space is a three-dimensional space,
said D different coordinates of said D-dimensional coordinate system are the three coordinates of a three-dimensional coordinate system used as an orthogonal-coordinate system, and
said cluster is an area provided with information on the positions of said pieces of data which are included in a block defined in said three-dimensional space in terms of said three coordinates of said three-dimensional coordinate system.

9. An information processing method comprising:
generating a combined base-N numerical value (where N=2, 3 and so on) for each piece of data having positional information indicating a position prescribed in terms of D different coordinates of a D-dimensional coordinate system set for a feature space as the position of said piece of data in said feature space (where D=2, 3 and so on) by alternately arranging digits representing the values of all said D different coordinates each represented by a component base-N numerical value having a predetermined digit count representing the number of said digits representing said coordinate sequentially on a digit-after-digit basis; and
grouping said pieces of data, which are each represented by one of said generated combined base-N numerical values each having k most significant digits common to said pieces of data (where k=1, 2 and so on), in the same cluster.

10. A non-transitory computer readable recording medium on which is stored an information processing program to be executed by a computer to carry out the method comprising:
processing to generate a combined base-N numerical value (where N=2, 3 and so on) for each piece of data having positional information indicating a position prescribed in terms of D different coordinates of a D-dimensional coordinate system set for a feature space as the position of said piece of data in said feature space (where D=2, 3 and so on) by alternately arranging digits representing the values of all said D different coordinates each represented by a component base-N numerical value having a predetermined digit count representing the number of said digits representing said coordinate sequentially on a digit-after-digit basis; and
processing to group said pieces of data, which are each represented by one of said generated combined base-N numerical values each having k most significant digits common to said pieces of data (where k=1, 2 and so on), in the same cluster.

11. The recording medium according to claim 10, said program executed by said computer in order to further carry out the method comprising:
processing to sort said clusters in a first direction in said feature space on the basis of said result of first ranking determination processing based on said coordinates of said D-dimensional coordinate system;
processing to determine whether or not said clusters sorted in said first direction are adjacent to each other in said first direction; and
processing to merge clusters determined to be clusters adjacent to each other in said first direction.

12. The recording medium according to claim 11, said program executed to carry out said processing to merge clusters as processing including:
a process of computing a distance between any two of said clusters; and
a process of merging two clusters with each other if said computed distance between said two clusters is not longer than a threshold value determined in advance.

13. The recording medium according to claim 11, said program executed to carry out said processing to merge clusters as processing including:
a process of computing a distance between any two of said clusters;
a process of storing any two clusters in a memory as merging-candidate clusters if said computed distance between said two clusters is not longer than a threshold value determined in advance; and
a process of merging clusters, which are selected from said stored merging-candidate clusters, with each other in an order starting with said merging-candidate clusters having a small distance between said merging-candidate clusters.
